(19) United States
(12) Patent Application Publication
(10) Pub. No.: US 2012/0116799 A1
(43) Pub. Date: May 10, 2012

(54) SYSTEM FOR ASSESSING RISK FOR PROGRESSION OR DEVELOPMENT OF PERIODONTITIS FOR A PATENT

(76) Inventors: Sven Lindskog, Stockholm (SE); Leif Blomlöf, Stockholm (SE)

(21) Appl. No.: 13/319,383

(22) PCT Filed: May 8, 2009
(86) PCT No.: PCT/EP09/55590

§ 371 Date: Jan. 18, 2012

(51) Int. Cl. G06Q 50/22

(52) U.S. Cl. 705/2

(57) ABSTRACT

The invention relates to a method, system and a device for assessing the risk for periodontitis progression or for developing periodontitis, and a method, system and a device for prognosticating the outcome of a treatment procedure for treating periodontitis, on the basis of a risk score calculated on the basis of weight factors, which may be associated with numerical values, assigned to a plurality of measures corresponding to a plurality of predictors promoting periodontitis comprising host predictors, local predictors, and systemic predictors for periodontitis progression or for developing periodontitis for a patient. The invention provides among other things an objective tool that allows for preventive measures to be taken in time before severe and often irreversible damage caused by periodontitis has occurred, by taking into account the most important risk predictors promoting periodontitis, and in particular takes into account the synergy between these predictors. The invention also relates to a computer readable storage medium, on which there is stored a computer program comprising computer code adapted to perform one or more of the above-mentioned methods, and furthermore such a computer program.

### FIELD OF THE INVENTION

The present invention generally relates to the field of dental treatment. In particular, the present invention is related to a system for assessing the risk for progression of periodontitis for a patient. The present invention also relates to a system for prognosticating the outcome of a treatment procedure for treating periodontitis.

### BACKGROUND

Periodontitis is a significant global healthcare problem with increasing costs both for the individual patient as well as other cost bearers. The disease is a silent, multi-factorial dental disease involving a large number of risk factors. The interaction of the risk factors for periodontitis is particularly challenging to assess, even for an experienced clinician. Patients suffering from periodontitis very often have an increased propensity for the disease, potentiated by a number of other complex risk factors. Inflammation of the gingiva (that is, part of the soft tissue lining of the mouth surrounding the teeth and providing a seal around them), gingivitis, is present before periodontitis develops. Periodontitis generally begins by an accumulation of bacteria in the pocket between the tooth and adjacent gingiva. The bacteria causes inflammation and destruction of the tooth-supporting tissue. During a later stage of disease progression, a number of teeth may become loose or may be lost. The disease generally develops during a period of twenty to thirty years, and usually culminates when the patient is between fifty and sixty years old.

Population surveys and studies done in the United States and Western Europe indicate that over 50% of adults suffer from gingivitis, and 30% of them suffer from periodontitis. In its severe form, periodontitis affects roughly 10% of the population in the industrialized countries, leading to partial or complete tooth loss.

A number of risk factors associated with periodontitis have been identified in the field. However, conventional methods for assessing risk for progression of periodontitis are generally inadequate in that they in general allow for registering risk for disease only after severe and often irreversible dental damage has occurred. Also, conventional methods for prognosticating, in particular prognosticating the outcome of a treatment procedure for treating periodontitis, generally suffer from the same drawbacks. One of the most common risk assessment methods involves observation of gingival bleeding and tissue loss, followed by measurement of the depth of periodontal pockets of the patient using a probe. If pocket depths exceeding 3 or 4 mm are observed, the patient is diagnosed with periodontitis. Another method involves observing attachment loss by means of radiographic measurements. In case of attachment loss exceeding about a third of the root, the disease is generally regarded as moderate. If such attachment loss is accompanied by the presence of bony pockets and infection between the roots (furcation involvement), the disease is generally regarded as severe. Such methods obviously do not allow for preventive measures to be taken in time before severe and often irreversible damage has occurred.

Furthermore, such conventional methods generally do not provide objective and clinically validated methods for comprehensive assessment of risk for development and progression of periodontitis, prognosis for disease development and the outcome of dental treatment, and generally do not take into account the most important risk factors, in particular the accumulation of and synergy between such factors.

Thus, there is a need in the art for a clinically validated and unbiased tool for assessing risk of development and progression of periodontitis and for prognosticating disease development and the outcome of dental treatment, and which takes into account the most important risk factors.

Moreover, there is a need in the art for effective periodontal risk-factor management that may be used at early stages in the disease development or progression, which improves dental healthcare, patient quality of life, registers risk before severe and often irreversible dental damage has occurred, and substantially reduces treatment costs.

U.S. Pat. No. 6,484,144B2 describes a method implemented in a computer system for computing a risk value that indicates a likelihood of a patient of entering an undesirable state, comprising receiving data reflecting a current state of the patient and computing a risk value reflecting the likelihood of the patient entering the undesirable state based on a subset of the received data. The computer system analyses a proposed strategy for preventing the patient from entering the undesirable state.

### SUMMARY OF THE INVENTION

A drawback of the method of U.S. Pat. No. 6,484,144B2 is that it is limited to computing a risk value pertaining to the patient on the whole reflecting the likelihood of the patient entering the undesirable state, based on a subset of the received data.

In this respect, the inventors of the present invention have realized that for efficiently allowing preventive measures to be taken in time before severe and often irreversible dental damage has occurred, tooth-by-tooth periodontal risk-factor management is highly advantageous, particularly in case it has already been established that the patient has an elevated risk for developing or progression of periodontal disease.

In view of the above, it is an object of the invention to provide an improved method, device and system for assessing risk of development and progression of periodontitis.

Another object of the invention is to provide an improved method, device and system for prognosticating the outcome of a treatment procedure for treating periodontitis.

Yet another object of the invention is to provide a computer program for performing the improved method for assessing the risk for the progression of periodontitis or for developing periodontitis for a patient.

Still another object of the invention is to provide a computer program for performing the improved method for prognosticating the outcome of a treatment procedure for treating periodontitis.

One or more of these and other objects are completely or partially achieved by a method, system and device for assessing the risk for periodontitis progression or for developing periodontitis, a method, system and device for prognosticating the outcome of a treatment procedure for treating periodontitis, a computer program for performing a method for assessing the risk for the progression of periodontitis or for developing periodontitis for a patient and a computer readable digital storage medium on which there is stored such a computer program, and a computer program comprising computer code for performing a method for prognosticating the outcome of a treatment procedure for treating periodontitis and a computer readable digital storage medium on which there is stored such a computer program, according to the independent claims.

As already discussed above, particularly when factors associated with periodontitis accumulate and work in synergy, episodes of disease progression may occur. Obviously, although correlated to disease progression, not all of these factors are causative of dental disease such as periodontitis and as such might be better referred to as “risk predictors” rather than “risk factors” or “risk determinants”. As will be further discussed in the following, risk predictors correlated to risk for development or progression of periodontitis may be divided into systemic and local risk predictors that may influence the host's (or patient's) response (i.e. host predictors) to the primary etiological risk predictor, namely a subset of pathogenic bacteria from the indigenous human bacterial flora in the form of plaque or a biofilm.

According to a first aspect of the invention, there is provided a method for assessing the risk for periodontitis progression or for developing periodontitis, the method including the step of receiving a first set of measures, where each measure of the first set of measures corresponds to one of a plurality of predictors promoting periodontitis comprising host predictors, local predictors, and systemic predictors for periodontitis progression or for developing periodontitis for a patient. For each of the thus received first set of measures, there is assigned a weight factor on the basis of the relative impact on the progress of periodontitis of the predictor corresponding to the respective measure. Furthermore, a risk score for periodontitis progression or for developing periodontitis for the patient on the basis of the thus assigned weight factor is calculated.

By such a method for assessing the risk for periodontitis progression or for developing periodontitis, there is provided an objective tool that allows for preventive measures to be taken in time before severe and often irreversible damage has occurred, by taking into account the most important risk predictors promoting periodontitis, and in particular taking into account the synergy between these predictors. When such predictors work in synergy, episodes of disease progression may occur. The risk predictors may thus be chosen such that they are at least partly overlapping. Namely, such that there is a certain degree of synergy between two or more risk predictors, which may increase the robustness of the thus determined risk level. For example, one or more risk predictors may compensate for a risk that is present for a certain patient when another predictor that is overlapping said on or more predictors is non-existent due to measurement errors, lack of measurement data, etc. Thus, the number of false negatives may be reduced. The predictors used in the method are in general predictors that are assessed at dental practices in connection with ordinary, regular dental treatment. Hence, in general there is no need for special procedures for assessing the risk predictors used in the method according to the invention, but the predictors pertaining to each individual are generally already available or easily accessible at the individual's dental practice, with the single exception comprising the result from the skin provocation test for assessing the patient's inflammatory reactivity (DentoTest™) that may be used in exemplary embodiments, as will be described below. Consequently, especially in view of that the method according to the invention allows for preventive measures to be taken in time before severe and often irreversible damage has occurred, costs for treatment, in particular treatment against periodontitis, may be substantially reduced. Furthermore, the quality of life for the patient may be increased.

According to a second aspect of the invention, there is provided a device for assessing the risk for periodontitis progression or for developing periodontitis, the device including a processing unit adapted to receive a first set of measures, where each measure of the first set of measures corresponds to a plurality of predictors promoting periodontitis comprising host predictors, local predictors, and systemic predictors for periodontitis progression or for developing periodontitis for a patient. For each of the thus received first set of measures, the processing unit is further adapted to assign a weight factor on the basis of the relative impact on the progress of periodontitis of the predictor corresponding to the respective measure, and calculate a first risk score for periodontitis progression or for developing periodontitis for the patient on the basis of the thus assigned weight factors. The processing unit is further adapted to determine the risk level for the risk for progression of periodontitis or for developing periodontitis for the patient on the basis of the thus calculated first risk score.

By such a device, there is achieved similar or the same advantages as for the method according to the first aspect of the invention as described previously.

According to a third aspect of the invention, there is provided a method for prognosticating the outcome of a treatment procedure for treating a patient suffering from periodontitis, the method including the step of receiving a set of measures, where each measure of the set of measures corresponds to one of plurality of predictors promoting periodontitis progression comprising host predictors, local predictors, and systemic predictors for periodontitis progression for the patient. The method further includes assessing the impact of the treatment procedure on at least one of the set of measures, and on the basis of said assessed impact, determining a set of impact factors, where each impact factor corresponds to the at least one of the set of measures. Each impact factor is applied to the corresponding measure, thereby biasing the measure. For each of the determined set of measures, a weight factor is assigned on the basis of the relative impact on the progress of periodontitis of the predictor corresponding to the respective measure. Furthermore, a biased risk score for progression of periodontitis for the patient is calculated on the basis of the thus assigned weight factors, and on the basis of the difference between the biased risk score and a predetermined unbiased risk score for progression of periodontitis for the patient, the outcome of a treatment procedure for treating the patient suffering from periodontitis is prognosticated.

By such a method for prognosticating the outcome of a treatment procedure for treating a patient suffering from periodontitis, there is provided an objective tool that allows for preventive measures to be taken in time before severe and often irreversible damage has occurred, by taking into account the most important risk predictors promoting periodontitis, and in particular taking into account the synergy between these predictors. When such predictors work in synergy, episodes of disease progression may occur. The risk predictors may thus be chosen such that they are at least partly overlapping. Namely, such that is there is a certain degree of synergy between two or more risk predictors, which may increase the robustness of the thus determined biased risk score. For example, one or more risk predictors may compensate for a risk that is present for a certain patient when another predictor that is overlapping said on or more predictors is non-existent due to measurement errors, lack of measurement data, etc. Thus, the number of false negatives may be reduced. By increasing the robustness of the determination of the biased risk score, the robustness of the prognostication of the treatment procedure increases in turn. The predictors used in the method are in general predictors that generally are assessed at dental practices in connection with ordinary, regular dental treatment. Hence, in general there is no need for special procedures for assessing the risk predictors used in the method according to the invention, but the predictors pertaining to each individual are generally already available or easily accessible at the individual's dental practice, with the single exception comprising the result from the skin provocation test for assessing the patient's inflammatory reactivity (DentoTest™) that may be used in exemplary embodiments, as will be described below. Consequently, especially in view of that the method according to the invention allows for preventive measures to be taken in time before severe and often irreversible damage has occurred, costs for treatment, in particular treatment against periodontitis, may be substantially reduced. Furthermore, the quality of life for the patient may be increased.

The prognosis thus obtained by means of the method for prognosticating the outcome of a treatment procedure for treating a patient suffering from periodontitis according to the invention may subsequently be used as data on which a decision for choice of a treatment plan for the current disease state may be based.

The method for prognosticating the outcome of a treatment procedure for treating a patient suffering from periodontitis according to the invention may hence be used to simulate the outcome of a treatment procedure to be applied to a patient, by estimating the impact the treatment procedure may have on one or more risk predictors promoting periodontitis progression comprising host predictors, local predictors, and systemic predictors for periodontitis progression for the patient. In general this allows for savings in cost for treatment, in particular treatment against periodontitis, to be carried out, as the number of unnecessary or not worthwhile treatment procedures, having a small or negligible impact on the present disease state of the patient, may be kept to a minimum or eliminated. Furthermore, strain on the patient may be decreased as the patient does not have to endure going through unnecessary or not worthwhile treatment procedures.

According to a fourth aspect of the invention, there is provided a device for prognosticating the outcome of a treatment procedure for treating a patient suffering from periodontitis, the device including a processing unit adapted to receive a set of measures, where each measure of the set of measures corresponds to one of a plurality of predictors promoting periodontitis progression comprising host predictors, local predictors, and systemic predictors for periodontitis progression for the patient, and receive a set of predetermined impact factors with respect to the estimated impact of the treatment procedure on at least one of the set of measures, where each impact factor corresponds to the at least one of the set of measures. Each impact factor is applied to the corresponding measure, whereby the measure is biased. For each of the thus determined set of measures, the processing unit is adapted to assign a weight factor on the basis of the relative impact on the progress of periodontitis of the predictor corresponding to the respective measure, and calculate a biased risk score for progression of periodontitis for the patient on the basis of the thus assigned weight factors. Furthermore, the processing unit is adapted to prognosticate the outcome of a treatment procedure for treating the patient suffering from periodontitis on the basis of the difference between the biased risk score and a predetermined unbiased risk score for progression of periodontitis for the patient.

By such a device, there is achieved similar or the same advantages as for the method according to the third aspect of the invention as described previously.

According to a fifth aspect of the invention, there is provided a system for assessing the risk of periodontitis or for developing periodontitis for a patient, the system including a control and processing unit adapted to perform a method for assessing the risk for the progression of periodontitis or for developing periodontitis for a patient according to the first aspect of the invention or embodiments thereof.

By the system according to the fifth aspect of the invention, advantages similar or identical to the advantages of the method according to the first aspect of the invention are achieved, as described above. In addition, by the control and processing unit there is provided a means for achieving automatization of the method according to the first aspect of the invention or embodiments thereof.

For example, the control and processing unit may be located in a central server adapted to communicating with a plurality of user devices. This allows for user devices or satellite stations located at dental practices or the like where dental treatment is performed, to communicate over a public or private network, which may be wireless, with an entity where the method according to the first aspect of the invention is implemented.

According to a sixth aspect of the invention, there is provided a system for prognosticating the outcome of a treatment procedure for treating periodontitis, the system including a processing unit adapted to perform a method for prognosticating the outcome of a treatment procedure for treating periodontitis according to the third aspect of the invention or embodiments thereof.

By the system according to the sixth aspect of the invention, advantages similar or identical to the advantages of the method according to the third aspect of the invention are achieved, as described above. In addition, by the control and processing unit there is provided a means for achieving automatization of the method according to the third aspect of the invention or embodiments thereof.

For example, the control and processing unit may be located in a central server adapted to communicating with a plurality of user devices. This allows for user devices or satellite stations located at dental practices or the like where dental treatment is performed, to communicate over a public or private network, which may be wireless, with an entity where the method according to the third aspect of the invention is implemented.

According to a seventh aspect of the invention, there is provided a computer program implemented in a processing unit, which computer program comprises computer code adapted to perform a method for assessing the risk for the progression of periodontitis or for developing periodontitis for a patient according to the first aspect of the invention or embodiments thereof. By such a computer program, there is provided a means for implementing the method according to the first aspect of the invention or embodiments thereof, thus achieving advantages similar or identical to the advantages of the method according to the first aspect of the invention or embodiments thereof, as described above.

According to a eight aspect of the invention, there is provided a computer program implemented in a processing unit, which computer program comprises computer code adapted to perform a method for prognosticating the outcome of a treatment procedure for treating periodontitis according to the third aspect of the invention or embodiments thereof. By such a computer program, there is provided a means for implementing the method according to the third aspect of the invention or embodiments thereof, thus achieving advantages similar or identical to the advantages of the method according to the third aspect of the invention or embodiments thereof, as described above.

According to a ninth aspect of the invention, there is provided a computer readable digital storage medium on which there is stored a computer program comprising computer code adapted to, when executed in a processor unit, perform a method for assessing the risk for the progression of periodontitis or for developing periodontitis for a patient according to the first aspect of the invention or embodiments thereof, as described above. By such a storage medium, there is provided an easily portable means for implementing the method according to the first aspect of the invention or embodiments thereof, thus achieving advantages similar or identical to the advantages of the method according to the first aspect of the invention or embodiments thereof, as described above.

According to a tenth aspect of the invention, there is provided a computer readable digital storage medium on which there is stored a computer program comprising computer code adapted to, when executed in a processing unit, perform a method for prognosticating the outcome of a treatment procedure for treating periodontitis according to the third aspect of the invention or embodiments thereof, as described above. By such a storage medium, there is provided an easily portable means for implementing the method according to the third aspect of the invention or embodiments thereof, thus achieving advantages similar or identical to the advantages of the method according to the third aspect of the invention or embodiments thereof, as described above.

According to an embodiment of the present invention, on the basis of the thus calculated first risk score, a risk level for the risk for progression of periodontitis or for developing periodontitis for the patient may be determined, thus providing an objective measure of the risk for progression of periodontitis or for developing periodontitis pertaining to a patient, which measure is readily available to, e.g., a practitioner.

According to another embodiment of the present invention, a first set of numerical values may be produced, where each numerical value of the first set of numerical values is associated with a weight factor. The first risk score may then be calculated further on the basis of the thus produced numerical values of the first set of numerical values as well as the associated weight factors.

In this manner, an increased versatility in calculating the first risk score is achieved in that for each weight factor, corresponding to a certain predictor promoting periodontitis for periodontitis progression or for developing periodontitis for a patient, there is an associated numerical value, thus increasing the number of ways of modifying the relative impact of a certain predictor on the determined risk level in view of potential future changes to the parameters of the risk assessment procedure according to the embodiment, as well as increasing the flexibility of the risk assessment procedure of the embodiment.

According to yet another embodiment of the present invention, the step of receiving a first set of measures may further include assessing predictors promoting periodontitis comprising host predictors, systemic predictors and local predictors for periodontitis progression or for developing periodontitis for the patient, and determining a first set of measures, where each of the measures of the first set of measures corresponds to one of the thus assessed predictors. This first set of measures may then be stored in a database. For example, in case of repeated risk assessments for a given individual or patient, the database in which the first set of measures was stored can be accessed by a clinician, or practitioner, or any other authorized person and subsequently, the first set of measures can be retrieved from the database.

According to yet another embodiment of the present invention, at least one of the weight factors associated with the first set of measures may be improved by performing the method according to the embodiment and comparing the thus determined risk level for the risk for progression of periodontitis or for developing periodontitis with clinical measures on the progress of periodontitis or indications for developing periodontitis for the patient. On the basis of that comparison, the at least one of the weight factors may then be adjusted. Furthermore, according to yet another embodiment of the invention, at least one of the numerical values of the first set of numerical values may be improved by performing the method according to the embodiment and comparing the thus determined risk level for the risk for progression of periodontitis or for developing periodontitis with clinical measures on the progress of periodontitis or indications for developing periodontitis for the patient, and on the basis of said comparison, adjusting the at least one of the numerical values.

In this manner, the performance of the method according to the embodiment may be gradually improved by repeated use of it. Thus, the results obtained from performing the method are compared with clinical data on the progress of periodontitis or indications for developing periodontitis for the patient, and this comparison may then form the basis for adjusting the model parameters, that is the weight factors associated with the first set of measures and/or the numerical values that may be associated therewith, to improve the performance of the method according to the embodiment.

According to yet another embodiment of the present invention, there may be further performed a continued, in-depth assessment of the risk for periodontitis progression or for developing periodontitis, if the calculated risk level is classified as a high risk or in other words if the calculated first risk score exceeds a predetermined threshold value. Then, for a particular tooth of the patient, there is received a second set of measures, where each measure of the second set of measures corresponds to one of a plurality of predictors promoting periodontitis comprising local predictors for periodontitis progression or for developing periodontitis for the particular tooth. For each of the thus received second set of measures, there is assigned a weight factor on the basis of the relative impact on the progress of periodontitis of the predictor corresponding to the respective measure. A second risk score for periodontitis progression or for developing periodontitis for the particular tooth is calculated on the basis of the thus assigned weight factors. This procedure is repeated for all remaining teeth.

Given the thus calculated second risk score for an individual tooth, categorization of prognosis levels for the particular tooth may be performed, for example by categorization of prognosis levels into a number of strata with increasing risk of disease progression. In this case, a higher second risk score corresponds to an increasing risk of disease progression (cf. the appended Example 1).

Thus, according to the exemplary embodiment described immediately above, in case an elevated risk level for the risk for periodontitis progression or for developing periodontitis is found, an in-depth risk assessment tooth-by-tooth may be performed for assessing the risk level for the risk for progression of periodontitis or for developing periodontitis for each tooth, or even the risk for future attachment loss tooth by tooth, thereby enabling focused therapy to be performed as well as prognostication of disease progression. Consequently, in this manner preventive measures may be taken in time before severe and often irreversible damage has occurred. Furthermore, because the risk levels of individual teeth are assessed, in general more efficient preventive measures may be taken compared to only knowing the risk level for periodontal disease progression or development for the patient as a whole. Thereby, costs for treatment, in particular treatment against periodontitis, may be substantially reduced, as well as increasing the quality of life for the patient.

According to yet another embodiment of the present invention, on the basis of the thus calculated second risk score, a risk level for the risk for progression of periodontitis or for developing periodontitis for the particular tooth may be determined, thus providing an objective measure of the risk for progression of periodontitis or for developing periodontitis associated with individual teeth pertaining to a patient, which measure is readily available to, e.g., a practitioner.

According to yet another embodiment of the present invention, a second set of numerical values may be produced, where each numerical value of the second set of numerical values is associated with a weight factor.

The second risk score may then be calculated further on the basis of the thus produced numerical values of the second set of numerical values as well as the associated weight factors.

In this manner, an increased versatility in calculating the second risk score is achieved in that for each weight factor, corresponding to a certain predictor promoting periodontitis for periodontitis progression or for developing periodontitis for a patient, there is an associated numerical value, thus increasing the number of ways of modifying the relative impact of a certain predictor on the determined risk level in view of potential future changes to the parameters of the risk assessment procedure according to the embodiment, as well as increasing the flexibility of the risk assessment procedure according to the embodiment.

According to yet another embodiment of the present invention, the step of receiving a second set of measures may further include assessing predictors promoting periodontitis comprising local predictors for periodontitis progression or for developing periodontitis for the respective tooth, and determining a second set of measures, where each of the measures of the second set of measures corresponds to one of the thus assessed predictors. This second set of measures may then be stored in a database. For example, in case of repeated risk assessments for a given individual or patient, the database in which the second set of measures was stored can be accessed by a clinician, or practitioner, or any other authorized person and subsequently, the second set of measures can be retrieved from the database.

According to yet another embodiment of the present invention, at least one of the weight factors associated with the second set of measures may be improved by performing the method according to the embodiment and comparing the thus determined risk level for the risk for progression of periodontitis or for developing periodontitis for the respective tooth with clinical measures on the progress of periodontitis or indications for developing periodontitis for the patient. On the basis of that comparison, the at least one of the weight factors may then be adjusted. Furthermore, according to yet another embodiment of the invention, at least one of the numerical values of the second set of numerical values may be improved by performing the method according to the embodiment and comparing the thus determined risk level for the risk for progression of periodontitis or for developing periodontitis for the respective tooth with clinical measures on the progress of periodontitis or indications for developing periodontitis for the patient, and on the basis of said comparison, the at least one of the numerical values may be adjusted.

In this manner, the performance of the method according to the embodiment may be gradually improved by repeated use of it. Thus, the results obtained from performing the method are compared with clinical data on the progress of periodontitis or indications for developing periodontitis for the patient, and this comparison may then form the basis for adjusting the model parameters, that is the weight factors associated with the second set of measures and/or the numerical values that may be associated therewith, to improve the performance of the method according to the embodiment.

According to yet another embodiment of the present invention, at least one of the weight factors and/or numerical values associated with the second set of measures may be adjusted on the basis of the thus calculated first risk score.

By such a configuration there is enabled, inter alia, to differentiate the calculation of the second risk score(s) depending on the outcome of the calculation of the first risk score, providing an increased flexibility and accuracy in the risk assessment procedure. For example, this enables implementation of a risk assessment scheme distinguishing between individuals suffering from periodontitis of varying severity. Thus, in this manner, especially for individuals suffering from a severe form of periodontitis, as indicated by high first risk scores, the calculation of second risk score(s) may be even further refined and thus quality measures, such as sensitivity, specificity and accuracy, of the risk for progression of periodontitis for individual teeth may be even further increased for those individuals (cf. the appended Example 2).

For each of the weight factors and/or numerical values associated with the second set of measures, a time factor may be assigned on the basis of the estimated temporal variation of the predictor corresponding to the measure that the respective weight factor is associated with.

On the basis of the thus assigned time factors and the respective weight factors and/or numerical values, a maximum time period during which the second risk score for the respective tooth will maintain a predetermined confidence level may be evaluated.

Hence, it is contemplated that the thus calculated second risk scores for individual teeth of a patient may be utilized for prognostication of disease progression. It is contemplated that a so called prognostic horizon of the thus calculated second risk scores may be obtained in this manner. By the term “prognostic horizon” it is meant the length of the time interval during which the prognosis for periodontitis progression on the basis of tooth-specific risk scores may be considered as being valid (e.g. to be within some predetermined confidence interval), provided that none of the measures corresponding to the risk predictors used in the analysis changes. In this way, the optimal frequency for performing the tooth-by-tooth risk assessment scheme for each patient may be determined (i.e. the frequency with which the risk assessment procedure should optimally be repeated). Such a configuration would even further facilitate treatment planning and enable preventive measures to be taken in time before severe and often irreversible damage has occurred.

According to an embodiment of the present invention, the host predictors may include at least one of the age of the patient in relation to history of periodontitis, the patient's family history of periodontitis, the patient's history of systemic disease and related diagnoses, and the result of a skin provocation test for assessing the inflammatory reactivity of the patient. According to another embodiment of the invention, the host predictors may comprise the age of the patient in relation to history of periodontitis, the patient's family history of periodontitis, the patient's history of systemic disease and related diagnoses, and the result of a skin provocation test for assessing the inflammatory reactivity of the patient.

This set of host predictors has been chosen for achieving optimal robustness, taking account synergy between the predictors, and accuracy, in that they comprise that most important host predictors promoting periodontitis, while keeping the set of predictors small enough so that the process of assessing the risk for periodontitis progression or for developing periodontitis and/or prognosticating the outcome of a treatment procedure for treating a patient suffering from periodontitis does not become cumbersome to perform.

According to another embodiment of the present invention, the systemic predictors may include at least one of patient cooperation and disease awareness, socioeconomic status, smoking habits, and the experience of the patient's dental therapist from periodontal treatment. According to yet another embodiment of the invention, the systemic predictors may comprise patient cooperation and disease awareness, socioeconomic status, smoking habits, and the experience of the patient's dental therapist from periodontal treatment.

This set of systemic predictors has been chosen for achieving optimal robustness, taking account synergy between the predictors, and accuracy, in that they comprise that most important systemic predictors promoting periodontitis, while keeping the set of predictors small enough so that the process of assessing the risk for periodontitis progression or for developing periodontitis and/or prognosticating the outcome of a treatment procedure for treating a patient suffering from periodontitis does not become cumbersome to perform.

According to yet another embodiment of the present invention, the local predictors may include at least one of the amount of dental bacterial plaque, endodontic pathology, furcation involvement, angular bony destruction, radiographic marginal bone loss, periodontal pocket depth, periodontal bleeding on probing, marginal dental restorations, and the occurrence of increased tooth mobility. According to another embodiment of the invention, the local predictors may comprise the amount of dental bacterial plaque, endodontic pathology, furcation involvement, angular bony destruction, radiographic marginal bone loss, periodontal pocket depth, periodontal bleeding on probing, marginal dental restorations, and the occurrence of increased tooth mobility.

This set of local predictors has been chosen for achieving optimal robustness, taking account synergy between the predictors, and accuracy, in that they comprise that most important local predictors promoting periodontitis, while keeping the set of predictors small enough so that the process of assessing the risk for periodontitis progression or for developing periodontitis and/or prognosticating the outcome of a treatment procedure for treating a patient suffering from periodontitis does not become cumbersome to perform.

According to yet another embodiment of the present invention, the assigning of a weight factor on the basis of the relative impact on the progress of periodontitis of the predictor may further comprise using furcation involvement, angular bony destruction, radiographic marginal bone loss, or any combination thereof, as a measure of the progress of periodontitis. Thus, furcation involvement, angular bony destruction, radiographic marginal bone loss, or any combination thereof, may be used as an outcome variable if disease is present, in contrast to conventional schemes, where gingival bleeding, tissue loss and attachment loss is generally employed as outcome variables in assessing whether disease is present. Hence, the embodiment of the present invention enables preventive measures to be taken in time before severe and often irreversible damage has occurred, as the outcome variables according to the embodiment may be used to indicate disease at a much earlier stage than the conventional outcome variables.

According to an embodiment of the present invention, the risk assessment scheme for assessing the risk for periodontitis progression or for developing periodontitis and/or the scheme for prognosticating the outcome of a treatment procedure for treating a patient suffering from periodontitis may be directed to chronic periodontitis.

According to an embodiment of the present invention, a first set of numerical values may be produced, where each numerical value of the fist set of numerical values is associated with a weight factor. The biased risk score may be calculated further on the basis of the thus produced numerical values, that is both on the basis of the thus produced numerical values and the associated weight factors.

In this manner, an increased versatility in calculating the biased risk score is achieved in that for each weight factor, corresponding to a certain predictor promoting periodontitis for periodontitis progression or for developing periodontitis for a patient, there is an associated numerical value, thus increasing the number of ways of modifying the relative impact of a certain predictor on the prognostication of the outcome of a treatment procedure for treating a patient in view of potential future changes to the parameters of the risk assessment procedure according to the embodiment, as well as increasing the flexibility of the risk assessment procedure of the embodiment.

According to another embodiment of the present invention, the step of receiving a set of measures may further include assessing predictors promoting periodontitis comprising host predictors, systemic predictors and local predictors for periodontitis progression or for developing periodontitis for the patient, and determining a set of measures, where each of the measures of the set of measures corresponds to one of the thus assessed predictors. This set of measures may then be stored in a database. For example, in case of repeated prognosticating for a given individual or patient, the database in which the set of measures was stored can be accessed by a clinician, or practitioner, or any other authorized person and subsequently, the set of measures can be retrieved from the database.

According to an embodiment of the present invention, the device according to the invention further may include at least one database, wherein the processing unit is further adapted to store a first and/or a second set of measures, where each of the measures of the first and/or second set of measures corresponds to one of a plurality of predictors promoting periodontitis comprising host predictors, systemic predictors and local predictors for periodontitis progression or for developing periodontitis for the patient, in the at least one database. For example, in case of repeated risk assessment for a given individual or patient, the database in which the first and/or second set of measures was stored can be accessed by a practitioner or any other authorized person by means of the processing unit and subsequently the first and/or second set of measures can be retrieved from the database.

According to another embodiment of the present invention, the processing unit may be further adapted to receive clinical measures on the progress of periodontitis or indications for developing periodontitis for the patient, compare the thus determined risk level for the risk for progression of periodontitis or for developing periodontitis with the thus received clinical measures on the progress of periodontitis or indications for developing periodontitis for the patient, and on the basis of the comparison adjust at least one of the weight factors associated with the first and/or second set of measures and/or at least one of the numerical values of the first and/or second set of numerical values.

In this manner, the performance of the device according to the embodiment may be gradually improved by repeated use of it. Thus, the results obtained from using the device are compared with clinical data on the progress of periodontitis or indications for developing periodontitis for the patient, and this comparison may then form the basis for adjusting the model parameters, that is the weight factors associated with the first set of measures and/or the numerical values that may be associated therewith, to improve the performance of the device according to the embodiment.

Due to the nature of dental disease, particularly its progression over time, and also the variability of the risk predictors pertaining to a given individual over time because of changed habits, lifestyle, etc. of the patient, prognostication of the patient as a whole or tooth-by-tooth, as well as risk assessment, according to any one of the different exemplifying embodiments of the present invention as have been described in the foregoing and in the following should advantageously be repeated at regular intervals, for example at a dental practice and performed by a dental practician. In other words, the accuracy of the results of prognostication for the patient as a whole or tooth-by-tooth, as well as risk assessment, according to the different exemplifying embodiments of the present invention as have been described in the foregoing and in the following, generally are not valid indefinitely but need to be reestablished at regular intervals, for example in connection to or as a part of the patient's regular visits to a dental practice or the like where dental treatment and check-ups are performed.

In the context of the invention, by the term “dentition” it is meant the character of a set of teeth especially with regard to their number, kind, and arrangement in the mouth.

Other objectives, features and advantages of the present invention will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, unit, means, step, etc]” are to be interpreted openly as referring to at least one instance of said element, device, component, unit, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the invention, will be better understood through the following illustrative and non-limiting detailed description of preferred embodiments of the invention, with reference to the appended drawings, where the same reference numerals are used for identical or similar elements, wherein:

FIG. 1 shows a listing of host predictors, systemic predictors and local predictors promoting periodontitis progression or development;

FIG. 2 shows a listing of different systemic diseases or other diagnoses or conditions;

FIG. 3 shows the proportional relative impact of host, systemic and local predictors for assessing the risk for periodontitis progression or for developing periodontitis for the patient (for the case when all numerical values associated with the respective predictor are maximal) according to an exemplary embodiment of the invention;

FIG. 4 shows the proportional relative impact of host, systemic and local predictors for assessing the risk for periodontitis progression or for developing periodontitis for individual teeth of the patient (for the case when all numerical values associated with the respective predictor are maximal) according to an exemplary embodiment of the invention;

FIG. 5A is a schematic illustration of an exemplary embodiment of the invention;

FIG. 5B is a schematic illustration of other exemplary embodiments of the invention;

FIGS. 6-20 present clinical data and statistical measures from a prospective clinical trial over a period of four years for evaluating the performance characteristics of the present invention or embodiments thereof;

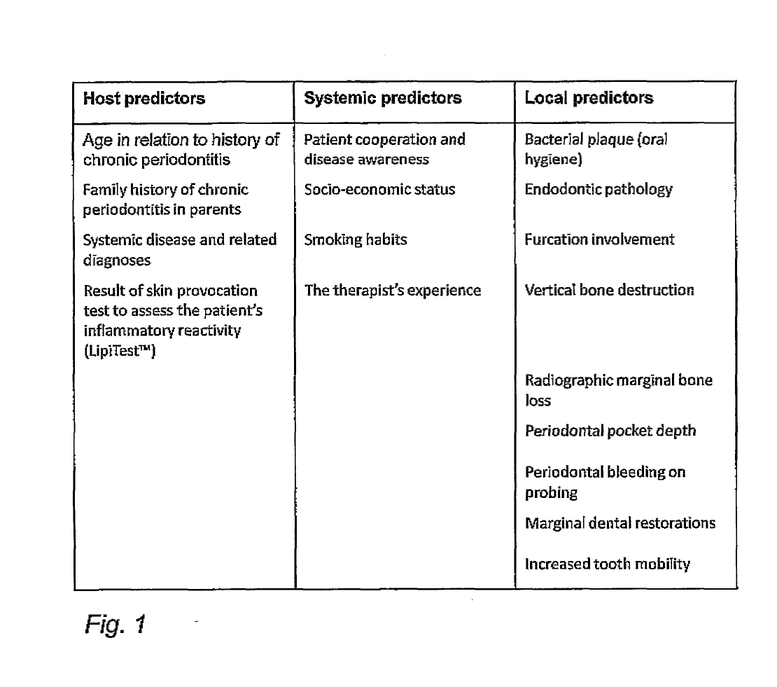

FIG. 1.1 is a schematic view illustrating the principles of an exemplifying embodiment of the present invention;

FIGS. 1.2a-1.2c are photographs illustrating the principles of an exemplifying embodiment of the present invention; and

FIGS. 1.3-1.8 present clinical data for the clinical trial described in the appended Example 1.

### DETAILED DESCRIPTION OF PREFERRED EMBODIMENTS

An increasing number of risk predictors associated with progression and/or development of periodontitis have been identified over the past decades in a number of studies as reported in the periodontal literature. The primary etiological predictor of periodontal disease that has been identified is an indigenous pathogenic bacterial plaque or biofilm. However, there are also host predictors (patient predictors), as well as a number of predictors that influence the patient's susceptibility to periodontal disease and modify disease progression. When predictors such as these accumulate and work in synergy, episodes of disease development or progression may occur.

Predictors promoting periodontitis progression may be divided into systemic and local risk predictors that modify the host's (or patient's) response to the primary etiological predictor (bacteria). Local predictors may exert their influence on one or more teeth, in contrast to systemic modifying predictors, which invariably affect all teeth. A number of the systemic predictors may have a genetic background. Such host, systemic and local predictors are listed in FIG. 1.

Periodontitis is thus a multifactorial disease. The risk factors may interact and reinforce or reduce the effects of each other. They may influence either growth or composition of the bacterial plaque, which in turn may elicit an inflammatory response, or influence growth or composition of the inflammatory response itself. Because of its complex nature, conventional methods for risk assessment of progression and/or development of periodontitis, as well as methods for prognostication, such as prognostication of the outcome of a treatment procedure against periodontitis, show great variability between clinicians.

In the following, host predictors for periodontitis progression or for developing periodontitis, for example the age of the patient in relation to history of periodontitis, the patient's family history of periodontitis, the patient's history of systemic disease and related diagnoses and the result of a skin provocation test for assessing the inflammatory reactivity of the patient, will be briefly described.

### The Patient's Age in Relation to the Patient's History of Periodontitis

Older individuals generally suffer from more advanced periodontitis and generally have fewer remaining teeth than younger individuals. Some longitudinal studies indicate age to be a risk predictor for alveolar bone loss or clinical attachment loss. However, the fact that older individuals have less remaining teeth and less attachment seems not to depend on less capable defense mechanisms against periodontitis pathogens in older individuals, but may rather be explained by an accumulated influence of periodontitis-stimulating predictors as individuals grow older.

### Family History of Periodontitis (Genetic Aspects) and the Result of a Skin Provocation Test

In its severe form, periodontitis affects roughly 10% of the population in industrialized countries leading to partial or complete tooth loss, indicating an individual susceptibility to develop the disease. Differences between individuals in the innate immune system have previously been proposed a plausible explanation. The variation may have a polygenetic background. A clinical aspect of individual immune variability with respect to periodontitis development has earlier been demonstrated by the inventors (S. Lindskog et al., “Skin-prick test for severe marginal periodontitis”, Int. J. Periodontol. Rest. Dent. vol. 4, p. 373-377 (1999), which is hereby incorporated by reference in its entirety) by a decreased reactivity to Lipid A administered through a simple skin-prick test for assessing the inflammatory reactivity of patients suffering from refractory periodontitis.

### Systemic Disease and Related Diagnoses

There are several reviews of the role of systemic disease and related conditions in development and progression of periodontitis in the literature (for example, R. A. Seymore and P. A. Heasman, “Drugs, Diseases and Periodontium”, Oxford Medical Publications (1992), and R. J. Genco and H. Löe, “The role of systemic conditions and disorders in periodontal disease”, Periodontology 2000, vol. 2, p. 98-116 (1993)). Although not of direct etiological importance, systemic disease, particularly chronic diseases, may be of critical importance for periodontal conditions during active periods of systemic disease. The following systemic diseases and conditions represent the most important ones based on relative impact on the development and progression of periodontitis, as indicated by several earlier studies in the field: obesity, nutritional deficiencies, alcohol consumption, diabetes mellitus, aids, pregnancy, osteoporosis, blood disorders and immune deficiencies, Sjögren's syndrome, renal disease, granulomatous disease, monogenetic disease relevant to an impaired immune response or chromosomal aberrations, such as Down's syndrome, and medication which influence the gingival or saliva. It is to be understood that this list is not exhaustive.

In the following, systemic predictors for the development or progression of periodontitis, for example patient cooperation and disease awareness, the patient's socioeconomic status, the patient's smoking habits, and the experience of the patient's dental therapist from periodontal treatment, will be briefly described.

### Patient Cooperation and Disease Awareness

A number of earlier studies in the art have shown that the patient's compliance with oral hygiene instructions is crucial to regain and maintain periodontal health. In this regard, the patient's disease awareness and understanding of periodontal therapy must be considered to be as important as compliance with oral hygiene instructions.

### Socioeconomic Status

Early as well as later studies have shown that low socioeconomic status, low education level, social isolation, mental illness, low income, as well as anxiety and depression, correlate with poor periodontal status.

### Smoking Habits

Smoking is a predictor that influences the entire dentition (that is, the character of a set of teeth especially with regard to their number, kind, and arrangement in the mouth) of an individual, but it may also be considered as a local predictor. Earlier studies have indicated that smokers generally have deeper periodontal pockets and more attachment loss than control patients. Also, it has been indicated that smokers are over-represented at periodontal specialist clinics, and that heavy smokers (having a cigarette consumption exceeding twenty cigarettes a day) have a five-fold higher risk of periodontitis progression compared to matched groups of non-smokers with periodontitis. Even after considering the hygiene predictor as a confounder, the relationship between smoking and attachment loss seems to be evident. It has been demonstrated that individuals who quit smoking lose more attachment within a ten-year period than individuals who never smoked. Furthermore, it has been demonstrated that 85 to 90% of patients suffering from refractory periodontitis have been reported to be smokers. In this context, it is interesting to note that tobacco consumed as snuff has only been found to influence attachment loss at the sites of application (that is, at the site where the snuff is placed in the mouth) but not in other locations.

The Therapist's Knowledge and Experience from Periodontal Treatment

A number of studies have emphasized the importance of the therapist's knowledge and experience from periodontal treatment for choice of periodontal treatment procedures, and consequently the outcome of the periodontal treatment procedure. This may be important for periodontal healing and disease prognosis.

In the following, local predictors for periodontitis progression or for developing periodontitis, for example the amount of dental bacterial plaque, endodontic pathology, furcation involvement, periodontal pocket depth, periodontal bleeding on probing and the occurrence of increased tooth mobility, will be briefly described.

### Dental Bacterial Plaque and Plaque-Retaining Predictors (Oral Hygiene)

There is a general consensus in periodontal literature that marginal dental plaque is the predominant local predictor for initiation and progression of gingivitis and periodontitis. As has been indicated in a number of studies in the art, plaque-retaining predictors, such as crowding of teeth, tooth anatomy, calculus and restorations, are local predictors related to the individual tooth that accumulate plaque and thereby influences the progression of periodontitis and also the outcome of periodontal treatment. Furthermore, it has been demonstrated that an overhanging restoration retains more plaque than a smooth junction between the tooth and the root surface. The distance between the gingival margin and the restoration appears also to be of importance for marginal periodontal conditions. Other studies have shown that the further away from the gingival margin the restoration is located, the less negative impact it has on marginal periodontal conditions. In addition, maintenance therapy appears to be crucial for the periodontal healing result, including plaque control and individually adjusted periodic professional tooth cleaning and root debridement. Several reviews exist in the periodontal literature (for example, J. Egelberg, “Periodontics. The scientific way. Synopsis of clinical studies.”, 3^{rd} edition, OdontoScience, Malmö (1999)).

### Endodontic Pathology

Within the field of dental traumatology, it is well known that an infected root canal influences periodontal status and healing in teeth with a compromised periodontium. With the periodontium it is meant the specialized tissues that both surround and support the teeth. It has been demonstrated that endodontic plaque within the root canal promotes apical epithelial down-growth on a root surface void of a protecting root cementum layer. It has also been reported that teeth having advanced periodontitis in combination with a root canal infection exhibit deeper periodontal pockets, more radiographic attachment loss, increasingly frequent angular bony defects and a higher rate of attachment loss compared to endodontically intact teeth and root-filled teeth not having periapical pathology. It must however be emphasized that these findings apply to a group of periodontitis-prone patients void of cervical protecting root cementum. The same findings cannot be expected in patients not suffering from periodontitis and thus having an intact cervical root cementum. In addition, intracanal medication may have a similar effect on the periodontium in teeth void of cementum coverage. Both clinical and experimental studies have shown that root canal treatment with calcium hydroxide may have a negative influence on periodontal healing in teeth void of a protecting cementum layer, similar to what has been seen in teeth with a root canal infection.

Furcation Involvement

As known in the art, by furcation involvement it is meant a depression in the furcation area (the area where multiple roots diverge from the tooth). It has been indicated that multi-rooted teeth, especially such teeth with furcation involvement, appear to be at a higher risk for periodontitis progression than molars and premolars without furcation involvement or single-rooted teeth.

Increased Tooth Mobility

Neither jiggling nor traumatizing occlusion applied to a healthy periodontium results in pocket formation or loss of supporting connective tissue attachment. However, as has been demonstrated in the art, the presence of plaque trauma from occlusion may result in resorption of alveolar bone and increased tooth mobility in periodontitis-prone patients, and thus result in periodontitis progression.

### Periodontal Pocket Depth, Bleeding on Probing and Pus

It has been indicated that the presence of plaque at the gingival margin presents a limited risk for disease progression in patients on an individual maintenance care program following both surgical and non-surgical periodontal therapy. Gingival suppuration (formation or discharge of pus) seems to be superior to bleeding on probing for prognosticating disease progression for patients on such maintenance care programs. Furthermore, patients having deeper residual pockets run a higher risk of disease progression than patients with shallower residual pockets, based on a number of studies on disease progression in patients participating in maintenance care programs. According to a recent study in the art, individuals with low mean bleeding on probing percentages (less than 10% of the surfaces) may be regarded as patients with low risk for recurrent periodontal disease, while patients with mean bleeding on probing percentages exceeding about 25% may be considered to be at high risk for periodontal breakdown.

Furthermore, patients with a history of periodontitis seem to have a higher susceptibility for further attachment loss than periodontally healthy individuals. Also, angular bony defects have been proposed to be an indicator of risk for further attachment loss.

According to an exemplary embodiment of the invention, a first set of numerical values may be produced, wherein each numerical value of the first set of numerical values is associated with a weight factor, and wherein the first risk score is calculated on the basis of both the thus produced numerical values of the first set of numerical values and the weight factors associated therewith. Each weight factor in turn corresponds to a measure of a predictor promoting periodontitis comprising host predictors, local predictors, and systemic predictors for periodontitis progression or for developing periodontitis for a patient, as has been previously described. In other words, each such predictor may be associated with a numerical value.

In the following, a schematic overview of the procedure of assigning numerical values x of a first set of numerical values according to an exemplary embodiment of the invention will be presented. It is to be understood that the particular choice of numerical values and weight factors generally depends on factors such as, for example, outcomes of clinical measurements on the progress of periodontitis or indications for developing periodontitis for patients, which may prompt the user to vary, for example, one or more, or all, of the numerical values and/or the weight factors w associated therewith (cf. the appended Example 1).

The numerical value associated with the age of the patient in relation to history of periodontitis may be based on an assessment of the degree of radiographic bone loss around any remaining teeth in relation to the patient's age.

The predictor of family history of periodontitis in parents may be assigned different numerical values on the basis of the assessment of whether both parents are affected by periodontitis, if only one parent is known to have the disease, or if none of them are affected.

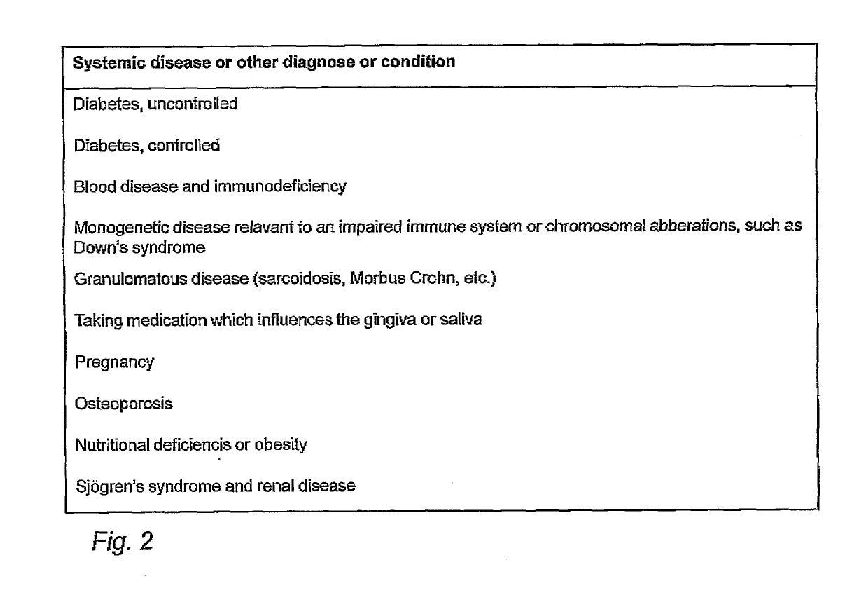

Each presence of a number of relevant systemic diseases and other diagnoses/conditions (see FIG. 2) may be assigned an associated numerical value x depending on the relative influence of the systemic diseases and other diagnoses/conditions on periodontitis.

The result of a skin provocation test for assessing the patient's inflammatory reactivity (DentoTest™) at three different concentrations of Lipid A (0.1, 0.01 and 0.001 mg/ml) may be associated with a specific numerical value x depending on the number of negative reactions to the test.

The numerical value x associated with the percentage of plaque-covered tooth surfaces may be set to an increasingly higher value for increasingly higher percentages.

The numerical value x associated with patient cooperation and disease awareness may be set to different values on the basis of whether the patient cooperation and disease awareness is substantially none, if there is some patient cooperation and disease awareness, or if the patient cooperation and disease awareness is high.

The numerical value x associated with the percentage of teeth with endodontic radiographic pathology, the numerical value x associated with the percentage of teeth with furcation involvement, and the numerical value x associated with the percentage of teeth with angular bony destruction may be set to increasingly higher values for increasingly higher percentages.

The numerical value x associated with the degree of radiographic marginal bone loss around remaining teeth may be set according to increasingly higher values for increasingly higher values of marginal bone loss.

The numerical value x associated with the patient's socioeconomic status may be set on the basis of an assessment of whether negative stress including alcohol abuse is present, if financial problems are present, or if a combination of negative stress, including alcohol abuse, and financial problems is present.

The numerical value x associated with the patient's smoking habits may be set depending on the degree of cigarette consumption, for example be set to increasingly higher values for increasingly larger daily consumption of cigarettes. If the patient does not smoke, the numerical value x associated with the patient's smoking habits may be set to zero.

The numerical value x associated with the therapist's experience with therapy planning in periodontal care may be set, for example, on the basis of whether the experience is non-existent or negligible, if the therapist has some experience, or if the therapist's experience is extensive.

The numerical value x associated with the percentage of teeth with periodontal pockets may be set to zero if such periodontal pockets are less than some predetermined value, for example less than 4 mm. Furthermore, if such periodontal pockets are higher than the predetermined value, the numerical value x may for example be set to increasingly higher values for increasingly higher percentages of teeth with periodontal pockets.

The numerical value x associated with the percentage of teeth with periodontal pockets that bleed on probing, the numerical value x associated with the percentage of teeth with teeth with proximal restorations, and the numerical value x associated with the percentage of teeth with increased mobility may be set to increasingly higher values for increasingly higher percentages.

The numerical value x associated with past smoking habits may be set to a non-zero value if, for example, the patient stopped smoking (at a daily consumption of more than fifteen cigarettes) less than, e.g., five years ago. If the patient's never has smoked, it may be set to zero. Of course, other criteria for the setting of this numerical value and others presented in the foregoing and in the following may be envisaged.

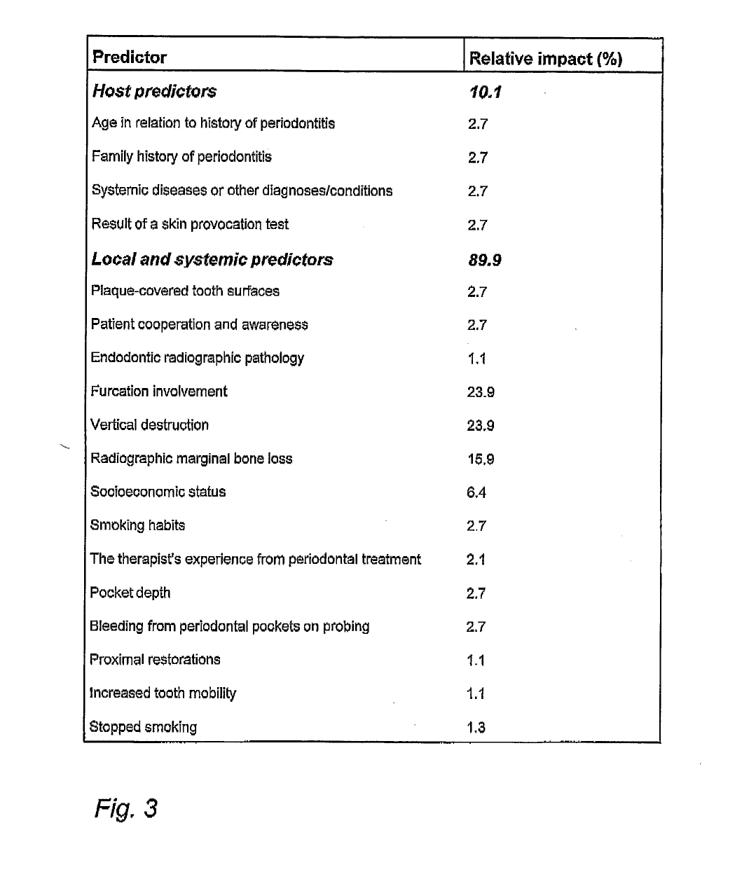

FIG. 3 presents the proportional distribution (in %) of predictors used in calculating the risk level for the risk for progression of periodontitis or for developing periodontitis for the patient (for the case when all numerical values associated with the respective predictor are maximal) for an exemplary embodiment of the invention.

If the calculated first risk score exceeds a predetermined threshold value, which for example may be set according to the first risk score representing an “increased risk” for the individual's dentition to develop periodontitis, a further in-depth analysis for assessing the risk for periodontitis progression or for developing periodontitis, for each tooth of the patient, may be performed. A second set of numerical values may then be produced, wherein each numerical value of the second set of numerical values is associated with a weight factor, and wherein a second risk score is calculated on the basis of both the thus produced numerical values of the second set of numerical values and the weight factors associated therewith. Each weight factor corresponds in turn to a measure of a predictor promoting periodontitis comprising local predictors for periodontitis progression or for developing periodontitis for the respective tooth, as has been previously described. In other words, each such local predictor may be associated with a numerical value.

In the following, a schematic overview of the procedure of assigning numerical values x of a second set of numerical values according to an exemplary embodiment of the invention will be presented. It is to be understood that the particular choice of numerical values and weight factors generally depends on factors such as, for example, outcomes of clinical measurements on the progress of periodontitis or indications for developing periodontitis for patients, which may prompt the user to vary, for example, one or more, or all, of the numerical values and/or the weight factors w associated therewith (cf. the appended Example 1).

The numerical value x associated with plaque-covered tooth surface may be set on the basis of, for example, whether there is no plaque covering the surface of the particular tooth, if there is buccal/lingual plaque present or if there is proximal plaque present.

The numerical value x associated with endodontic radiographic pathology may be set on the basis of, for example, whether there is no endodontic radiographic pathology present or if periapical radiolucency is present.

The numerical value x associated with furcation involvement may be set depending on, for example, whether there is no furcation involvement whatsoever or, in case a furcation involvement is present, the observed probing depth.

The numerical value x associated with angular bony destruction may for example be set on the basis of whether angular bony destruction is present or not.

The numerical value x associated with radiographic marginal bone loss may, for example, be set increasingly higher for increasingly higher values of marginal bone loss.

The numerical value x associated with periodontal pocket depth may, for example, be set increasingly higher for increasingly higher values of observed pocket depth.

The numerical value x associated with bleeding from periodontal pockets on probing may for example be set on the basis of the assessment of whether no bleeding on probing is present, if bleeding is present on probing, or if both bleeding and pus are present on probing.

The numerical value x associated with proximal restorations may for example be set on the basis of the assessment of whether a supra restoration is present, a subgingival restoration is present or a margin with or without overhang is present.

The numerical value x associated with increased mobility of a particular tooth may for example be set on the basis of the assessment of whether the tooth is a molar or the tooth is any other tooth than molar.

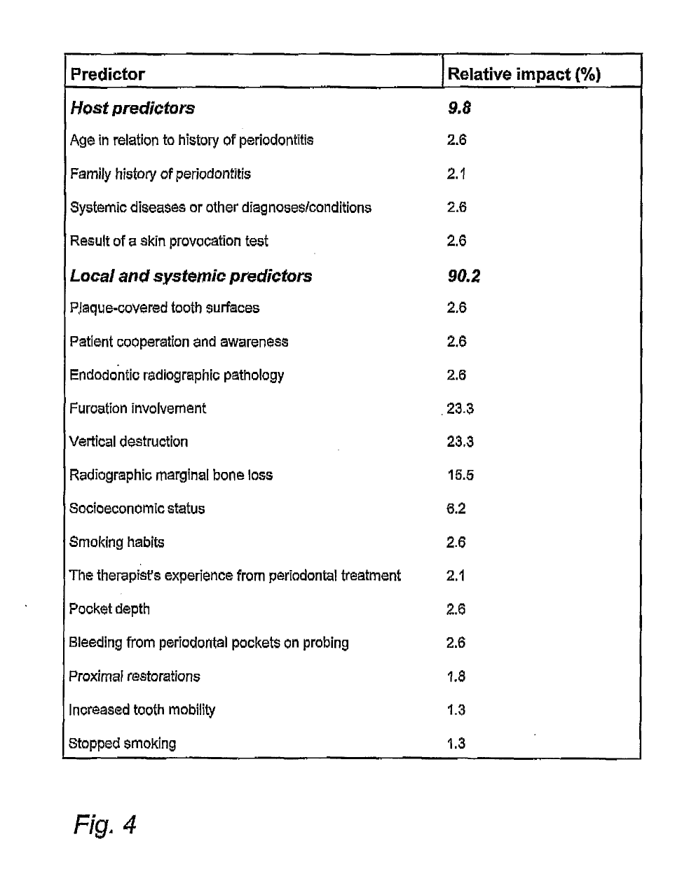

FIG. 4 presents the proportional distribution (in %) of the predictors used in calculating the risk level for the risk for progression of periodontitis or for developing periodontitis for the respective tooth of the patient (for the case when all numerical values associated with the respective predictor are maximal for an exemplary embodiment of the invention.

According to an exemplary embodiment of the invention, denoting the n weight factors and associated numerical values wᵢ and xᵢ, respectively, where i=1, 2, . . . , n, the first and second risk scores may be calculated according to the quotient:

$$\frac{{W}_{1} \cdot {X}_{1} + {W}_{2} \cdot {X}_{2} + … + {W}_{n} \cdot {X}_{n}}{{W}_{1} \cdot {X}_{1 , max} + {W}_{2} \cdot {X}_{2 , max} + … + {W}_{n} \cdot {X}_{n , max}} ,$$

where x_{i,max} denotes the maximum value that may be assigned to the numerical value xᵢ.

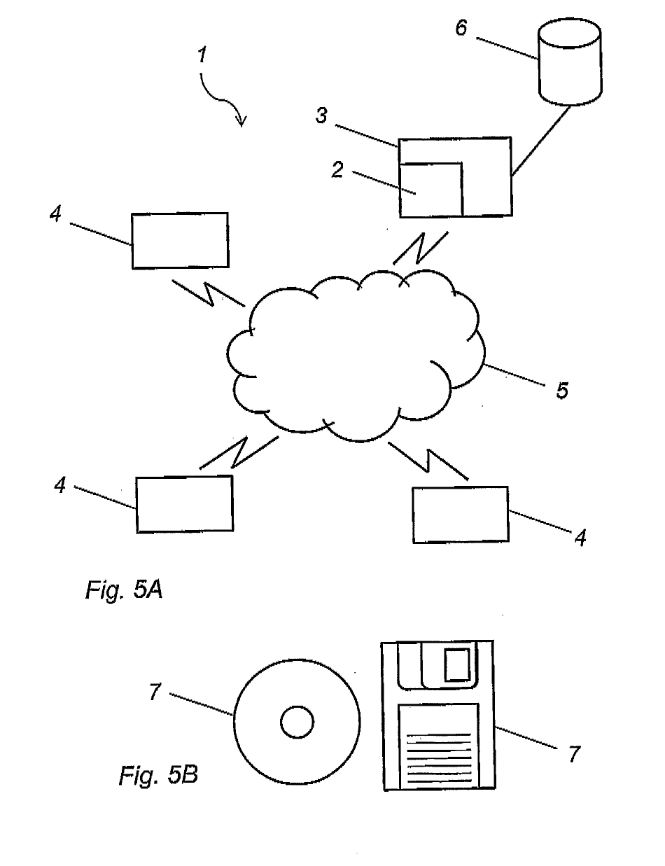

FIG. 5A illustrates an exemplary embodiment of a system 1 for assessing the risk of periodontitis or for developing periodontitis for a patient and/or for prognosticating the outcome of a treatment procedure for treating a patient suffering from periodontitis, the system 1 including a control and processing unit 2 adapted to perform a method for assessing the risk for the progression of periodontitis for a patient according to the first aspect of the invention or embodiments thereof and/or a method for prognosticating the outcome of a treatment procedure for treating a patient suffering from periodontitis according to the third aspect of the invention or embodiments thereof. According to the illustrated embodiment, the control and processing unit 2 is located on a central server 3 or the like adapted to communicating with a plurality of user devices or satellite stations 4 via a private or public network 5, such as the Internet. For example, such user devices or satellite stations 4 may be located at dental practices or the like where dental treatment is performed. In this exemplary case, the control and processing unit 2 may communicate with three such user devices or satellite stations 4. However, it is to be understood that any number of such user devices or satellite stations 4 is envisaged and is within the scope of the invention.

Furthermore, it is to be understood that the communications over the public or private network 5 as mentioned above may be performed via a wireless communications medium or via electrical conductors (“wires”). It is further to be understood that the communications may be performed such that they are protected from third party tampering, as well known in the art.

The central server 3 may be a secure web server that responds to communications from the Internet, although it is not limited to this exemplary case. Such servers are available from many vendors. Because the communications procedures of the central server 3 as such are not essential to the invention, detailed description thereof is omitted.

The system 1 may further comprise a database 6 which may communicate with the central server 3 (or communicate directly with the control and processing unit 2) and is capable of digitally storing user data or other data, for example comprising a set of measures, where each measure of the set corresponds to one of plurality of predictors promoting periodontitis progression comprising host predictors, local predictors and systemic predictors for periodontitis progression for the patient on the whole or for individual teeth of the patient. It is understood that the database 6 may be isolated from the network 5 by a firewall. By a firewall it is meant a computing machine configured to enable communication only for authorized users, operating on principles well known in the art. Firewalls are available from many vendors.

At the user devices or satellite stations 4, users may perform the risk assessment method or the prognostication method according to the invention by uploading, for example via a computerized data entry module implemented locally at the user end, patient data in the form of one or more set of measures to the central server 3 or directly to the control and processing unit 2, wherein each measure of the one or more set of measures corresponds to one of a plurality of predictors promoting periodontitis comprising host predictors, local predictors, and systemic predictors for periodontitis progression or for developing periodontitis for a patient and/or for individual teeth of the patient.

Thus, the assignment of the numerical values associated with the predictors may be performed via a computerized data entry module. Numerical or dichotomous values for each predictor in FIG. 1 may be entered by the user (clinician) into the control and processing unit 2 by way of simple menus associated with the two different levels of analysis, namely the calculation of a first risk score for periodontitis progression and for developing periodontitis for the patient and a second risk score for periodontitis progression or for developing periodontitis for an individual tooth of the patient, respectively. Furthermore, at both levels of analysis a biased risk score for progression of periodontitis for the patient may be calculated by entering numerical or dichotomous values for each predictor in FIG. 1 into the control and processing unit 2.

For the calculation of the first risk score or the biased risk score, the user enters answers to a number of questions pertaining to the patient, where each question has a predefined number of alternative answers that match the patient's risk predictor status. Similarly, for the calculation of the second risk score or the biased risk score, the user (clinician) enters answers to a number of questions pertaining to the individual teeth of the patient, where each question has a predefined number of alternative answers that match the patient's risk predictor status with respect to the individual teeth. Thus, it is not possible to register any other answers than those of the predefined set of alternatives. Thereby, it is only possible to register objective data on the predictors shown in FIG. 1, thus avoiding any subjective assessments by the user (clinician) entering registering the data.

The data entered into the computerized data entry module may be coded for increased security and protection of the patient's identity. Furthermore, preferably only registered users may access the data entry module by entering a registered user name and a password corresponding therewith. Once the patient data has been uploaded to the control and processing unit 2, the control and processing unit 2 may immediately start performing the method according to the first and/or third aspect of the invention or embodiments thereof. The result may then immediately and/or automatically be sent back to the user depending on the capacity of the communications path or connection between the control and processing unit 2 (or central server 3) and the user device 4.

The system 1 for assessing the risk of periodontitis or for developing periodontitis for a patient and/or the system for prognosticating the outcome of a treatment procedure for treating a patient suffering from periodontitis may be arranged such that only an authorized, registered dental clinician may link the results obtained from the control and processing unit 2 to the individual patient's case records, thus protecting the identity of the patient. The result may be saved and printed by such a dental clinician.

Thus, in clinical praxis the invention provides dental care with an objective, analytical tool supporting a clinician in treatment planning and making clinical decisions. The invention may identify individuals at risk of developing periodontitis and prognosticate disease development and/or the outcome of a treatment procedure for treating a patient suffering from periodontitis, thus securing quality in treatment planning, communication between the dental clinician and the patient, and instigation of periodontal care.

According to other aspects of the invention, there is provided a computer program that is implemented in the processing unit 2, wherein the computer program comprises computer code for performing a method according to the first aspect of the invention or embodiments thereof and/or a method according to the third aspect of the invention or embodiments thereof. The computer program may be written in any suitable programming language, examples of which are, but not limited to, C, C++, C#, and Java.

As illustrated in FIG. 5B, according to further aspect of the invention, there is provided a digital storage medium 7, examples of which are, but not limited to, a CD, a DVD, a floppy disk, a hard-disk drive, a tape cartridge and an USB memory device, readable by a computer, on which digital storage medium 7 there is stored a computer program comprising computer code for performing a method according to the first aspect of the invention or embodiments thereof and/or a method according to the third aspect of the invention or embodiments thereof.

### Performance Characteristics of the Present Invention

The risk levels for the risk for progression of periodontitis or for developing periodontitis for the patient and for the risk for progression of periodontitis or for developing periodontitis for the respective tooth are determined on the basis of the thus calculated first and second risk score (or DentoRisk™ Score or DRS), respectively. In the following, the first and second risk score will also be referred to as “DentoRisk™ Level I” and “DentoRisk™ Level II”, respectively. The performance characteristics of the present invention have been evaluated in a series of clinical tests in which clinical data from a prospective clinical trial over a period of four years was used, cf. the appended Example 1. DentoRisk™ Level I and DentoRisk™ Level II are referred to in the appended Examples as DRS_{dentition} and DRSₜₒₒₜₕ, respectively.

Throughout this description, radiographic bone loss, development of furcation involvement and angular bony destruction were used in combination as a measure of periodontitis progression. If one or more of the three disease indicators were present, periodontitis was considered to have progressed. For comparison, radiographic bone loss was studied separately. As a first step, the variables (host, systemic and local predictors) to be included in the methods were correlated to progression of periodontitis for the whole material as well as within the different risk score (DentoRisk™ Score) intervals. In a second step, the risk scores (DentoRisk™ Scores) calculated by the methods according to the invention were correlated to the outcome variable (number of disease progression indicators), and relevant statistical measures were calculated.

Multivariate linear regression was used to investigate the relationship between a numerical outcome variable (number of disease progression indicators) and explanatory variables (predictors). As known in the art, multi-variate linear regression is the extension of simple linear regression used when more than one explanatory variable is suspected to affect the response variable. Multivariate linear regression may tell how much an increase of one unit in each explanatory variable (or parameter thereof) affects progression of periodontitis under the assumption that all other explanatory variables are constant. The relationship between such variables can be modeled using regression or so-called ordinary least squares regression. As a supplement to the parameter value (estimator) β, the regression coefficient or explanatory value (or coefficient of determination) R₂ is presented. The regression coefficient is a value that ranges from zero to one and which may tell how much of the variation in the outcome variable that is explained by variation of the explanatory variables or the variation that is “shared” by the variables.

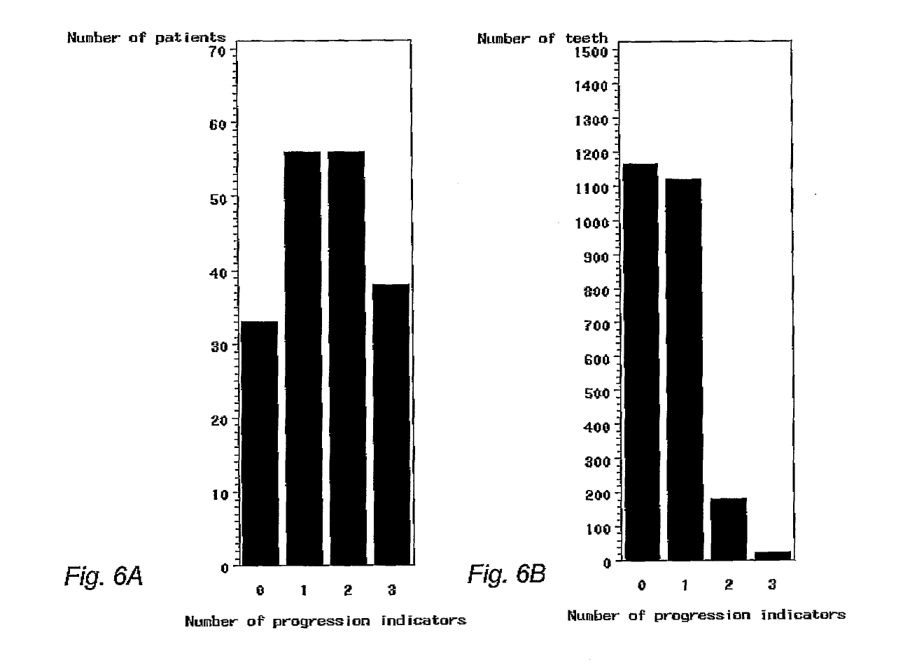

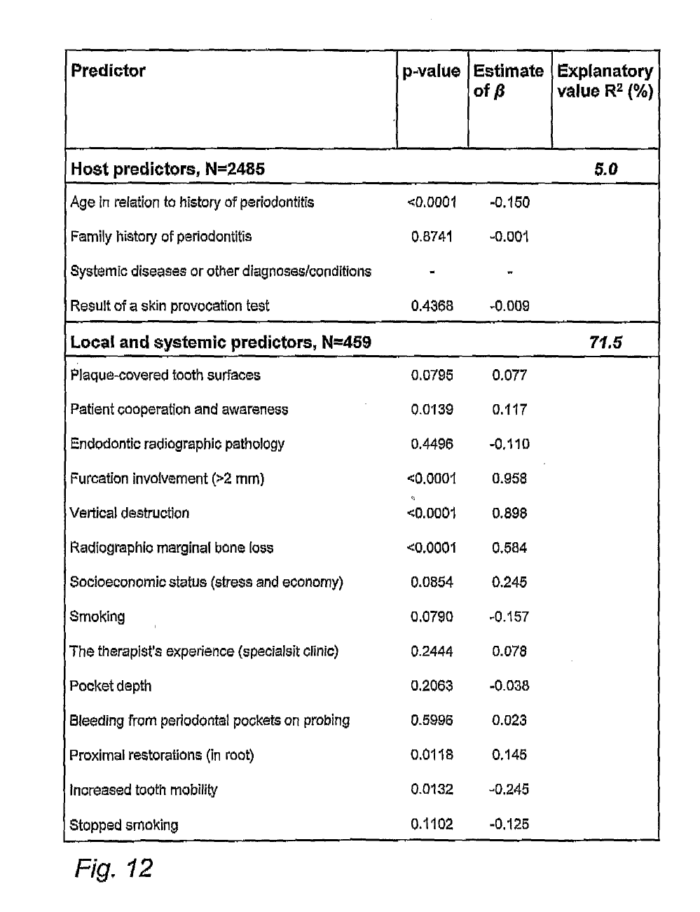

FIGS. 6-20 present data obtained from the above-mentioned prospective clinical trial over a period of four years and statistical measures, as described in the following.

FIGS. 6A and 6B are graphs over the number of patients (total number of patients N=183) and number of teeth (total number of teeth N=2928), respectively, distributed against the number of periodontitis disease progression indicators (ranging from 0 to 3) from the prospective clinical trial over approximately four years that was used for the performance tests of the present invention.

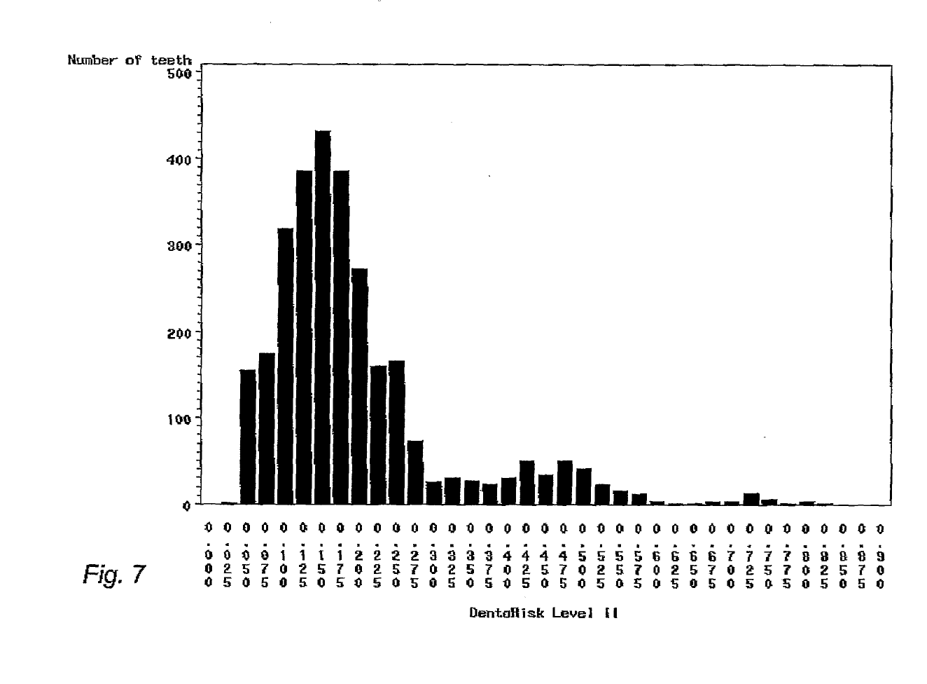

FIG. 7 is a graph of the number of teeth (total number of teeth N=2928) distributed against the DentoRisk™ Level II Score intervals from the prospective clinical trial over approximately four years that was used for the performance tests of the present invention.

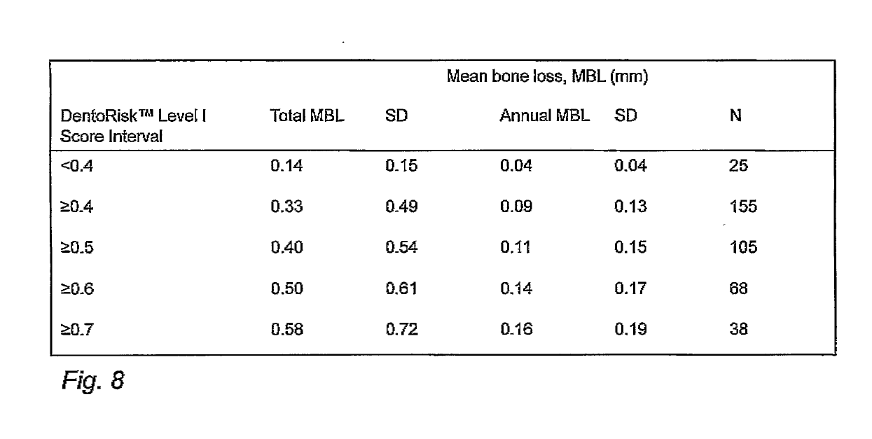

Correlation of DentoRisk™ Scores from Level I (pertaining to the dentition of the patient as a whole, as described above) to the outcome variable (number of disease progression indicators) presented a strong correlation (correlation coefficient r=0.723, significance p<0.0001, N=183). Linear regression between DentoRisk™ Scores from Level I and the outcome variable yields an overall explanatory value R² of 53.1% (parameter value β=5.1, p<0.0001, N=183). As illustrated by FIG. 8, the mean marginal radiographic bone loss increases with increasing DentoRisk™ Score. With reference to FIG. 8, “SD” corresponds to the standard deviation.

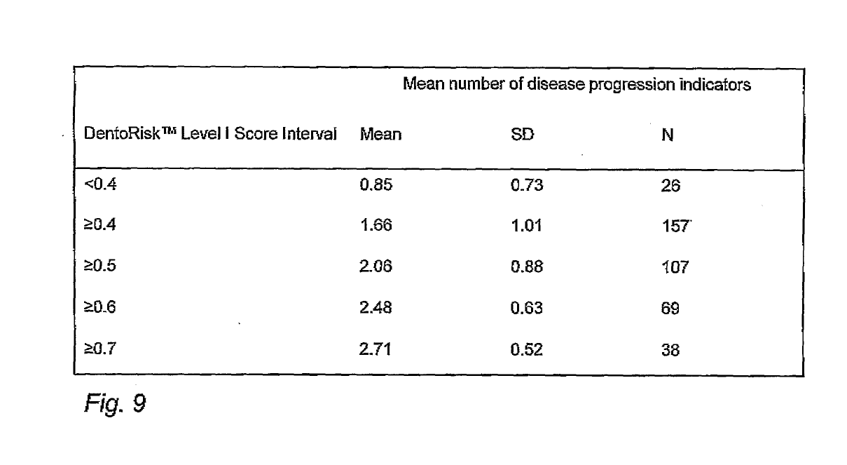

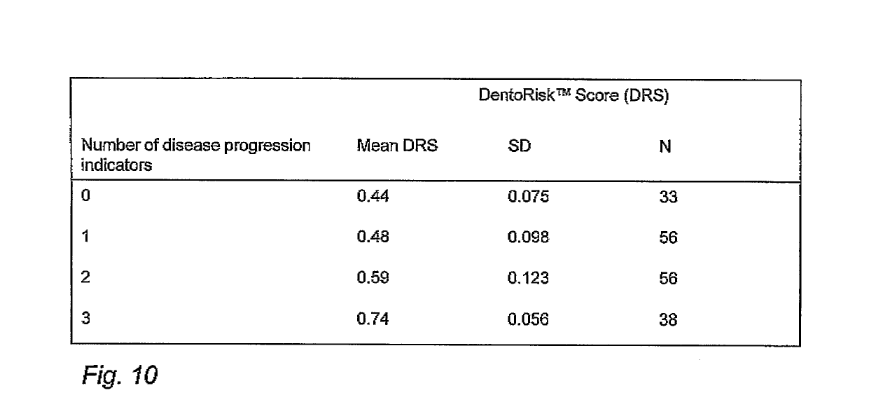

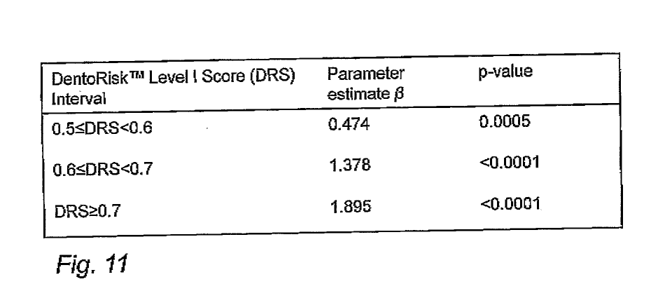

With an increasing mean number of disease progression indicators for the entire dentition, the DentoRisk™ Score increases, as may be seen in FIGS. 9 and 10, indicating a significantly increased risk of disease progression for patients with a DentoRisk™ Score from Level I exceeding 0.5 (annual mean bone loss >0.1 mm corresponds to a mean number of disease progression indicators >2).

This is confirmed by a high correlation coefficient (r=0.7, p<0.0001, N=107) for DentoRisk™ Level I Scores exceeding 0.5 to the outcome variable (number of disease progression indicators) for the dentition as a whole, as well as significant parameter estimates for DentoRisk™ Score intervals >0.5, compared to a DentoRisk™ Score <0.5 (see FIG. 11) with an explanatory value R² of 57.4% (N=183). Thus, a patient with a DentoRisk™ Level I Score between 0.5 and 0.6 has on average 0.474 more periodontitis progression indicators than a patient with a DentoRisk™ Score <0.5. A patient with a DentoRisk™ Score of 0.7 or higher has 1.895 more periodontitis progression indicators than a patient with a DentoRisk™ Score <0.4.

Thus, patients with a DentoRisk™ Score from Level I >0.5 are at risk of losing clinically significant attachment and should undergo further risk assessment tooth by tooth (calculation of DentoRisk™ Level II Score [the second risk score]).

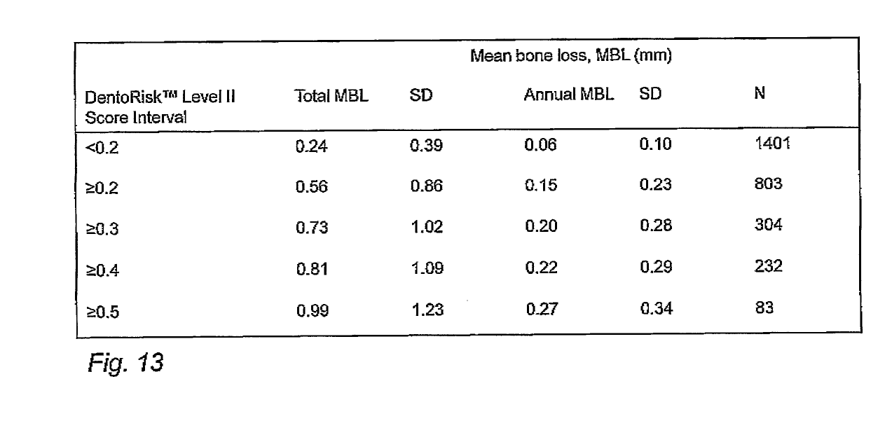

The results from multivariate linear regression analysis of the variables included in the present invention (DentoRisk™ Level II) is presented in FIG. 13 with explanatory values for host predictors and modifying predictors collectively. The multivariate linear regression analysis shows that the variables (host, systemic and local predictors) included in the present invention (DentoRisk™ Level II), when correlated to the outcome variable for progression of periodontitis (number of disease progression indicators), present an overall explanatory value R² of 71.6% (N=459). For the subgroup of teeth with one or more periodontitis progression indicators, the explanatory value R² is 77.4% (N=248). For the subgroup of teeth with DentoRisk™ Scores >0.2 from Level II, the explanatory value R² is 84.6% (N=169). For the subgroup of teeth from patients with DentoRisk™ Scores >0.5 from Level I, the explanatory value R² is 77.0% (N=265). These explanatory values R² indicate that substantially every relevant variable that may influence progression of periodontitis has been taken into account according to embodiment of the invention.

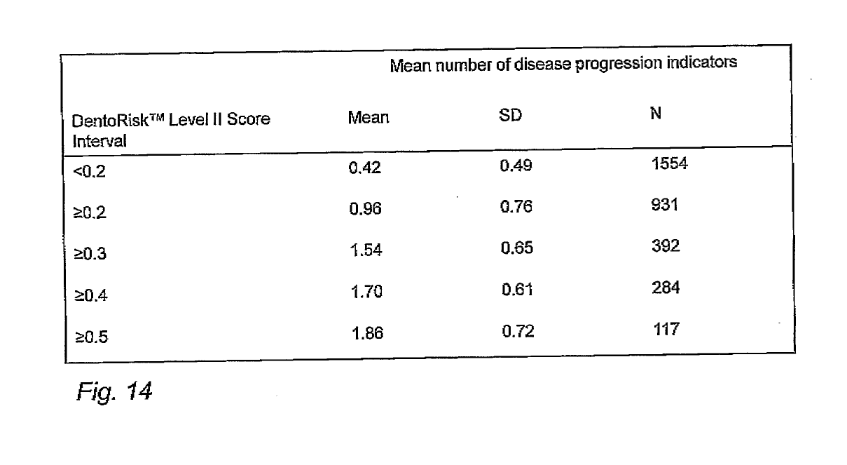

As illustrated in FIGS. 13 and 14, teeth lose marginal attachment (progression of disease seen both as progressive loss of radiographic bone attachment and increasing number of disease progression indicators) with an increasing DentoRisk™ Level II Score.

The average bone loss as presented above (both for DentoRisk™ Score Level I and Level II) should be compared with what has been reported in epidemiological studies on periodontal health irrespective of ethnic background. In several different Scandinavian and US studies, a normal population undergoing general dental care was reported to lose between 0.05 and 0.1 mm of periodontal attachment annually. An annual loss of attachment up to 0.1 mm may thus be regarded as representative of a non-periodontitis prone group of patients. Attachment loss above 0.1 mm may consequently be indicative of periodontitis with increasing severity, as the annual attachment loss increases. At increasing DentoRisk™ Scores >0.2 from Level II, the individual tooth appears to be at an increasing risk of disease progression, while a DentoRisk™ Scores <0.2 indicates substantially no or negligible risk of disease progression.

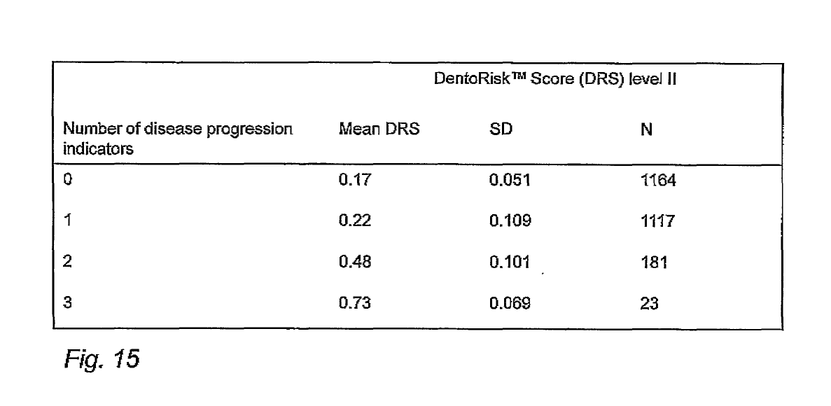

Conversely, the DentoRisk™ Level II Score is significantly (r=0.40, p>0.0001, N=2485) correlated to the outcome variable disease progression. Furthermore, with an increasing number of disease progression indicators, the DentoRisk™ Score increases, as may be seen in the FIG. 15.

For the relevant DentoRisk™ Level II Score interval >0.2, there is a significant correlation (r=0.64, p<0.0001, N=931) between DentoRisk™ Score and the outcome variable (number of disease progression indicators).

A DentoRisk™ Score from Level II (that is tooth by tooth risk assessment) thus appears to be able to identify individual teeth with an elevated risk of future loss of periodontal attachment (DentoRisk™ Score from Level II >0.2). With an increasing DentoRisk™ Score follows a significant increase in disease progression indicators over time. Teeth in the DentoRisk™ Level II Score interval <0.2 lose periodontal attachment within the limits of a normal population irrespective of ethnic background, and seem not to be at any clinically significant risk of disease progression.

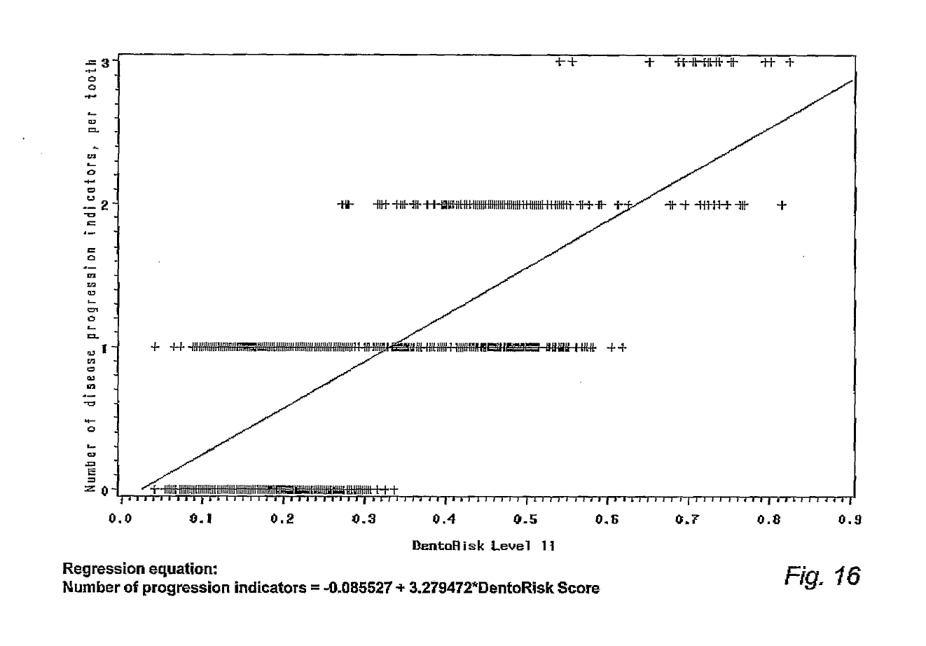

Linear regression for estimating a regression model over the entire interval of DentoRisk™ Scores pertaining to Level II yields an explanatory value R² of 39.2% with a statistically significant parameter estimate β of 3.28 (N=2485, parameter estimate β of 3.28, p-value of <0.0001), as shown in FIG. 16. This means that an increase in the DentoRisk™ Score by 0.1 results in a statistically significant increase in the number of disease progression indicators by 0.328.

Similarly, the explanatory value R² for a corresponding analysis over the entire interval of DentoRisk™ Scores, when calculating scores based on modifying predictors (local and systemic) only, is 40.1% (parameter estimate β of 3.43, p<0.0001, N=2485), and for scores based on host predictors only the explanatory value R² is 1.6% (parameter estimate β of 6.05, p<0.0001, N=2485).

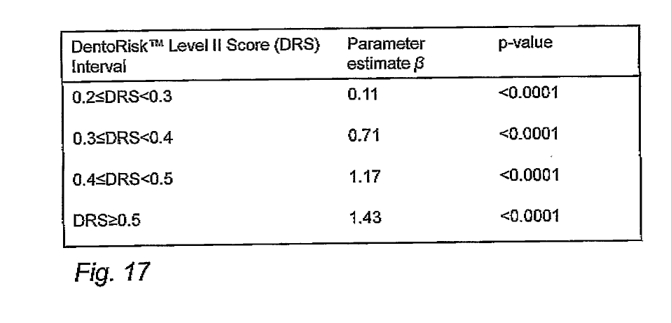

FIG. 17 presents estimates and significance levels for the relevant DentoRisk™ Level II Score intervals >0.2, compared to the DentoRisk™ Score interval <0.2, with an overall explanatory value R² of 39.6% (N=2485). Thus, a tooth with a DentoRisk™ Score between 0.2 and 0.3 has on average 0.11 more periodontitis progression indicators than a tooth with a DentoRisk™ Score <0.2. A tooth with a DentoRisk™ Score between 0.4 and 0.5 has 1.17 more periodontitis progression indicators than a tooth with a DentoRisk™ Score <0.2.

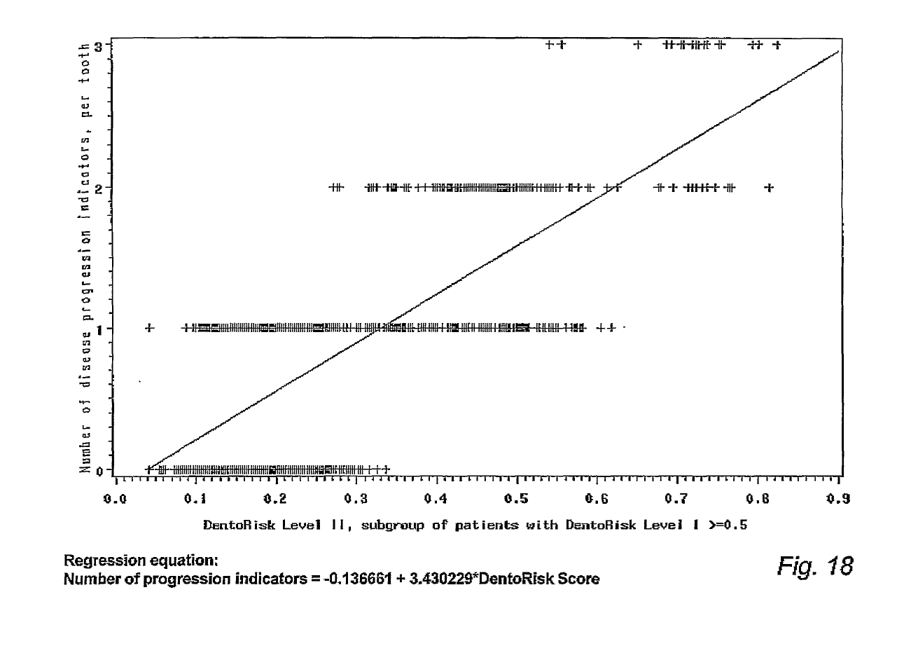

Linear regression for estimating a regression model over the entire interval of DentoRisk™ Scores Level II for the subgroup of teeth of patients with a DentoRisk™ Score 0.5 from Level I yields an explanatory value R² of 46.8% with a statistically significant parameter estimate β of 3.43 (N=1405, parameter estimate β of 3.43, p-value of <0.0001), as shown in FIG. 18. This means that an increase in the DentoRisk™ Score by 0.1 results in a statistically significant increase in the number of disease progression indicators by 0.343.

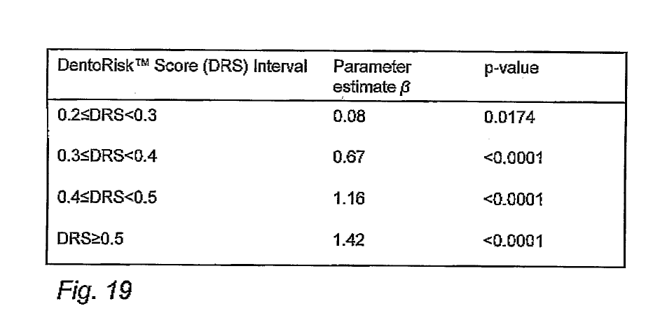

FIG. 19 presents estimates and significance levels for the relevant DentoRisk™ Score intervals >0.2 based on the subgroup of teeth from patients with DentoRisk™ Scores >0.5 from Level I, compared to the DentoRisk™ Score interval <0.2, with an overall explanatory value R² of 46.7% (N=1408).

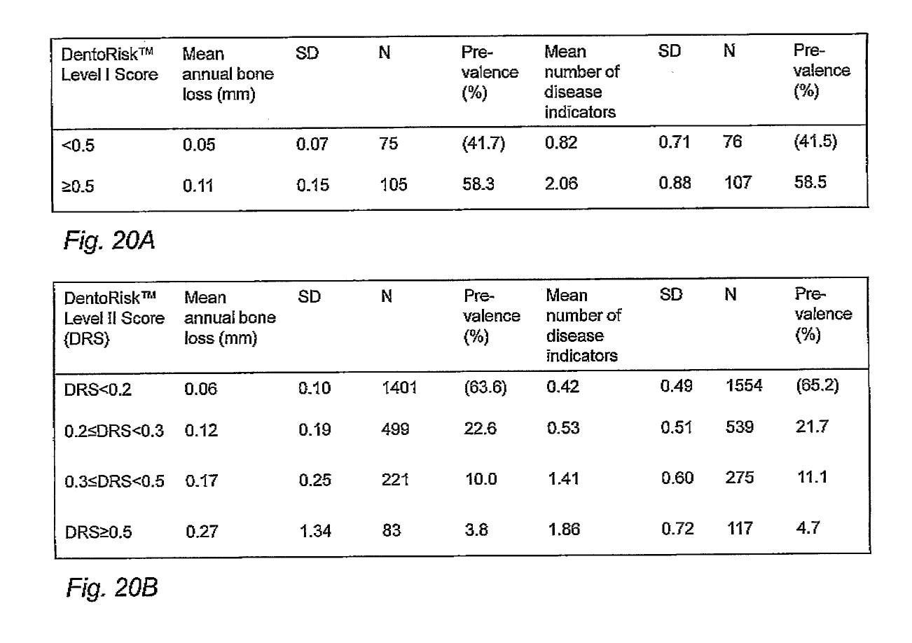

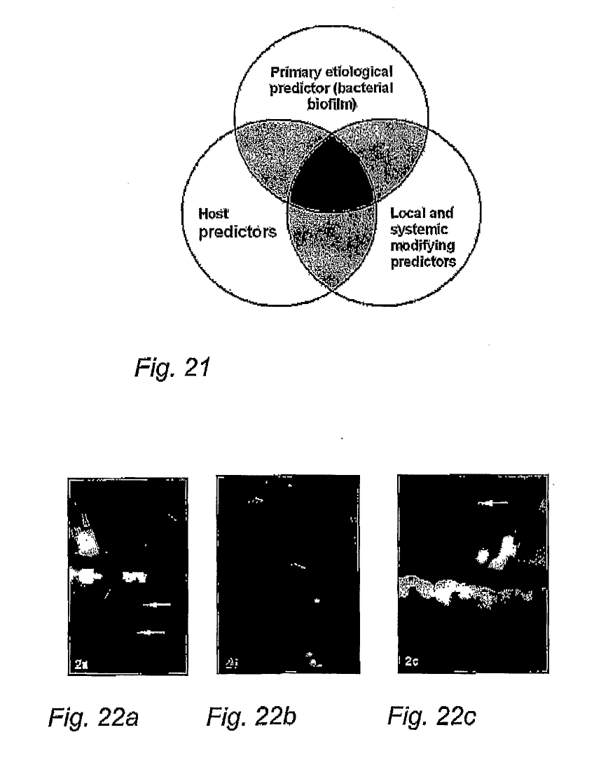

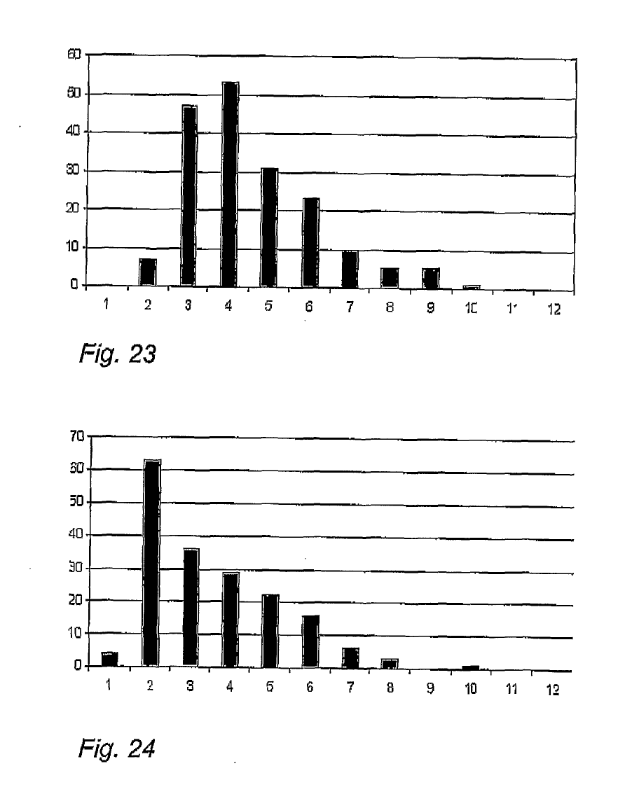

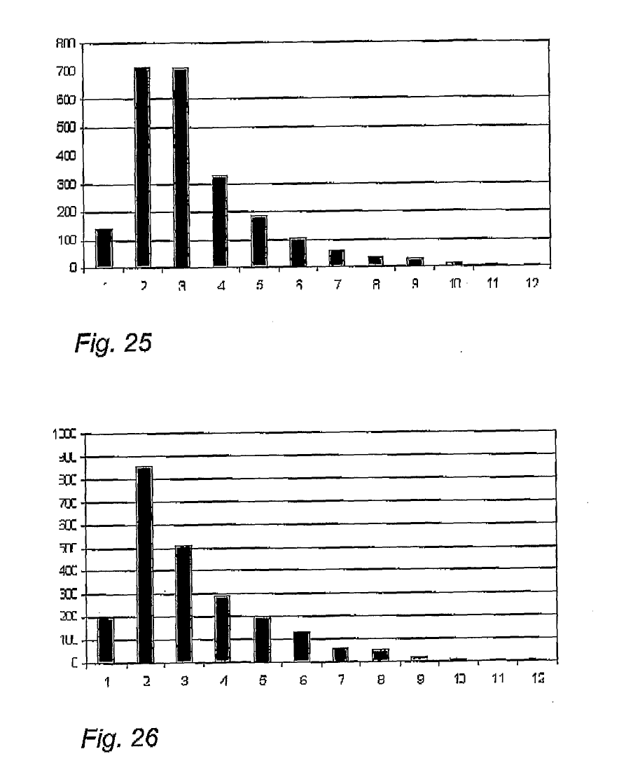

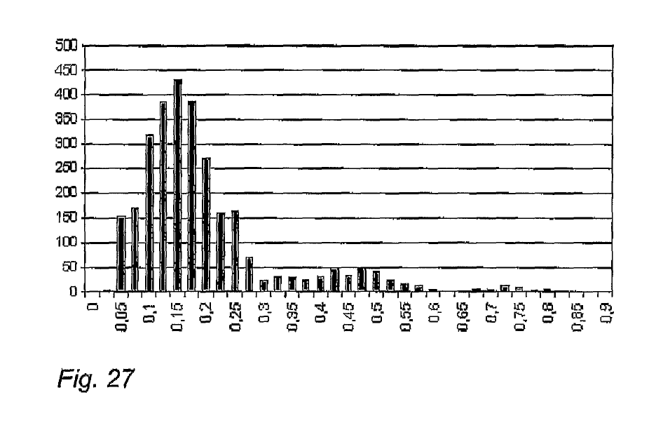

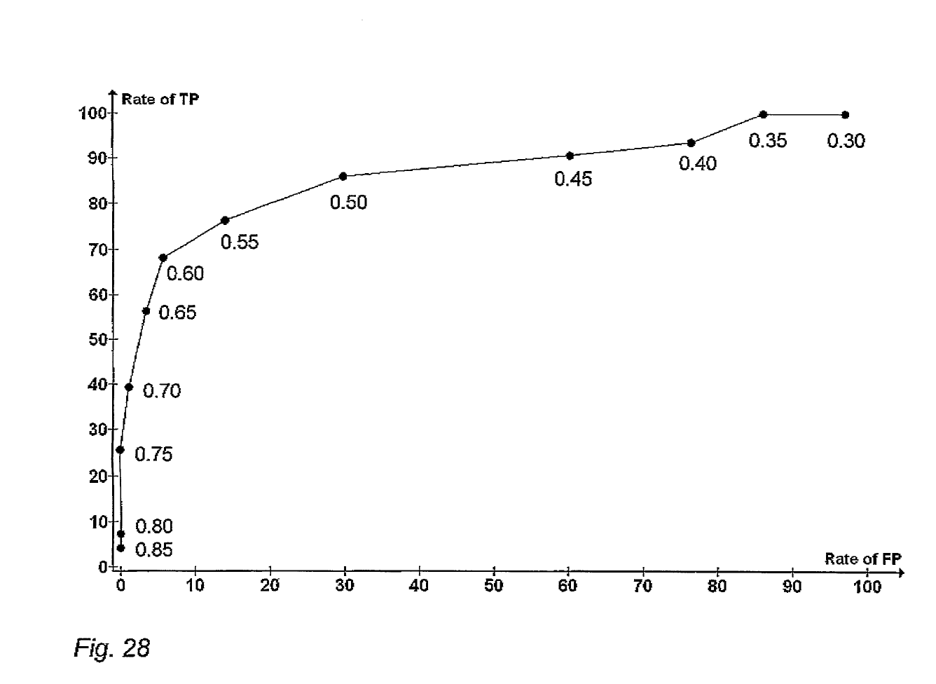

FIGS. 20A and 20B present relevant distribution data from the clinical trial material (Example 1) stratified according to the characteristics of DentoRisk™ Score intervals from Level I and II analysis.

FIG. 20A presents distribution data from the clinical trial material stratified according to DentoRisk™ Score intervals from Level I.

FIG. 20B presents distribution data from the clinical trial material stratified according to DentoRisk™ Score intervals from Level II.

From the distribution data in FIGS. 20A and 20B, the proportion of patients and teeth found to have a clinically significant risk of disease progression, as indicated by their DentoRisk™ Scores from Levels I and II (DRS>0.5 and >0.2, respectively), has been calculated and found to be approximately 58% and 37%, respectively. However, as previously demonstrated, both annual bone loss and the number of disease progression indicators increase significantly with increasing DentoRisk™ Score, indicating that teeth with a disease progression rate indicative of severe periodontitis (mean annual bone loss >0.2 mm and mean number disease progression indictors >1.7) are associated with a DentoRisk™ Score >0.4. Approximately 10% of the teeth are found in this strata (DentoRisk™ Score >0.4).

Thus, as has been described above, DentoRisk™ Scores >0.5 from Level I, when correlated to the outcome variable (number of disease progression indicators), show a high correlation coefficient (r=0.7, p<0.0001, N=107) as well as a relatively high explanatory value R² of 57.4%. Hence, it may be concluded that patients with a DentoRisk™ Score from Level I >0.5 are at risk of losing significantly more periodontal attachment (>0.10 mm radiographic bone loss or >2 disease indicators) than a normal population, and should therefore undergo further risk assessment tooth by tooth in DentoRisk™ Level II. Selection of patients with a DentoRisk™ Score from Level I exceeding 0.5 for further analysis with DentoRisk™ Level II increases the explanatory value for DentoRisk™ Level II compared to regression over the entire spectrum of DentoRisk™ Scores in Level II regardless of outcome in DentoRisk™ Score from Level I.

Regression of DentoRisk™ Scores Level II (tooth by tooth) for teeth in patients with DentoRisk™ Scores >0.5 from Level I and the outcome variable (number of disease progression indicators) gave an explanatory value R² of 46.7% (N=1408), thereby demonstrating that a DentoRisk™ Score >0.2 from Level II may be used to identify individual teeth with an elevated risk of future loss of periodontal attachment (>0.10 mm radiographic bone loss or >1 disease indicators).

In conclusion, the invention relates to a method, system and a device for assessing the risk for periodontitis progression or for developing periodontitis, and a method, system and a device for prognosticating the outcome of a treatment procedure for treating periodontitis, on the basis of a risk score calculated on the basis of weight factors, which may be associated with numerical values, assigned to a plurality of measures corresponding to a plurality of predictors promoting periodontitis comprising host predictors, local predictors, and systemic predictors for periodontitis progression or for developing periodontitis for a patient. The invention provides among other things an objective tool that allows for preventive measures to be taken in time before severe and often irreversible damage caused by periodontitis has occurred, by taking into account the most important risk predictors promoting periodontitis, and in particular takes into account the synergy between these predictors. The invention also relates to a computer readable storage medium, on which there is stored a computer program comprising computer code adapted to perform one or more of the above-mentioned methods, and furthermore such a computer program.

The invention has mainly been described in the foregoing with reference to a few embodiments. However, as is readily appreciated by a person skilled in the art, other embodiments than the ones disclosed in the foregoing are equally possible within the scope of the invention, as defined by the appended claims.

Further embodiments of the present invention are described in Example 1 and Example 2 presented in the following.

### Example 1

### Clinical Validation of the Dentorisk™ Algorithm for Chronic Periodontitis Risk Assessment and Prognostication

Chronic periodontitis is a multifactorial infectious disease in patients with a polygenetic predisposition. Predictors from three categories (primary etiological, host, and modifying predictors) interact to reinforce or attenuate the effects of each other. They influence either growth and composition of the pathogenic bacterial biofilm (that in turn elicit an inflammatory response) or the inflammatory response itself. Consequently, because of the complex nature of the disease, unaided risk assessment and prognostication of chronic periodontitis show great variability between clinicians.

The need for rational risk assessment methods in periodontal treatment planning has recently been highlighted by the American Academy of Periodontology: “[risk assessment will become] increasingly important in periodontal treatment planning and should be part of every comprehensive dental and periodontal evaluation”. Consequently, intervention and preventive measures cannot be accurately focused on a specific tooth or site since detailed prognostic data at the tooth level is lacking. This can result in significant increases in cost and suffering for patients, even over fairly short periods of time. This requirement for a clinically relevant unbiased risk assessment tool prompted research which resulted in the DentoSystem algorithm (incorporated in the DentoRisk™ assessment software (Cε mark)) for assessing risk and prognosis of chronic periodontitis. The algorithm includes results from DentoTest™, a skin provocation test developed to assess an individual patient's ability to mount an appropriate unspecific chronic inflammatory reaction relevant to the patient's propensity to develop chronic periodontitis.

DentoRisk™ is a web-based analysis tool which integrates a multitude of risk predictors relevant to the host, systemic and local conditions within the mouth and calculates chronic periodontitis risk (DentoRisk™ Level I). If an elevated risk is found, the algorithm prognosticates disease progression on a tooth by tooth basis (DentoRisk™ Level II). The clinician enters numerical or dichotomous values for each variable into the algorithm by way of a simple menu, and the resulting risk score is presented for the dentition as a whole (DentoRisk™ Level I). Subsequently, if an elevated risk is indicated in Level I, calculation of a risk score for each individual tooth is recommended (DentoRisk™ Level II), enabling prognostication of disease progression.

The score calculated in DentoRisk™ Level I (DRS_{dentition}) indicates the risk of disease progression, that is, future attachment loss for the entire dentition, and selects patients for detailed prognostication tooth by tooth in DentoRisk™ Level II (DRSₜₒₒₜₕ). This biphasic testing aims at securing full clinical utility by initially presenting a risk level for the patient, which, if elevated, provides detailed risk assessment for individual teeth to enable focused therapy, including the prognosticated rate of disease progression.

The purpose of the present report is to present validation data confirming that the DentoRisk™ algorithm in Level I accurately selects risk patients for detailed disease prognostication, and, in Level II, that it can accurately prognosticate on an individual tooth basis the risk and progression of chronic periodontitis. An independent clinical validation sample was generated for this purpose in a prospective clinical study and a four-step validation model was defined.

The following conclusions were drawn from the validation analyses: Periodontal risk assessment using DentoRisk™ Level I appears to provide a clinically useful tool for selecting patients in need of detailed prognostication tooth by tooth in DentoRisk™ Level II. Both selection of patients and prognostication are accompanied by clinically relevant quality characteristics in relation to the prevalence of chronic periodontitis. The tooth by tooth analyses enabled categorization of prognosis levels into four strata with an increasing risk of disease progression:

| | Mean annual | |
|---|---|---|
| | marginal | |
| DRSₜₒₒₜₕ interval | bone loss | Prognosis category |
| DRSₜₒₒₜₕ < 0.2 | 0.06 mm | No or negligible risk of |
| | | periodontitis progression |
| 0.2 ≦ DRSₜₒₒₜₕ < 0.3 | 0.15 mm | Low risk of periodontitis |
| | | progression |
| 0.3 ≦ DRSₜₒₒₜₕ < 0.5 | 0.21 mm | Moderate risk of |
| | | periodontitis progression |
| DRSₜₒₒₜₕ ≧ 0.5 | 0.27 mm | High risk of periodontitis |
| | | progression |

It is likely that the disease progression rates could have been higher, as the majority of patients, especially those at periodontal clinics, underwent some form of periodontal treatment during the observation period. Prognosticated periodontitis progression in DentoRisk™ Level II has a positive predictive value of 73% and a negative predictive of 55% for a disease prevalence in the relevant strata of approximately 15%. These values are clinically acceptable since positive and negative predictive values should not be confused with simple probability in a sample with equal distribution of health and disease.

Furthermore, DentoTest™, is the skin test designed to detect if the patient's inflammatory response is suppressed, appears to provide a clinically significant contribution to the quality of analysis within DentoRisk™, in particular in the selection of patients for in-depth risk analysis tooth by tooth in DentoRisk™ Level II. This is reflected by a high positive predictive value for DentoTest™ results for disease progression, both for the dentition as a whole and on an individual tooth basis. It should be noted, however, that DentoTest™ is not intended as a stand-alone test, and its clinical value lies in its merit as an adjunct to the risk assessment and prognostication of chronic periodontitis in DentoRisk™.

Based on the outcomes of the validation study, it may be argued that the principal clinical utility of risk analysis and periodontitis prognostication with DentoRisk™ (incorporating results from DentoTest™) is to provide the clinician with a reliable, consistent and objective tool supporting periodontal prognostication, treatment planning and decision making.

### Section 1.1 Introduction, Clinical Relevance and Aims

### Introduction

Maintaining health and preventing disease is a primary goal in health care. From a health economics perspective, well-directed relevant preventive and treatment measures are especially imperative for the prevalent multifactorial diseases which are, to a large extent, brought about by our modern life style. An inherent problem in this area is to identify individuals at risk and to prognosticate their disease outcome.

In its more severe form, chronic periodontitis is a multifactorial polygenetic disease that affects 8 to 10% of the population. However, not more than 5 to 10% of tooth surfaces in this group show ongoing active disease at any given time. If left untreated, such teeth may lose on average up to 1.0 mm attachment per year (Löe et al 1986). For these severely affected individuals, it has been shown that individual supportive periodontal therapy is essential in order to prevent re-infection and progression of periodontal lesions (Axelsson & Lindhe 1981, Jansson et al 1995b, Axelsson 2002). However, instigation of supportive periodontal therapy is most often based on previous disease history since individualized validated assessment criteria for future risk of disease development or recurrence have not yet been established (Lang et al 1998). Hence, the most frequently used methods for assessing risk and prognosis of chronic marginal periodontitis are largely inadequate as they identify the disease only after severe, and sometimes irreversible, damage has occurred.

### Clinical Relevance

The need for rational risk assessment methods in periodontal treatment planning has recently been highlighted by the American Academy of Periodontology (AAP 2006, 2008): “[risk assessment will become] increasingly important in periodontal treatment planning and should be part of every comprehensive dental and periodontal evaluation”. Consequently, intervention and preventive measures cannot be accurately focused on a specific tooth or site since detailed prognostic data at the tooth level is lacking (Lang et al 1998). This can result in significant increases in cost and suffering for patients, even over fairly short periods of time Ode et al 2007).

Increasing numbers of risk indicators for chronic periodontitis, and risk factors including some risk determinants, have been identified over the past decades (Wilson 1999, Renvert & Persson 2002, Nunn 2003, Stanford & Rees 2003, Ronderos & Ryder 2004, Heitz-Mayfield 2005, Klinge and Norlund 2005, Cronin et al 2008). Risk in this context indicates a potential negative impact of known past and present conditions. Information relevant to these conditions can most often be derived from patients' records, current clinical recordings and radiographic examinations. However, a clinically validated unbiased tool that assesses risk of disease development and progression based on this information at the tooth level is lacking (Persson et al 2003a). This prompted research resulting in the algorithm which is incorporated into the DentoRisk™ assessment software (Cε mark).

### Aims

The overall aim of the present report is to present the DentoRisk™ algorithm for chronic periodontitis risk assessment and prognostication and accompanying validation data for its clinical application. The report has the following specific detailed aims which are addressed separately in the indicated sections:
Section 1.2 To review etiological and disease modifying factors in an attempt to characterize the relative impact of each factor on risk of chronic periodontitis progression. The review serves as a basis for constructing the DentoRisk™ software which incorporates an algorithm integrating numerical values for relevant clinical variables, and calculates a risk score for the patient or dentition (DentoRisk™ Level I, the score of which will be referred to in the following as DRS_{dentition}) and prognosticates disease outcome tooth by tooth (DentoRisk™ Level II, the score of which will be referred to in the following as DRSₜₒₒₜₕ).
Section 1.3 To describe the DentoRisk™ algorithm for chronic periodontitis risk assessment for the dentition (Level I) and prognostication of disease outcome tooth by tooth (Level II) as well as to describe the DentoTest™ skin provocation test that assesses the individual patient's ability to develop an appropriate unspecific chronic inflammatory reaction which is included in the group of host-related risk predictors. A clinical validation plan for DentoRisk™ and DentoTest™ is presented.
Section 1.4 To present the investigational materials and methods (independent validation sample) for validation of the DentoRisk™ algorithm for chronic periodontitis risk assessment and prognostication.
Section 1.5 To verify that a sufficient number of relevant risk predictors resulting in sufficiently high explanatory values have been included in the DentoRisk™ algorithm.
Section 1.6 To calculate clinically relevant quality characteristics for chronic periodontitis risk assessment relevant to the dentition in DentoRisk™ Level I and prognosis of chronic periodontis progression tooth by tooth in DentoRisk™ Level II.
Section 1.7 To determine clinical significance and relevance of prognosticated chronic periodontitis progression tooth by tooth calculated in DentoRisk™ Level II.
Section 1.8 To analyze results from the skin provocation test (DentoTest™) to assess the patient's inflammatory responsiveness as a risk predictor for chronic periodontitis. Previous studies have shown a decreased reactivity to Lipid A administered through a simple Skin Prick Test in patients with severe chronic periodontitis. Hence, this initial analysis was done to validate previous results (Lindskog et al 1999). Secondly, the analyses estimates the contribution of DentoTest™ results to the DentoRisk™ model compared to the contribution of smoking, angular bony destruction and furcation involvement, abutment teeth and endodontic pathology, all of which are risk predictors with known strong explanatory values for development and progression of chronic periodontitis. The rational for including these known predictors in the analyses is to verify congruence between our investigational materials (validation sample) and previous reports.

### Section 1.2 Review of Periodontitis Risk Predictors and Risk/Prognostication Methods

### Periodontal Disease

Periodontal diseases are bacterial infections of the periodontal attachment apparatus which affect 50 to 80% of the adult population (Brown and Löe 1994). Gingivitis, a reversible disease, is the most prevalent periodontal disease (Page 1985). It is similar to chronic periodontitis in that it is caused by our indigenous bacterial flora (Löe et al 1965, Theilade et al 1966).

Chronic periodontitis is caused by a subset of subgingival anaerobic pathogens from our indigenous flora (Sanz & Quirynen 2005). Although bacteria are thought to be the initiating agent, the host response to these pathogens, expressed both as immunological and inflammatory reactions, largely determines the development and outcome of chronic periodontitis (Kornman et al 1997a&b). In an adult average population, attachment loss in chronic periodontitis varies between 0.10 and 0.30 mm per year, while 8 to 10% of the population is affected by more severe forms of chronic periodontitis. However, not more than 5 to 10% of tooth surfaces in this subgroup of patients show ongoing active disease at any given time. Nevertheless, if untreated these patients and sites may lose up to 1.0 mm attachment per year (Löe et al 1986).

### Progression of Chronic Periodontitis

Three different theories have been presented for periodontitis progression (Socransky et al 1984).
Slow continuous attachment loss throughout life.
Irregularly distributed periods of localized attachment loss.
Periods of localized attachment loss during defined periods in life.

There is reason to believe that all three theories are valid within different sub-populations of patients. The two first theories may explain variations in progression of chronic periodontitis within different groups of adult patients and the third may be relevant to juvenile periodontitis.

Long-term studies (20 years) investigating tooth loss within groups of periodontitis-prone patients in specialized periodontal care report tooth loss of between 8 and 13 percent. Certain groups of teeth were more severely affected than others, and loss of molars was as high as 29 to 58 percent (Hirschfeld & Wasserman 1978, McFall 1982, Goldman et al 1986).

In Scandinavian studies of adult patients undergoing general dental care annual periodontal attachment loss has been reported to vary between 0.05 and 0.10 mm (Löe et al 1978, Laystedt et al 1986, Papapanou et al 1989), while adults in Sri Lanka who did not receive any dental treatment showed an attachment loss varying between 0.10 and 0.30 mm per year (Löe et al 1986). Löe et al (1986) also found that a subpopulation, about 8%, lost approximately 1.0 mm per year and had lost all teeth by 40 to 45 years of age. A comparable adult population in an urban area was reported to have lost 0.10 mm per year (Laystedt et al 1986). However, in other long-term studies it has been shown that periodontitis-prone patients in individualized periodontal care need not lose more periodontal attachment than an adult average population (Jansson et al 1995b, Jansson & Lagervall 2008). Supported by these studies, it appears that periodontitis-prone patients can be prevented from excessive loss of attachment provided they undergo specialized periodontal treatment on a regular and individual basis.

### Review of Risk Predictors for Chronic Periodontitis

Risk and uncertainty are central to forecasting, prediction or prognostication. Conceptually, risk denotes a potential negative impact of known past and present conditions. Prognosis is a medical term for prediction of how a patient's disease will progress, and whether there is chance of recovery. Prognostication of forecasting in situations of uncertainty is the process calculating estimates based on time-series from cross-sectional or longitudinal data.

Time-series forecasting is the use of a model to forecast future events based on known past events or to forecast future data points before they can be measured. A longitudinal study is a correlational research study that involves repeated observations of the same individuals over long periods of time. Cross-sectional data refers to data collected by observing many subjects at the same point of time, or without regard to differences in time. In medicine and dentistry, time-series data is preferable for validating predictive or prognostic models. However, before predictive qualities of such a model are assessed, the relevance of “past events” need to be established. Primarily, such “past events” are risk factors (behavioral, environmental or biological conditions) confirmed in time-series studies and known to be associated with disease-related conditions (Vandersall 2007). Some of these, such as a genetic predisposition, have been designated risk determinants since they cannot be changed or modified (Vandersall 2007). However, cross-sectional studies may also contribute valuable information in identifying relevant “past events” commonly referred to as risk indicators, although data on their causal relationship may be lacking (Vandersall 2007).

Over the past decades, increasing numbers of risk factors associated with chronic periodontitis have been identified (Grossi et al 1994 & 1995, Wilson 1999, Renvert & Persson 2002, Nunn 2003, Stanford & Rees 2003, Ronderos & Ryder 2004, Heitz-Mayfield 2005, Klinge & Norlund 2005, Cronin et al 2008). The primary or etiological risk factor for chronic periodontitis is a subset of pathogenic bacteria from our indigenous flora organized as a biofilm (Sanz & Quirynen 2005). However, there are host factors as well as a number of modifying factors that influence the patient's susceptibility to periodontal disease and modify disease progression. When these factors accumulate and work in synergy, episodes of significant disease progression may occur as discussed later in this Section. Obviously, not all of these factors are directly causative, although correlated to the risk of disease progression and, hence, they do not qualify as risk factors or risk determinants but rather as risk predictors (Page & Beck 1997). Since the purpose of the DentoSystem™ algorithm in DentoRisk™ is to assess risk and prognosis of chronic periodontitis and not to establish any causal relationships, all factors or clinical variables of relevance to chronic periodontitis risk assessment and prognostication will be referred to as risk predictors in the following (FIG. 1).

Risk predictors correlated to risk for periodontitis or periodontitis progression may be divided into systemic and local risk predictors that modify the host's or patient's response to the primary etiological risk predictors (pathogenic bacterial biofilm) (Kornman & Löe 1993, Genco & Löe 1993). Local modifying risk predictors may exert their influence on all, some or single tooth sites in contrast to systemic modifying risk predictors, which invariably affect all teeth. Some of the systemic modifying risk predictors have a genetic background. Consequently, because of the complex nature of the disease, unaided risk assessment and prognostication of chronic periodontitis shows great variability between clinicians (Persson et al 2003a).

With reference to FIG. 1.1, chronic periodontitis is a multifactorial infectious disease (see Table 1.1) in patients with a polygenetic predisposition. Predictors from all three categories (primary etiological, host and modifying predictors) interact and reinforce or reduce the effects of each other. They influence either growth and composition of the pathogenic bacterial biofilm (which, in turn, elicit an inflammatory response) or the inflammatory response itself. When predictors from the three categories work in synergy episodes of clinically significant disease progression may occur.

### Host Predictors

### Age in Relation to History of Chronic Periodontitis

In general, older individuals have more advanced periodontitis and fewer remaining teeth than younger individuals (Marshall-Day et al 1955, Schei et al 1959, Laystedt 1975, Laystedt et al 1986, Beck et al 1990, Beck & Koch 1994). Some longitudinal studies indicate age to be a risk predictor for alveolar bone loss or clinical attachment loss (Papapanou et al 1989, Ismail et al 1990, Norderyd et al 1999), while others show no association (Brown et al 1994, Brown & Löe 1994, Baelum et al 1997). However, the fact that older individuals have fewer remaining teeth and less attachment seems not to depend so much on less capable defense mechanisms against periodontitis pathogens in older individuals, but may rather be explained by an accumulated influence of periodontitis-promoting factors as patients grow older (Genco & Löe 1993, Albandar et al 1999, Albandar 2002, Axelsson 2002, Nunn 2003, Stanford & Rees 2003).

### Genetic Aspects of Chronic Periodontitis

In its severe form chronic periodontitis affects roughly 10% of the population in industrialized countries, leading to partial or complete tooth loss indicating an individual susceptibility to develop the disease. Differences between individuals in the innate immune system have been proposed as a plausible explanation (Kinnane et al 2007). This variation has most likely a poly-genetic background (Hassell & Harris 1995, Mucci et al 2005). A clinical aspect of individual immune variability with respect to chronic periodontitis development has been demonstrated by a decreased reactivity to Lipid A administered through a simple Skin Prick Test in patients with refractory chronic periodontitis (Lindskog et al 1999). Polymorphism of the IL-1, IL-10 and Fc_{γ}-receptor genesgenes have also been shown to be associated with chronic periodontitis in certain ethnic groups. However, none of these polygenetic aberrations are sufficiently strong to be the single etiological factor in periodontitis development (Loos et al 2005, Mucci et al 2005, Huynh-Ba et al 2007).

### Systemic Disease and Related Diagnoses

There are several excellent reviews on the role of systemic disease and related conditions in the development and progression of chronic periodontitis (Seymore & Heasmen 1992, Genco & Löe 1993). Although not of direct etiological importance, systemic disease, and in particular chronic diseases, may be of critical importance to periodontal conditions during active periods of systemic disease. The following review of systemic diseases lists those most important based on relative impact.

Adiposity and malnutrition have been reported to be associated with periodontitis development (Stahl 1976, Saito et al 2001, Al-Zahrani et al 2003, 2005, Nishida et al 2005). A number of studies have also found an aggravating impact of alcohol intake on periodontitis (Pitiphat et al 2003, Nishida et al 2004, Shimazaki et al 2005).

Several studies have shown that groups of patients with diabetes have a higher prevalence of chronic periodontitis (Bernick et al 1975, Cianciola et al 1982, Rylander et al 1986, Harrison & Bowen 1987, Schlossman et al 1990, Emrich et al 1991, Thorstensson et al 1996, Taylor et al 1998, Sandberg et al 2000, Soskolne & Klinger 2001, Tsai et al 2002). Why patients with diabetes suffer more often from periodontitis than control groups of patients is not clear, but patients with poor glycemic control are over-represented (Tervonen & Karjalainen 1997, Scheil et al 2001, Guzman et al 2003). In addition, presence of defective neutrophile granulocytes has been suggested as an explanation (Manouchehr-Pour et al 1981); however, this has also been questioned (Fikrig et al 1977).

Advanced periodontal diseases have been described in HIV-infected patients and include distinctive erythema in the attached gingival region, and rapid soft tissue destruction accompanied by interproximal cratering, necrosis and ulceration (Winkler et al 1988). However, conventional therapy including plaque control, scaling and root planing with or without chlorhexidine rinsing has been reported to be a successful treatment regime (Grassi et al 1988). Furthermore, high-activity anti-retroviral therapy (HAAART) is likely to be a major confounder in periodontitis progression because of its impact on viral load and immune function (Chapple & Hamburger 2000).

Increased gingival inflammation is a symptom significantly correlated with pregnancy and contraceptives (Ziskin et al 1933, Maier & Obran 1949, Ringsdorf et al 1962, Löe & Silness 1963, Hugoson 1970, Knight & Wade 1974, Kalkwarf 1978). However, this type of gingivitis can be reduced by proper oral hygiene procedures (Silness & Löe 1966) and is considered to disappear spontaneously post partus (Löe & Silness 1963).

Several studies have attempted to relate the degree of osteoporosis to periodontal status but have only demonstrated weak correlations. It has, however, been proposed that loss of bone mass during ageing may contribute to the progression of chronic periodontitis in addition to other age-related modifying factors (Genco & Löe 1993).

Normal polymorphonuclear leukocyte (PMN) function is an important determinant of host resistance and response to periodontal pathogens. A number of disturbances in function or production of PMN cells may dramatically promote progression of chronic periodontitis (Wilton 1991, Hart et al 1994, Kornman et al 1997a&b, Dennison & Van Dyke 1997).

Granulomatous diseases (e.g. sarcoidosis and Crohn's disease), renal disease and rheumatoid diseases such as Sjögren's syndrome present with similar oral pathology such as focal lymphocytic inflammation in the salivary glands leading to xerostomia. Hence, these diseases as well as cardiovascular disease have been show to be associated with a higher incidence of periodontal disease (Seymore & Heasman 1992, Buhlin et al 2003, Renvert et al 2004, Lagerwall & Jansson 2007, Bayraktar et al 2007, Borawski et al 2007, Moretti et al 2007, Seymour et al 2007, Craig 2008, Fisher et al 2008).

Despite major advances in the awareness of genetic risk predictors for periodontal disease (with the exception of periodontitis associated with certain monogenetic conditions), we are still some way from determining the genetic basis of both aggressive and chronic periodontitis. However, considerable insight into the hereditary pattern of aggressive periodontitis has been gained. Related to our understanding that it is autosomal-dominant with reduced penetrance comes a major clinically relevant insight into the risk assessment and screening for this disease: we appreciate that parents, offspring, and siblings of patients affected with aggressive periodontitis have a 50% risk of this disease (Kinnane & Hart 2003). Other monogenetic diseases and chromosomal aberrations of related relevance are Papillon-Lefevre's syndrome, hereditary gingival syndrome, Down's syndrome and cyclic neutropenia (Gettig & Hart 2003).

Systemic medications that may act as promoters of gingivitis and chronic periodontitis development include drugs that induce (Seymore & Heasman 1992):
Gingival overgrowth (e.g. phenytoin)
Hypersensitivity reactions (plasma cell gingivitis)
Xerostomia (antihistamines, antidepressants, anticholinergics, anorexiants, antihypertensives, antipsychotics, anti-Parkinsonian agents, diuretics and sedatives)

### Modifying Systemic Predictors

### Patient Cooperation and Disease Awareness

A number of studies have shown that the patient's compliance with oral hygiene instructions is crucial to regain and maintain periodontal health (Lindhe & Nyman 1975, Nyman et al 1975, 1977, Rosling et al 1976a&b, Becker et al 1984, Wilson et al 1987). In this context, the patient's disease awareness and understanding of periodontal therapy must be considered to be as important as their compliance with oral hygiene instructions.

### Socio-Economic Predictors

Both early and recent studies have shown that low socio-economic status, low education level, social isolation, mental illness, low income as well as anxiety and depression correlate with poor periodontal status (Arnö et al 1958, Lövdal et al 1958, Björn 1964, Laystedt 1975, Axtelius et al 1998, Teng et al 2003, Merchant et al 2003, Ronderos & Ryder 2004, Borell et al 2006, Johannsen 2006, Javed et al 2007).

### Tobacco Habits

Smoking influences the whole dentition both locally and through systemic effects. Smokers have deeper periodontal pockets and more attachment loss than control patients (Laystedt 1975, Laystedt & Eklund 1975, Bolin et al 1986a&b, Bergström & Eliasson 1987). Smokers are over-represented at periodontal specialist clinics (Preber & Bergström 1986) and heavy smokers (more than 20 cigarettes per day) have a five-fold higher risk of periodontitis progression compared to matched groups of non-smokers with periodontitis (Bergström 1989, Haber & Kent 1992, Stoltenberg et al 1991 & 1993, Haber at al 1993). Even after considering the hygiene factor as a confounder, the relationship between smoking and generalized attachment loss is evident (Laystedt & Eklund 1975, Bergström 1989, Feldman et al 1983). However, tobacco taken as snuff has only been found to influence attachment loss at sites of application but not in other locations in the dentition (Laystedt & Eklund 1975, Robertson et al 1990).

Individuals who quit smoking lose more attachment within a 10-year period than individuals who never smoked (Bolin et al 1993). 85 to 90% of patients with refractory periodontitis have been reported to be smokers (MacFarlane et al 1992). In an evidence-based appraisal, it was concluded that “91% of 10 nonsurgical and 93% of 14 surgical therapy intervention studies indicate an untoward effect of smoking on the therapeutic outcome” (Bergström 2006). Furthermore, smokers have been reported to lose more implants than non-smokers (Bain & Moy 1993, Debruyn & Collaert 1994). Recently, it was stated that smoking in comparison with socio-economic variables present a stronger association with periodontal disease (Klinge & Norlund 2005).

Treatment Procedures and Therapist's Knowledge and Experience with Periodontal Care

A number of studies have emphasized the importance of the therapist's knowledge and experience with periodontal care for the determination of effective periodontal treatment procedures and, consequently, outcome. This is profoundly important for periodontal healing and disease prognosis (Rosling et al 1976a&b, Nyman et al 1977, Jansson et al 1995b, Lang & Tonetti 1996, Blomlöf et al 1997, Egelberg 1999, Axelsson 2002).

### Modifying Local Predictors

### Plaque (Oral Hygiene) and Plaque-Retaining Conditions

There is no doubt that marginal dental plaque is the predominant local cause of initiation and progression of gingivitis and periodontitis (Löe et al 1965, Theilade et al 1966, Socransky 1970, Socransky et al 1984). Conditions such as crowding of teeth (Buckley 1981, Ingervall 1977, Silness & Roystrand 1985), tooth anatomy (Masters & Hoskins 1964, Gould & Picton 1966, Kaldahl et al 1990, Kalkwarf & Reinhardt 1988, Papapanou et al 1988), calculus (Lövdal et al 1958, Laystedt & Eklund 1975) and restorations (Brunsvold & Lane 1990) relate to the individual tooth's ability to accumulate plaque and thereby can influence the progression of periodontitis and the outcome of periodontal treatment. An overhanging restoration retains more plaque than a smooth junction between the tooth and the root surface (Jeffcoat & Howell 1980, Lang et al 1983, Brunsvold & Lane 1990). The distance between the gingival margin and the restoration appears to be of importance for marginal periodontal conditions. The further away from the gingival margin the restoration is situated, the less negative impact it has on marginal periodontal conditions (Jansson et al 1994). In addition, maintenance therapy appears to be crucial for the periodontal healing result, including plaque control and individually adjusted periodic professional tooth cleaning and root debridement (for review see Egelberg 1999).

### Endodontic Pathology

Within dental traumatology it is a well-known fact that an infected root canal influences periodontal status and healing in teeth with a compromised periodontium (Andreasen & Hjörting-Hansen 1966, Andreasen et al 2007). Endodontic plaque within the root canal promotes apical epithelial down-growth on a root surface void of a protecting root cementum layer (Jansson et al 1995a). It has also been reported that teeth with advanced chronic periodontitis in combination with a root canal infection exhibit deeper periodontal pockets, more radiographic attachment loss, more frequent angular bony defects and a higher rate of attachment loss compared to endodontically intact teeth and root-filled teeth without periapical pathology (Jansson 1995, Jansson et al 1993a&b). It must however, be emphasized that these results (Jansson 1995, Jansson et al 1995a&b) only apply to teeth void of cervical protecting root cementum in periodontitis-prone patients. The same outcome can not be expected in patients without chronic periodontitis and thus an intact layer of cervical root cementum.

In addition, intra-canal medication may have a similar effect on the periodontium in teeth void of cementum coverage. Both clinical and experimental studies have shown that root canal treatment with calcium hydroxide has a negative influence on periodontal healing in teeth void of a protecting cementum layer (Cvek et al 1974, Hammarström et al 1986, Blomlöf et al 1988, 1992, Lengheden 1994) similar to that seen in teeth with a root canal infection (Ehnevid 1995).

### Past Marginal Attachment Loss, Type of Tooth and Bony Destruction

Patients with a history of periodontitis have a higher susceptibility to further attachment loss than periodontally healthy individuals (Laystedt et al 1986, Papapanou et al 1989, Bolin et al 1986a&b, Lindhe et al 1989a&b, Haffajee et al 1991a,b&c). Furthermore, angular bony defects appear to increase the risk of further attachment loss (Papapanou & Wennström 1991, Papapanou & Tonetti 2000). Multi-rooted teeth, especially those with furcation involvement, are at a higher risk of periodontitis progression than molars and premolars without furcation involvement or single-rooted teeth (Hirschfeld & Wasserman 1978, McFall 1982, Goldman et al 1986, Nordland et al 1987, Wood et al 1989, Wang et al 1994, McGuire & Nunn 1996a&b, McLeod et al 1997, Papapanou & Tonetti 2000).

### Occlusal Trauma and Tooth Mobility

Neither jiggling nor traumatizing occlusion applied to a healthy periodontium results in pocket formation or loss of supporting connective tissue attachment. However, in the presence of plaque, trauma from occlusion may result in resorption of alveolar bone and increased tooth mobility in periodontitis patients and thus result in periodontitis progression (Lindhe et al 1998).

### Periodontal Pockets, Bleeding on Probing and Pus

Presence of plaque at the gingival margin is of limited relevance for disease progression in patients on an individual maintenance program following both surgical and non-surgical periodontal therapy (for review see Egelberg 1999). Gingival suppuration seems to be superior to bleeding on probing for prognosticating disease progression in maintenance patients. Furthermore, patients with deeper residual pockets run a higher risk of disease progression than patients with shallower residual pockets (for review see Egelberg 1999, Matuliene et al 2008). “Individuals with low mean bleeding on probing percentages (<10% of the surfaces) may be regarded as patients with low risk for recurrent disease, while patients with mean bleeding on probing percentages >25% should be considered to be at high risk for periodontal breakdown” (Lang & Tonetti 2003). This conclusion is supported by the findings of Schätzle et al (2004).

### Assessment of the Relative Impact of Risk Predictors for Chronic Periodontitis

Risk assessment and prognostication of multifactorial diseases such as chronic periodontitis depend on a balanced evaluation of relevant risk predictors. As seen in the preceding discussion, risk predictors for chronic periodontitis have been the subject of numerous studies although results have not been consistently presented in a way which enables direct comparison. Thus, a precise ranking of predictors appears unfeasible and may not even be necessary since there is good reason to believe that conclusions drawn from a statistical material are not necessarily applicable to the individual patient. However, in order to develop an algorithm which incorporates risk predictors in the assessment, a basis for the selection of risk predictors needs to be established. Consequently, the following table (Table 1.1) categorizes relevant and strong risk predictors of chronic periodontitis into four groups based on semi-quantitative ranking of their reported impact using the following variables:
Number of well-documented studies
Estimates of contribution from confounders in the studies
Clinical relevance and statistical significance
Established clinical quantitative methods for assessing outcome

The table lists relevant studies for each risk predictor together with the assigned risk group reflecting each predictor's relative impact on disease progression from low impact (Group 1) to high impact (Group 4).

TABLE 1.1
Relevant studies describing risk predictors in chronic periodontitis development and progression.
They have been categorized into four risk groups from low impact (Group 1) to high impact (Group
4) based on our ranking of their relative importance for disease progression.

| | | |
|---|---|---|
| | Ranking | |
| | based on | |
| | impact on | |
| | periodontitis | |
| Risk predictor/s | progression | References |

Host predictors

| | | |
|---|---|---|
| Age in relation to history of | 2 | Marshall-Day et al 1955, Schei et al 1959, Lavstedt |
| chronic periodontitis | | 1975, Lavstedt & Eklund 1975, Bolin et al 1986a & |
| | | 1986b, Lavstedt et al 1986, Papapanou et al 1989, |
| | | Ismail et al 1990, Brown et al 1994, Baelum et al |
| | | 1997, Albandar 1990, Albandar et al 1999, |
| | | Norderyd et al 1999, Albandar 2002, Nunn 2003, |
| | | Stanford & Rees 2003 |
| Family history of chronic | 2 | Hassell & Harris 1995, Mucci et al 2005, Loos et al |
| periodontitis (genetic | | 2005 |
| aspects) | | |
| Systemic disease and related | 2 | |
| diagnoses | | |
| HIV/Aids | | Grassi et al 1988, Winkler et al 1988, Genco & Löe |
| | | 1993, Chapple & Hamburger 2000 |
| Diabetes mellitus | | Bernick et al 1975, Cianciola et al 1982, Rylander |
| | | et al 1986, Harrison & Bowen 1987, Schlossman et |
| | | al 1990, Emrich et al 1991, Thorstensson et al |
| | | 1996, Tervonen & Karjalainen 1997, Taylor et al |
| | | 1998, Sandberg et al 2000, Scheil et al 2001, |
| | | Soskolne & Klinger 2001, Guzman et al 2003 |
| Pregnancy and female | | Ziskin et al 1933, Maier & Obran 1949, Ringsdorf et |
| hormones | | al 1962, Löe & Silness 1963, Silness & Löe 1966, |
| | | Hugoson 1970, Knight & Wade 1974, Kalkwarf |
| | | 1978 |
| Osteoporosis | | Genco & Löe 1993 |
| Blood disorders and | | Wilton 1991, Hart et al 1994, Dennison & van Dyke |
| immunodeficiencies | | 1997, Kornman et al 1997a&b |
| Sjögren's syndrome, | | Seymore & Heasman 1992, Buhlin et al 2003, |
| cardiovascular, renal and | | Renvert et al 2004, Lagerwall & Jansson 2007, |
| granulomatous disease | | Bayaktar et al 2007, Borawski et al 2007, Moretti et |
| | | al 2007, Seymour et al 2007, Craig 2008, Fisher et |
| | | al 2008 |
| Monogenetic disease relevant | | Kinnane & Hart 2003, Gettig & Hart 2003 |
| to an impaired immune | | |
| response or chromosomal | | |
| aberrations | | |
| Medications which influence | | Seymore & Heasman 1992 |
| the gingiva or saliva | | |
| Results of the skin | 2 | Lindskog et al 1999, Kinnane et al 2007 |
| provocation test to assess | | |
| the patient's inflammatory | | |
| reactivity | | |

Modifying systemic predictors

| | | |
|---|---|---|
| Patient cooperation and | 3 | Lindhe & Nyman 1975, Nyman et al 1975, Rosling |
| disease awareness | | et al 1976a&b, Nyman et al 1977, Becker et al |
| | | 1984, Wilson et al 1987 |
| Socio-economic status, | 3 | Arnö et al 1958, Lövdal et al 1958, Björn 1964, |
| nutritional deficiencies, | | Stahl 1976, Axtelius et al 1998, Saito et al 2001, |
| obesity, alcohol abuse and | | Al-Zahrani et al 2003, Merchant et al 2003, Teng et al |
| stress-related factors | | 2003, Pitiphat et al 2003, Nishida et al 2004, 2005, |
| | | Ronderos & Ryder 2004, Al-Zahrani et al 2005, |
| | | Shimazaki et al 2005, Borell et al 2006, Johannsen |
| | | 2006 |
| Tobacco habits | 4 | Lavstedt 1975, Lavstedt & Eklund 1975, Feldman et |
| | | al 1983, Bolin et al 1986a, Preber & Bergström |
| | | 1986, Bergström & Eliasson 1987, Bergström 1989, |
| | | Haber & Kent 1992, Stoltenberg et al 1991, 1993, |
| | | Haber et al 1993, Bain & Moy 1993, Debruyn & |
| | | Collaert 1994, Klinge & Norlund 2005, Bergström |
| | | 2006 |
| Previous tobacco habits | 1 | Bolin et al 1993 |
| Treatment procedures and | 2 | Rosling et al 1976a&b, Nyman et al 1977, Jansson |
| the therapist's experience | | et al 1995b, Lang & Tonetti 1996, Blomlöf et al |
| | | 1997 |

Modifying local predictors

| | | |
|---|---|---|
| Plaque and plaque-retaining | 2 | Lövdal et al 1958, Masters & Hoskins 1964, Löe et |
| factors (oral hygiene) | | al 1965, Gould & Picton 1966, Theilade et al 1966, |
| | | Socransky 1970, Lavstedt & Eklund 1975, Ingervall |
| | | 1977, Buckley 1981, Socransky et al 1984, Silness |
| | | & Röystrand 1985 |
| Endodontic pathology | 3 | Andreasen & Hjörting-Hansen 1966, Jansson et al |
| | | 1993a&b, Jansson 1995, Jansson et al 1995b |
| Furcation involvement | 4 | Hirschfeld & Wasserman 1978, McFall 1982, |
| | | Goldman et al 1986, Nordland et al 1987, Wood et |
| | | al 1989, Wang et al 1994, McGuire & Nunn |
| | | 1996a&b, McLeod et al 1997, Papapanou & Tonetti |
| | | 2000 |
| Angular bony destruction | 4 | Papapanou & Wennström 1991, Papapanou & |
| | | Tonetti 2000 |
| Past marginal attachment | 4 | Lavstedt et al 1986, Bolin et al 1986a&b, |
| loss | | Papapanou et al 1989, Lindhe et al 1989a&b, |
| | | Haffajee et al 1991 a, b&c |
| Periodontal pocket depth | 2 | Egelberg 1999, Matuliene et al 2008 |
| Periodontal bleeding on | 2 | Egelberg 1999, Lang & Tonetti 2003, Schätzle et al |
| probing | | 2004 |
| Proximal dental restorations | 2 | Jeffcoat & Howell 1980, Lang et al 1983, Brunsvold |
| | | & Lane 1990, Jansson et al 1994 |
| Increased tooth mobility | 1 | Lindhe et al 1998 |

### Review of Studies and Methods Focusing on Impact of Risk Predictors for Chronic Periodontitis

Since chronic periodontitis is a multifactorial infectious disease in patients with a poly-genetic predisposition many studies have focused on identifying risk predictors that will enable identification of individuals at a high risk of disease (Page & Beck 1997). Risk predictors are not necessarily part of the causative chain or etiology of the disease (Vandersall 2008). From these studies it is apparent that successful risk assessment and prognostication for the individual patient must integrate a sufficient number of modifying systemic and local factors as well as host predictors. Table 1.2 lists some relevant studies that assess the impact of selections of risk predictors for chronic periodontitis. Table 1.3 lists a selection of commercially available tests addressing different risk predictors for chronic periodontitis with quality and clinical utility measures where available.

TABLE 1.2
Selected studies that have assessed the impact of risk predictors relevant
to chronic periodontitis. The table also presents clinical utility measures
for each study, and the selections of risk predictors addressed.

| Risk predictor/s | Clinical utility measures | References |
|---|---|---|
| Evaluation of type of tooth, age, | Statistically significant influence on | Albandar 1990 |
| bone loss at baseline as | progression of chronic periodontitis | |
| predictors of periodontitis | were established for type of tooth, | |
| progression | age, bone loss at baseline. | |
| Evaluation of morphological | Presence of angular bony defects | Papapanou & Wennström |
| characteristics of bony defects as | predict periodontitis progression with | 1991 |
| a predictor of periodontitis | a sensitivity of 8%, specificity of 94% | |
| progression | and positive 28% and negative 77% | |
| | predictive values of 28% and 77%, | |
| | respectively. | |
| Evaluation of age, gender, tooth | Positive predictive value for | Haffajee et al 1991a |
| loss at baseline, probing pocket | periodontitis progression of 80% | |
| depth, gingival index, plaque | using all risk factors. | |
| index, bleeding on probing and | | |
| probing attachment level as | | |
| predictors of periodontitis | | |
| progression | | |
| Evaluation of gingival recession, | Increased risk (odds-ratio) of | Locker & Leake 1993 |
| periodontal pocket depth, | periodontitis progression with age | |
| periodontal attachment loss, age, | above 75 yrs (3.0), psycho-social | |
| gender, marital status, income, | factors (1.5-2.8), low education level | |
| education, place of birth and | (2.2), smoking (2.7) and history of | |
| residence, general health status, | tooth loss (periodontitis) (4.3). | |
| medication, smoking, alcohol | | |
| consumption, oral hygiene, | | |
| regularity of preventive visits, | | |
| psycho-social status and life | | |
| stress as predictors of | | |
| periodontitis progression | | |
| Evaluation based on clinical and | Initial risk categorization of 100 | McGuire 1991, McGuire & |
| radiographic attachment loss, | patients into five risk groups followed | Nunn 1996a&b |
| furcation involvement, tooth | by clinical evaluation 5 to 8 years | |
| mobility, root proximity and form | later. No traditional quality measures | |
| | were calculated. However, prognosis | |
| | was reasonably predictable for teeth | |
| | in low risk categories while teeth in | |
| | high risk categories showed highly | |
| | variable predictability. | |
| Evaluation of the Periodontal | Five risk groups/scores (1 to 5) with | Page et al 2002, 2003 |
| Risk Calculator (PRC) which | increasing statistically significant risks | |
| integrates age, smoking, | of periodontitis progression and tooth | |
| diabetes, history of periodontal | loss for the individual patient. | |
| surgery, pocket depth, bleeding | “Compared with a risk score of 2, the | |
| on probing, restorations or | relative risk of tooth loss was 3.2 for a | |
| calculus below the gingival | risk score of 3, 4.5 for a risk score of | |
| margin, radiographic bone height, | 4 and 10.6 for a risk score of 5. The | |
| furcation involvements, angular | association between the assigned | |
| bone lesions | risk prediction and the actual | |
| | periodontal deterioration observed | |
| | over a period of 15 years was | |
| | unusually strong with probability | |
| | values < 0.000l.” | |
| Evaluation of a Periodontal Risk | Vector diagram which indicates | Lang & Tonetti 2003, |
| Assessment (PRA) model which | statistically significant risk for | Persson et al 2003b |
| integrates percentage of teeth | periodontitis progression or treatment | |
| with bleeding on probing, | outcome | |
| prevalence of residual pockets | | |
| greater than 4 mm, loss of teeth, | | |
| loss of periodontal support in | | |
| relation to age, IL-1 | | |
| polymorphism genotype and | | |
| smoking | | |
| Evaluation of systemic disorders, | “Cardio-vascular disease, diabetes | Lagervall & Jansson 2007 |
| tooth loss and probing depth as | and rheumatic disease may be | |
| predictors of periodontitis | regarded as risk indicators of tooth | |
| progression | loss in men.” | |
| Evaluation of a Periodontal Risk | Vector diagram which indicates | Jansson & Norderyd 2008 |
| Assessment (PRA) model which | (although somewhat overestimates) | |
| integrates bleeding on probing, | statistically significant risk for | |
| periodontal pockets > 5 mm, tooth | periodontitis progression or treatment | |
| loss, attachment loss in relation | outcome | |
| to age, smoking, systemic and | | |
| genetic aspects (IL-1β) as | | |
| predictors of periodontitis | | |
| progression | | |

TABLE 1.3
Commercially available risk assessment tests for chronic periodontitis
with quality and clinical utility measures when available.

| Manufacturer | Risk predictor/s | Risk or quality measure |
|---|---|---|
| AirPerio | Bacterial DNA Test ® (identifies | No information on prognostic |
| www.airperio.com | periodontal pathogens) | relevance for chronic periodontitis |
| | | available. |
| GenEx | Rapid Periodontitis Test ® | No information on prognostic |
| www.geneexinc.com | (RPTTM ®) (detects markers in | relevance for chronic periodontitis |
| | saliva indicative of active | available. |
| | periodontitis) | |
| Kimball genetics | PST ® Genetic Test (detects | Odds-ratio 2.7-18.9 for disease |
| www.kimballgenetics.com | specific variations in interleukin | progression or development |
| | 1α- and 1β-genes) | (Kornman et al 1997a, McGuire & |
| | | Nunn 1999, McDewitt et al 2000). |
| ORATEC | Geno Type ® PST plus (identify | Odds-ratio 2.7-18.9 for disease |
| www.oratec.net | defects in the interleukin 1-gene) | progression or development |
| | | (Kornman et al 1997a, McGuire & |
| | | Nunn 1999, McDewitt et al 2000). |
| ORATEC | BANA ® Enzymatic Test | 90-96% sensitivity and 83-92% |
| www.oratec.net | (identifies an enzyme associated | accuracy but no information on |
| | with 3 anaerobic periodontal | prognostic relevance for chronic |
| | pathogens) | periodontitis available (Loesche et |
| | | al 1992). |
| ORATEC | Micro-IDent ® plus (identifies | 52-86% sensitivity and 76-95% |
| www.oratec.net | major periodontal pathogens) | accuracy but no information on |
| | | prognostic relevance for chronic |
| | | periodontitis available (Eick & |
| | | Pfister 2002). |
| ORATEC | BioScan Phase Contrast Video | No information on prognostic |
| www.oratec.net | Microscopy System ® | relevance for chronic periodontitis |
| | (morphological detection of | available. |
| | periodontal microorganisms) | |
| PreViser Corporation | Risk evaluation based on the | Five risk groups/scores (1 to 5) |
| www.previser.com | Periodontal Risk Assessment | with increasing statistically |
| | model or originally the | significant risks of periodontitis |
| | Periodontal Risk Calculator | progression and tooth loss for the |
| | (PRC), using semi-quantitative | individual patient. “Compared with |
| | estimates of age, dental care, | a risk score of 2, the relative risk of |
| | bleeding, radiographic bone | tooth loss was 3.2 for a risk score |
| | destruction, history of | of 3, 4.5 for a risk score of 4 and |
| | periodontal surgery, subgingival | 10.6 for a risk score of 5.” (Page et |
| | calculus and restoration, | al 2002, 2003). |
| | diagnosis of diabetic, furcation | |
| | involvement, oral hygiene, | |
| | periodontal pockets, smoking | |
| | history, type of bone level | |
| Tendera | Tendera ® (detects ongoing | No information on prognostic |
| www.tendera.com | inflammation in the periodontal | relevance for chronic periodontitis |
| | pocket) | available. |

### Discussion

Chronic periodontitis is a multifactorial infectious disease in patients with a polygenetic predisposition. Because of the complex nature of the disease, unaided risk assessment and prognostication of chronic periodontitis shows great variability between clinicians (Persson et al 2003a). Some 20 different significant risk predictors have been identified as requiring integration in the process of risk assessment and prognostication. A quantitative or semi-quantitative risk measure for the patient and the individual tooth should be the outcome of this process. Hence, risk assessment for chronic periodontitis has been the focus of numerous studies and commercially available tests.

Periodontitis risk predictors can be divided into primary etiological, host and modifying predictors. They interact by reinforcing or reducing the effects of each other. It seems reasonable to assume that reliable periodontitis risk assessment must integrate risk predictors from all three categories. Although several studies have shown an increasing predictability with an increasing number of risk predictors, most of the commercially available tests include only one or two in their assessment. However, an exception is PreViser's risk assessment software which integrates around a dozen risk predictors to calculate a periodontitis risk score for the dentition. The clinical utility of their product in terms of reliability and clinical prognostic value tooth by tooth, however, remains to be determined.

In conclusion, commercially available tests appear to provide some relevant risk information but the prognostic value of the information appears limited. In order to secure full clinical utility, a test for periodontitis risk should not just present a risk level for the patient but also provide detailed risk assessment tooth by tooth to enable focused therapy. This should be accompanied by validation data and relevant data on the prognosticated rate of disease progression tooth by tooth, thereby providing a rationale for the choice of therapeutic measures, requirements which are essential for establishing an unbiased prognostication system. Such information would add a temporal dimension to risk assessment. Current tests based on and evaluated with tooth mortality as an outcome variable over extended observation periods fail to provide such a system (Kwok & Caton 2007).

### Section 1.3 DentoRisk™ and DentoTest™ for Periodontitis Risk Assessment and Prognostication

### Introduction

This section describes the DentoRisk™ algorithm for chronic periodontitis risk assessment for the dentition (Level I) and prognostication of disease outcome tooth by tooth (Level II). It also details the DentoTest™ skin provocation test, which is included in the group of host-related risk predictors. DentoTest™ assesses the individual patient's ability to develop an appropriate unspecific chronic inflammatory reaction.

Most methods used for chronic periodontitis risk assessment and prognostication are largely inadequate as they identify the disease only after severe and sometimes irreversible damage has occurred. The most common method involves observation of only a few risk predictors such as gingival bleeding, bleeding on probing and tissue loss, followed by measurements of the depth of periodontal pockets. Pocket depths in excess of 3 or 4 mm accompanied by attachment loss is indicative of chronic periodontitis. Attachment loss is most commonly observed in radiographs, and, if accompanied by the presence of bony pockets and infection between the roots (furcation involvement), the disease is classified as severe. These methods obviously do not allow for timely focused preventive measures.

In addition to clinical risk predictors as presented in Section 1.2, most of the commercially available tests only include one or two other risk predictors in their assessment, despite the fact that several studies have shown an increasing predictability with an increasing number of risk predictors. Thus, the need for a clinically relevant unbiased tool for risk assessment (Persson et al 2003a) prompted research which resulted in the DentoSystem algorithm (incorporated in the DentoRisk™ assessment software, Cε mark) for assessing risk for and prognosis of chronic periodontitis. The algorithm integrates a multitude of risk predictors relevant to the host, systemic and local conditions within the mouth (Table 1.4). The resulting risk score indicates the risk of progression of the disease, i.e. future attachment loss for the entire dentition (DentoRisk™ Level I), as well as for each individual tooth (DentoRisk™ Level II). Full clinical utility is thus provided by initially presenting a risk level for the patient which, if elevated, indicates more detailed assessment is required using DentoRisk™ Level II. The latter provides detailed risk assessment tooth by tooth to enable focused therapy, accompanied by relevant data on the prognosticated rate of disease progression for individual teeth.

TABLE 1.4
Risk predictors relevant to risk of periodontitis
progression classified according to host predictors,
and systemic and local modifying predictors.

| | Modifying systemic | Modifying local |
|---|---|---|
| Host predictors | predictors | predictors |
| Age in relation to | Patient cooperation | Bacterial plaque |
| history of | and disease | (oral hygiene) |
| chronic periodontitis | awareness | Endodontic pathology |
| Family history | Socio-economic status | Furcation involvement |
| of chronic | Smoking habits | Angular bone |
| periodontitis | The therapist's | destruction |
| Systemic diseases and | experience with | Radiographic marginal |
| related diagnoses | periodontal care | bone loss |
| Result of skin | | Periodontal pocket |
| provocation test to | | depth |
| assess the patient's | | Periodontal bleeding |
| inflammatory | | on probing |
| reactivity | | Marginal dental |
| (DentoTest ™) | | restorations |
| | | Increased tooth mobility |

Local modifying predictors usually exert their influence on all, some or single tooth sites in contrast to systemic modifying predictors, which invariably affect all teeth. In addition to the host predictors, some of the systemic modifying predictors also have a genetic background.

### Algorithm for Chronic Periodontitis Risk Assessment and Prognostication of Disease Outcome Tooth by Tooth (DentoRisk™)

DentoRisk™ (DentoSystem Scandinavia AB, Stockholm, Sweden, www.dentosystem.se) is a web-based analysis tool that calculates chronic periodontitis risk (DentoRisk™ Level I) and, if an elevated risk is found, prognosticates disease progression tooth by tooth (DentoRisk™ Level II). In Level I, the clinician enters numerical or dichotomous values for each clinical variable (Table 1.4) into the algorithm by way of a menu with predefined variable outcomes, and the resulting risk score (DRS_{dentition}) is presented for the dentition as a whole (DentoRisk™ Level I). Subsequently, if an elevated risk is indicated in Level I, detailed registration of clinical variables enables calculation of a risk score (DRSₜₒₒₜₕ) for each individual tooth (DentoRisk™ Level II).

The DentoRisk™ software assigns a numerical value to each variable x in Table 1.4 based on the patient's current periodontal and general medical status when entered into the data entry module. In addition, a relative weight factor a (an integral part of the DentoRisk™ algorithm) is assigned for each variable and is introduced into the calculations performed by the algorithm as presented below.

The numerical values for the variable outcomes and weight factors have been determined from pervious clinical studies, reviewed in detail under “Review of risk predictors in chronic periodontitis” in Section 1.2. Categorization of variable outcomes into intervals is described in “Clinical recordings” in Section 1.4. The equation in the algorithm for calculation of DentoRisk™ scores (DRS) in Levels I & II is as follows:

$$\frac{{a}_{1} {x}_{1} + {a}_{2} {x}_{2} + … + {a}_{n} {x}_{n}}{{a}_{1} {x}_{1 max} + {a}_{2} {x}_{2 max} + … + {a}_{n} {x}_{n max}} = {DentoRisk}^{} Score ( DRS , range 0.00 - 1.00 )$$

### Skin Provocation Test to Assess Inflammatory Response (DentoTest™)

A skin provocation test (DentoTest™) that assesses the individual patient's ability to develop an appropriate unspecific chronic inflammatory reaction is included in the group of host-related risk predictors. Patients with severe forms of chronic periodontitis present with varying degrees of decreased inflammatory reactivity. Using the skin provocation test, it has been shown that an increasing number of negative reactions to increasingly lower doses of irritants was related significantly to an increased severity of chronic periodontitis (Lindskog et al 1999). The impaired inflammatory reactivity in patients with treatment-resistant periodontitis or severe active marginal periodontitis (Lindskog et al 1999) has been interpreted as an impaired reaction to periodontitis pathogens, in turn a reflection of the host's individual immune variability. Differences in the innate immune system between individuals have been proposed as an etiological host factor in chronic periodontitis (Kinnane et al 2007), variations which most likely have a poly-genetic background (Hassell & Harris 1995, Mucci et al 2005).

The irritant in DentoTest™ is Lipid A administered through a simple skin provocation test (Skin Prick Test). Lipid A is the constant part of endotoxin (lipopolysaccharide or LPS). LPS as a complex, or the lipid part alone which is called Lipid A, has a wide range of biological activities including eliciting an unspecific chronic inflammatory response.

Because of the multifactorial nature of the disease, the results from the skin provocation test must be integrated with other risk factors in order to assess risk and prognosticate disease development. Thus, the intended use of the skin provocation test is only in conjunction with risk and prognosis assessment in DentoRisk™.

### Validation Plan for DentoRisk™ and DentoTest™

Validation is an important step in quality control of diagnostic and prognostic tests to demonstrate “fitness for purpose”. In the process of validation both reliability and validity as well as other relevant quality characteristics are demonstrated. Reliability is a measure of the extent to which an instrument, test or method is able to produce the same data when measured at different times, or by different users. Validity is a measure of the extent to which an instrument, test or method actually measures what it is supposed to measure. In measurement quality terms, reliability equals precision and validity equals accuracy. Consequently, a specific purpose of the test must be defined and sufficient data must be obtained (validation data) to demonstrate, in statistical terms, confidence in its use in a diagnostic or prognostic setting. The general purpose of the validation plan for the DentoRisk™ algorithm is to demonstrate that Level I of the DentoRisk™ analyses and accurately selects risk patients for detailed disease prognostication tooth by tooth in DentoRisk™ Level II. An independent clinical validation sample was generated for this purpose in a prospective clinical study described in detail in Section 1.4 and a four-step validation model with the following specific aims was defined in accordance with recommendations by Kwok & Caton (2007) and Rutjes et al (2007):
To verify that a sufficient number of relevant risk predictors for chronic periodontitis have been included in the DentoRisk™ algorithm (Section 1.5).
To calculate clinically relevant quality characteristics for risk assessment (DentoRisk™ Level I) and prognostication (DentoRisk™ Level II) of chronic periodontitis (Section 1.6).
To assess the clinical significance and relevance of prognostication of chronic periodontitis tooth by tooth in DentoRisk™ Level II (Section 1.7).
To analyze in-depth a select number of strong risk predictors (smoking, angular destruction and furcation involvement, abutment teeth and endodontic pathology) to verify congruence with previous studies and to evaluate the contribution of DentoTest™ to risk analysis and prognostication with DentoRisk™.

### Discussion

The need for rational risk assessment methods in periodontal treatment planning has recently been highlighted by the American Academy of Periodontology (AAP 2006, 2008): “[risk assessment will become] increasingly important in periodontal treatment planning and should be part of every comprehensive dental and periodontal evaluation.” It follows that intervention and preventive measures cannot be accurately focused on a specific tooth or site since detailed prognostic data at the tooth level is lacking (Lang et al 1998). This can result in significant increases in cost and suffering for patients, even over fairly short periods of time Ode et al 2007).

Since chronic periodontitis is a multifactorial infectious disease in patients with a polygenetic predisposition, risk assessment and disease prognostication must integrate significant predictors from three predictor categories (primary etiological, host and modifying predictors). A limited selection will not be sufficient since predictors from the three categories interact and reinforce or reduce the effects of each other. They influence either growth and composition of the pathogenic bacterial biofilm (which in turn elicits an inflammatory response) or the inflammatory response itself.

In order to make risk assessment with DentoRisk™ clinically accessible, only clinical and radiological registrations that are part of a normal dental examination are required in Level I. The selection of risk predictors in DentoRisk™ regardless of level may appear to be overlapping. However, they were selected to add strength to the model since overlapping risk predictors may serve to make the model robust in case of missing data. In the validation process, the relevance of the selected risk predictors are evaluated.

Level I analysis only selects patients with an overall risk for detailed prognostication tooth by tooth in Level II. Hence, Level I assesses risk and Level II prognosticates the rate of disease progression tooth by tooth for patients with an elevated risk. However, before any such risk assessment system can be recommended for clinical use, clinical utility must be demonstrated and validated (Kwok & Caton 2007), It should be demonstrated that the system fulfils its intended purpose. Accordingly, a validation plan was devised utilizing data from a prospective clinical trial. The general purpose of the validation plan for DentoRisk™ was to characterize its clinical performance and prognostic relevance and generate reliability and validity data specifying the quality of its performance.

### Section 1.4 Investigational Materials and Methods

### Introduction

This section presents the investigational materials and methods (independent validation sample) for clinical validation of DentoTest™ and the DentoRisk™ algorithm for chronic periodontitis risk assessment and prognostication. The investigational materials comprise longitudinal clinical and radiological recordings in an adult average population representing a spectrum of patients, from those with severe chronic periodontitis to those with only mild periodontitis or no disease. The patients were selected from three specialist and four general dental clinics to secure a sufficient number of patients with chronic periodontitis.

### Patient Population, Clinical Trial Data and Institutional Review

Results from an open prospective clinical study performed at 5 clinics with 7 investigators (3 periodontal specialists and 4 general practitioners) and 213 patients between 30-65 years of age was used to validate the clinical utility of DentoRisk™ and DentoTest™. Baseline registrations were done between December 1998 and March 1999 and follow-up registrations between October 2002 and December 2002, resulting in an average observation time of 3.8 years. At follow-up, 183 patients were available for examination. The trial was approved by the Local Ethics Committee and the Swedish Medical Products Agency. All patients signed an informed consent form. The trial was conducted in compliance with Good Clinical Practice and the Helsinki Declaration.

The following inclusion criteria applied:
Patients aged 30 to 65 years
Patients with periodontal status ranging from only mild or no gingivitis to ongoing severe periodontitis
   Exclusion criteria were:
Patients with a documented allergy to Lipid A
Patients undergoing treatment with anti-inflammatory drugs
Patients suffering from terminal cancer, AIDS or rheumatoid disorders
Patients which may be suspected of poor compliance

The patients were selected by the investigators on a consecutive referral or treatment basis during a period of four months. The involvement of both specialists and general practitioners ensured enrolment of patients presenting a spectrum of severity of chronic periodontitis and periodontal health. Each investigator examined no more than 35 patients and no less than 28 patients.

### Periodontal Therapy During the Observation Period

The investigational material consisted of patients in general dental care (58.8%) and patients referred to periodontal specialist clinics (41.2%). The distribution of different periodontal treatments during the observation period is presented in Table 1.5. It should be noted that some patients may have received both surgical and non-surgical intervention. Not included in Table 1.5 are restorative therapy, tooth extraction or tooth loss (see Section 1.7).

TABLE 1.5
Distribution of different periodontal treatments within the
investigational material during the observation period.

| | Type of Treatment | | | |
|---|---|---|---|---|
| | | Non-regenerative | Regenerative | |
| | Non-surgical | surgical | surgical | |
| Dental clinic | intervention | intervention | intervention | Other |
| General | 86.6% | 2.5% | 0.0% | 10.9% |
| Specialist | 67.9% | 20.2% | 1.2% | 20.2% |

All patients in general dental care stayed with the same dentist throughout the investigational period while 20.2% of the patients referred to periodontal specialists were referred back to their general practitioner after periodontal intervention or with a treatment plan that could be carried out by their general practitioners. These patients are accounted for under “Other” for “Specialists”. Patients who required no periodontal treatment are also accounted for under “Other”, in particular for general practitioners.

### Clinical Recordings

Age in relation to history of chronic periodontitis was based on an assessment of the degree of radiographic bone loss around remaining teeth in relation to the patient's age. Lost teeth were recorded as 100% bone loss. Each patient was asked about any family history of chronic periodontitis as well as systemic disease and related diagnoses relevant to chronic periodontitis (Table 1.1 in Section 1.2).

Smoking habits were recorded and categorized into three intervals: (1) less than 10 cigarettes per day, (2) 10-20 cigarettes per day and (3)>20 cigarettes per day. Previous smoking habits were recorded and entered into the calculations if the patients stopped less then 5 years ago and had smoked more than 10 cigarettes per day. Patients who stopped more than 5 years ago or had smoked less than 10 cigarettes per day before they stopped were regarded as non-smokers.

A simple semi-quantitative approach was chosen to record the three risk predictors which could not be immediately quantified. They were categorized into three intervals based on medical and socio-economic history as well as interviews and subsequently given predefined scores for each of the three intervals. Patient cooperation and disease awareness was categorized into three intervals (none, some or high). Similarly, socio-economic status was categorized into three intervals (1) negative stress including nutritional deficiencies, obesity, alcohol abuse and other stress-related factors, (2) economic problems, or (3) a combination of negative stress and economic problems. Finally, self-assessment was used to evaluate the therapist's own experience of diagnosing chronic periodontitis as well as planning and performing advanced periodontal treatment. This was categorized into three intervals (none or negligible, some and extensive).

The periodontal status in each patient was recorded by clinical examination and bite-wings as well as periapical radiographs. Presence or absence of proximal plaque was recorded (Ainamo & Bay 1975). Pocket depth was measured in millimeters by midproximal examination according to Persson (1991) and categorized into intervals (0-3 mm, 4-6 mm and ≧7 mm). Gingival bleeding following probing was recorded according to Ainamo & Bay (1975). Presence of pus was recorded simultaneously (Ainamo & Bay 1975). Missing teeth was recorded by tooth number. Furcation involvement was measured from the gingival margin into the furcation opening with a graded probe and recorded using a modified Nyman & Lindhe index (1998): (0) no furcation involvement, (1) initial but <2 mm and (2) ≧2 mm. Tooth mobility was assessed and recorded according to Lindhe et al (1998). Endodontic pathology was recorded when a periapical destruction was present or the periodontal space was widened and the lamina dura could not be seen (Jansson et al 1993a&b). Angular bony destruction was recorded if the most coronal point of the alveolar crest was located more than 2 mm from the bottom of the radiolucency in the vertical plane and located at least 1 mm from the root surface in the horizontal plane at the opening of the defect (Papapanou & Wennstrom 1991, Jansson et al 1993a&b). Radiographic marginal bone loss was measured as described under “Radiographic recordings” below and categorized into four intervals (<3 mm, 3-5 mm, 5-7 mm and >7 mm). Proximal restorations with a subgingival margin were recorded as with or without overhang. Abutment teeth were registered as a sub-group of teeth with proximal restorations.

### Radiographic Recordings

Radiographic examination was performed according to the intra-oral paralleling technique with projections perpendicular to the dental arch in premolar and molar areas (Jeffcoat et al 1995, Gröndahl 2003). The bisecting-angle technique was avoided because it may distort angular dimensions (Gröndahl 2003).

A total of four bite-wing radiographs were taken both at baseline and follow-up examination, on each side for the first and second molars and one on each side for the premolar areas. In partly edentulous patients, a total of two radiographs was acceptable. Analogue film and X-ray machine settings were used according to the routines and standard calibrations of each clinic.

Radiographs were scanned individually with a Microtek ScanMaker E6 flat bed scanner, using the software Image Pro Plus (IPP) version 4.0 (Media Cybernetics, Inc. Bethesda, Md., USA) and ScanWizard ver. 2.51 Twain-compliant scanner controller for Windows. The software used for measurements on the digitized radiographic material was Image Pro Plus (IPP) version 4.0. Measurements were taken in millimeters. Radiographs for each patient were calibrated by measuring the height of the image in millimeters in comparison to the scanned dimensions on the original image.

Three examiners performed the radiographic measurements. Measurements of attachment levels were made on the mesial and distal surfaces of premolars and first and second molars in both jaws, allowing a maximum total of 32 surfaces for each patient. Measurements were taken from the cemento-enamel junction to the marginal bone crest. In cases with angular bone defects, measurements were taken from the cemento-enamel junction to the apical extent of the angular defect. If a tooth had a proximal filling or a crown extending to the cemento-enamel junction, measurements were taken from the cervical margin of the filling or crown to the marginal bone crest. If the restorations extended below the cemento-enamel junction a projection of the neighboring cemento-enamel junction was used as a reference point.

Inter- and intra-examiner calibrations of the three examiners performing the measurements were conducted on a predefined series of radiographs.

### Analysis of Reliability of Measurements

The results of periodontal probing depends on a number of factors such as the thickness of the probe, pressure applied to the instrument during probing, malposition of the probe due to improper angulation of the probe and the degree of inflammatory cell infiltration in the soft tissue and accompanying loss of connective tissue (Listgarten 1980). Analysis of differences in measurements between the examiners is recommended in most studies and especially in cases of different examiners at baseline and intermediate or final probing. In the present study, the same examiner and the same kind of probe was used at baseline and at final examination. In addition, the examiners were not aware of baseline data at final recordings.

Periodontal pockets which showed both bleeding on probing and probing without bleeding were recorded. In a bleeding periodontal pocket, pocket depth is normally overestimated while probing in non-bleeding pockets underestimates the depth (Listgarten 1980). Midproximal periodontal examinations described by Persson (1991) were used in the present study. These examinations give values 1 mm higher than line-angle examinations for posterior teeth (Persson 1991). It is not always possible to identify the degree of angulation different studies have used (Okamoto et al 1988), but midproximal examination probably yields the best data for baseline recordings and periodontal treatment (Persson 1991).

Inter- and intra-examiner reliabilities were analyzed for the morphometric measurement of bone levels in radiographs. Inter-rater reliability, inter-rater agreement, or concordance is the degree of agreement among examiners. It gives a score of how much homogeneity, or consensus, there is.

There are a number of statistical test which can be used to determine inter-examiner reliability. One alternative that works well for more than two raters is the Fleiss' κ-statistic. It can be interpreted as expressing the extent to which the observed amount of agreement among raters exceeds what would be expected if all raters made their ratings completely randomly. If the raters are in complete agreement then κ=1. If there is no agreement among the raters (other than what would be expected by chance) then κ≦0 and if there is complete disagreement κ=−1. Inter-examiner reliability in the present study was determined to be κ=0.3 (Standard Error (SE)=0.02, p<0.0001) indicating acceptable agreement above chance level (Fleiss 1981).

For intra-examiner reproducibility simple κ-statistics does not take into account the degree of disagreement between measurements and all disagreement is treated equally as total disagreement. Therefore when the categories are ordered, as for the radiographic measurements in the present study, it is preferable to use weighted κ-analysis, and assign different weights wᵢ to subjects for whom the raters differ by i categories, so that different levels of agreement can contribute to the value of κ. Weights are chosen according to Fleiss & Cohen (1973). Intra-examiner reproducibility in the present study was determined to be κ=0.8 (Asymptotic Standard Error (ASE)=0.03, p<0.0001) indicating acceptable agreement above chance level (Fleiss & Cohen 1973).

It has previously been shown that non-standardized radiographic examinations using the paralleling technique are sufficient when the purpose of the examination is to obtain length measurements to determine progress of periodontal conditions (Duinkerke et al 1986). Measurements on clinically acceptable non-standardized bite-wing radiographs have been shown to enable detection of degrading changes in bone height as small as 0.5 mm (Jeffcoat et al 1995). However, other studies have shown limitations in the correlation of probing attachment level gain in horizontal bone defects following conventional treatment. This is in contrast to vertical bone defects following regenerative therapy where bone fill may be seen (Heijl et al 1997).

### Skin Provocation Test (DentoTest™)

Each patient was tested with a skin provocation test (DentoTest™) that assessed the individual patient's ability to develop an appropriate unspecific chronic inflammatory reaction both at baseline and follow-up examination. The test substance was Lipid A and the test comprised:
20 μl of three different concentrations of Lipid A (0.1 μg/ml, 0.01 μg/ml and 0.001 μg/ml dissolved in sterile water)
The vehicle (sterile water) alone (negative control)

The test was performed with a standardized assembly of applicators (Multi-Test™) manufactured by Lincon Diagnostics Inc, Decatur, Ill. 62525, USA. The chronic erythematous unspecific inflammatory reaction was measured in mm 24 hours (±6 hours) post challenge. The following definitions applied to reading of the test reaction:

Positive Reaction The skin becomes red and swollen with a weal in the center (very much like the reaction to a needle sting). The size of the weal does not indicate the severity of symptoms. For a positive reading the reaction must exceed that of the negative control.

Negative Reaction No redness, swelling or “weal” appear in the test sites.

### Data Handling

Data entry of all numerical data from baseline and follow-up visits was done by Trial Form Support (TFS, Helsingborg, Sweden) and a clean file produced for statistical analysis. The statistical report was designed to ensure compliancy with appropriate ICH guidelines, particularly E9 (Statistical Principles for Clinical Trials) and E3 (Structure and Content of Clinical Study Reports). The Standard Operating Procedures (SOP) for statistics belonging to TFS were applied. All statistical analyses were conducted in compliance with Good Clinical Practice. The Statistical Analysis Software with SAS/STAT® ver. 9.1 (SAS Institute Inc., Cary, N.C., USA) was used throughout the analyses.

### Outcome Variables

In steps one and two of the analysis plan, radiographic marginal bone loss over time, development of furcation involvement and angular bony destruction were used in combination as one of two outcome variables (measures of periodontitis progression, FIGS. 1.2a-c). Periodontitis was considered to have progressed in both DentoRisk™ Level I and II analyses if one or more of the three disease progression indicators had developed (1) at any proximal surface in the molar and premolar sections (radiographic marginal bone loss, furcation involvement or angular bony destruction), or (2) at any proximal, facial or oral surface (furcation involvement), or (3) increased in severity (radiographic marginal bone loss or furcation involvement) between baseline examination and follow-up.

The second outcome variable was radiographic marginal bone loss over time, which was used mainly for comparison with epidemiological data from the literature on progression of chronic periodontitis. In the DentoRisk™ Level I analyses a mean for the patient was calculated for radiographic marginal bone loss over time with no predefined cut-off limit for disease progression as well as for the combined outcome variable (radiographic marginal bone loss, furcation involvement or angular bony destruction).

In step three of the analysis plan, radiographic marginal bone loss and tooth loss over time were used as outcome variables. The annual mean radiographic marginal bone loss was calculated for the resulting DentoRisk™ score intervals.

With reference to FIGS. 1.2a-c, (FIG. 1.2a) change in marginal radiographic bone level over time as indicated by the two arrows or (FIG. 1.2b) furcation involvement (arrow), and (FIG. 1.2c) development of angular radiographic bony destruction (arrow), were used in combination as one of three outcome variables of periodontitis progression.

### Statistical Analysis Plan

Normality plots and tests (Kolmogorov's Test of Normality) were used in order to test the assumption for the Pearson's correlation coefficient for the continuous variables. The primary analysis focused on the end-point, defined as the last available measurement obtained from each subject during the study. Subjects with missing data (drop-outs) were included where possible, e.g. in the description of the patient population. Wherever the analysis required data on a variable, subjects with missing data were excluded from the analysis. Missing items were not imputed in any way.

In a series of statistical analyses, performance characteristics and quality measures for the DentoSystem algorithm in DentoRisk™ for assessing risk for, and prognosis of, chronic periodontitis were established:
1. Linear regression was used to correlate DentoRisk™ scores from Level I (DRS_{dentition}) to the outcome variables in order to establish intervals of DRS_{dentition} indicating risk of losing clinically significant periodontal attachment. Multivariate linear regression was used to investigate the relationship between the numerical outcome variables and the explanatory variables (host, systemic and local risk predictors) included in the DentoSystem algorithm in DentoRisk™ Level II (tooth by tooth). This was done to evaluate the relevance of the risk predictors included in the DentoSystem algorithm. In addition, step-wise regression analysis was applied to establish which variables are of greatest importance in terms of explaining the outcome variable in DentoRisk™ Level II.
2. Quality characteristics (accuracy, sensitivity, specificity, positive (PPV) and negative predictive values (NPV) were calculated for the selection of risk patients in DentoRisk™ Level I and the disease prognostication in DentoRisk™ Level II. Of these values, PPV probably represents the most important since it is a measure of the likelihood that disease or disease progression is truly present.
3. In order to establish the clinical significance of DentoRisk™ Level II score (DRSₜₒₒₜₕ) intervals, logistic regression was used to calculate the odds-ratio for progression of chronic periodontitis and tooth mortality.

The DentoTest™ results as a risk predictor for chronic periodontitis were analyzed in four steps:
1. The relationship between the skin provocation test result (DentoTest™) results and severity of chronic periodontitis (history of radiographic marginal bone loss) at baseline was investigated. Previous studies have shown a decreased reactivity to Lipid A administered through a simple Skin Prick Test in patients with severe chronic periodontitis. Hence, this initial analysis was done to confirm previous results (Lindskog et al 1999).
2. The relationship between the DentoTest™ results and the progression of chronic periodontitis (radiographic marginal bone loss) over time was investigated.
3. The contribution from the DentoTest™ results to the DentoRisk™ model was calculated.
4. Results from the three steps above were compared to the influence of smoking, morphological characteristics of attachment loss (angular destruction and furcation involvement), abutment teeth and endodontic pathology all of which are known strong modifying risk predictors.

### Descriptive Statistics

### Study Population

Data for validating the DentoSystem algorithm in DentoRisk™ were extracted from a prospective clinical trial which generated clinical and radiographic recordings from 213 patients at baseline and 183 patients at follow-up over a mean observation period of 3.8 years. The 183 patients that completed both visits had 2928 teeth at baseline and 2862 teeth at follow-up. The mean age of these patients was 47.9 years at baseline.

There were 30 dropouts (14%). The mean age of these was 44.3 years at baseline (range 29.9-69.5 years), i.e. the dropouts represented no specific age group and can be considered a random group of patients with respect to age. 11 of them were treated at specialist clinics (13% of the total number of patients at specialist clinics), and 19 were treated at general dental clinics (15% of the total number of patients at general clinics). The dropouts can thus be considered a random selection of patients from general and specialist clinics.

Radiographic marginal bone level and periodontitis progression indicators

Mean radiographic marginal bone levels per patient at baseline and follow-up are shown in FIGS. 1.3 and 1.4, respectively. Mean radiographic marginal bone level per tooth at baseline and follow-up are shown in FIGS. 1.5 and 1.6, respectively. Mean radiographic marginal bone loss from baseline to follow-up was 0.35 mm per tooth (SD 0.62 mm) with a mean annual loss of 0.09 mm.

FIG. 1.3 is a graph showing intervals of mean radiographic marginal bone level per patient at baseline (N=213 patients).

FIG. 1.4 is a graph showing intervals of mean radiographic marginal bone level per patient at follow-up (N=183 patients).

FIG. 1.5 is a graph showing intervals of mean radiographic marginal bone level per tooth at baseline (N=2928 teeth).

FIG. 1.6 is a graph showing intervals of mean radiographic marginal bone level per tooth at follow-up (N=2841 teeth).

Distribution of the number of periodontitis progression indicators per patient and tooth at follow-up is shown in Table 1.6. Approximately 50% of the patients had more than one periodontitis progression indicator and approximately 45% of the teeth presented with one or more periodontitis progression indicators.

TABLE 1.6
Distribution of the number of periodontitis progression
indicators per patient and tooth at follow-up.

| No. of periodontitis | No. of | | No. of | |
|---|---|---|---|---|
| progression indicators | patients | % | teeth | % |
| 0 | 33 | 18.0 | 1164 | 40.0 |
| 1 | 56 | 30.6 | 1117 | 38.0 |
| 2 | 56 | 30.6 | 181 | 6.2 |
| 3 | 38 | 20.8 | 23 | 0.8 |
| Not possible to evaluate | 0 | 0.0 | 443 | 15.0 |
| Total | 183 | 100.0 | 2928 | 100.0 |

The number of patients and teeth for which follow-up data were available distributed against DRS_{dentition} and DRSₜₒₒₜₕ at baseline, respectively, can be seen in Tables 1.7 and 1.8. Approximately 60% of the patients presented with a DRS_{dentition} above 0.5 while approximately 70% of the teeth had a DRSₜₒₒₜₕ below 0.2. This is illustrated in FIG. 1.7.

TABLE 1.7
Number of patients (N) at baseline and for which follow-up data
were available distributed against DRS_{dentition} intervals.

| DRS_{dentition} interval | N | % |
|---|---|---|
| DRS_{dentition} < 0.4 | 25 | 13.7 |
| 0.4 ≦ DRS_{dentition} < 0.5 | 51 | 27.7 |
| 0.5 ≦ DRS_{dentition} < 0.6 | 35 | 19.1 |
| 0.6 ≦ DRS_{dentition} < 0.7 | 34 | 18.7 |
| DRS_{dentition} ≧ 0.7 | 38 | 20.8 |
| Total | 183 | 100.0 |

TABLE 1.8
Number of teeth (N) at baseline and for which follow-up data
were available distributed against DRSₜₒₒₜₕ intervals.

| DRSₜₒₒₜₕ interval | N | % |
|---|---|---|
| DRSₜₒₒₜₕ < 0.2 | 1985 | 67.8 |
| 0.2 ≦ DRSₜₒₒₜₕ < 0.3 | 543 | 18.6 |
| 0.3 ≦ DRSₜₒₒₜₕ < 0.4 | 114 | 3.9 |
| 0.4 ≦ DRSₜₒₒₜₕ < 0.5 | 167 | 5.7 |
| 0.5 ≦ DRSₜₒₒₜₕ < 0.6 | 74 | 2.5 |
| 0.6 ≦ DRSₜₒₒₜₕ < 0.7 | 16 | 0.5 |
| DRSₜₒₒₜₕ ≧ 0.7 | 29 | 1.0 |
| Total | 2928 | 100.0 |

FIG. 1.7 is a graph of the number of teeth at baseline (N=2928 teeth) and for which follow-up data were available distributed against intervals of DRSₜₒₒₜₕ.

Mean radiographic marginal bone loss for the dentition as a whole increased with increasing DRS_{dentition} (Table 1.9). With an increasing DRS_{dentition}, the mean number of periodontitis progression indicators for the dentition increased, as seen in Tables 1.10 and 1.11 indicating a significantly increased risk of disease progression for patients with a DRS_{dentition}≧0.5 (annual mean bone loss >0.10 mm corresponding to a mean number of disease progression indicators >2).

TABLE 1.9
Mean radiographic marginal bone loss over the observation
period distributed against DRS_{dentition} intervals.

| | Mean radiographic marginal bone loss | | | | |
|---|---|---|---|---|---|
| | (MBL) in mm | | | | |
| | Total | | Annual | | |
| DRS_{dentition} interval | MBL | SD | MBL | SD | N (teeth) |
| DRS_{dentition} < 0.4 | 0.14 | 0.15 | 0.04 | 0.04 | 25 |
| DRS_{dentition} ≧ 0.4 | 0.33 | 0.49 | 0.09 | 0.13 | 155 |
| DRS_{dentition} ≧ 0.5 | 0.40 | 0.54 | 0.11 | 0.15 | 105 |
| DRS_{dentition} ≧ 0.6 | 0.50 | 0.61 | 0.14 | 0.17 | 68 |
| DRS_{dentition} ≧ 0.7 | 0.58 | 0.72 | 0.16 | 0.19 | 38 |

TABLE 1.10
Mean number of periodontitis progression indictors in the dentition
distributed against different DRS_{dentition} intervals.

| DRS_{dentition} Interval | 0 | 1 | 2 | 3 | N (patients) |
|---|---|---|---|---|---|
| DRS_{dentition} < 0.4 | 9 | 11 | 6 | 25 | 26 |
| DRS_{dentition} ≧ 0.4 | 24 | 45 | 50 | 157 | 157 |
| DRS_{dentition} ≧ 0.5 | 3 | 25 | 41 | 107 | 107 |
| DRS_{dentition} ≧ 0.6 | 0 | 4 | 27 | 69 | 69 |
| DRS_{dentition} ≧ 0.7 | 0 | 1 | 9 | 38 | 38 |

TABLE 1.11
Mean DRS_{dentition} distributed against number of periodontitis
progression indicators in the dentition.

| | DRS_{dentition} | | |
|---|---|---|---|
| No. of disease progression indicators | Mean | SD | N (patients) |
| 0 | 0.44 | 0.075 | 33 |
| 1 | 0.48 | 0.098 | 56 |
| 2 | 0.59 | 0.123 | 56 |
| 3 | 0.74 | 0.056 | 38 |

With an increasing DRSₜₒₒₜₕ chronic periodontitis progressed and teeth lost attachment, seen as both an increasing loss of marginal radiographic bone attachment (Table 1.12) and an increasing number of disease progression indicators (Table 1.13).

TABLE 1.12
Mean radiographic marginal bone loss for
teeth from different DRSₜₒₒₜₕ intervals.

| | Mean radiographic marginal bone loss (MBL) in mm | | | | |
|---|---|---|---|---|---|
| | Total | | Annual | | |
| DRSₜₒₒₜₕ interval | MBL | SD | MBL | SD | N (teeth) |
| DRSₜₒₒₜₕ < 0.2 | 0.24 | 0.39 | 0.06 | 0.10 | 1401 |
| DRSₜₒₒₜₕ ≧ 0.2 | 0.56 | 0.86 | 0.15 | 0.23 | 803 |
| DRSₜₒₒₜₕ ≧ 0.3 | 0.73 | 1.02 | 0.20 | 0.28 | 304 |
| DRSₜₒₒₜₕ ≧ 0.4 | 0.81 | 1.09 | 0.22 | 0.29 | 232 |
| DRSₜₒₒₜₕ ≧ 0.5 | 0.99 | 1.23 | 0.27 | 0.34 | 83 |

TABLE 1.13
Mean number of periodontitis progression indictors for
teeth distributed against different DRSₜₒₒₜₕ intervals.

| | Mean No. of disease progression indicators | | |
|---|---|---|---|
| DRSₜₒₒₜₕ interval | Mean | SD | N (teeth) |
| DRSₜₒₒₜₕ < 0.2 | 0.42 | 0.49 | 1554 |
| DRSₜₒₒₜₕ ≧ 0.2 | 0.96 | 0.76 | 931 |
| DRSₜₒₒₜₕ ≧ 0.3 | 1.54 | 0.65 | 392 |
| DRSₜₒₒₜₕ ≧ 0.4 | 1.70 | 0.61 | 284 |
| DRSₜₒₒₜₕ ≧ 0.5 | 1.86 | 0.72 | 117 |

At increasing DRSₜₒₒₜₕ≧0.2, the individual tooth appeared to be at an increasing risk of disease progression, while DRSₜₒₒₜₕ<0.2 indicate no or negligible risk of disease progression (Table 1.14).

TABLE 1.14
Mean DRSₜₒₒₜₕ distributed against annual number of
disease progression indicators at the tooth level.

| | DRSₜₒₒₜₕ | | |
|---|---|---|---|
| No. of disease progression indicators | Mean | SD | N (teeth) |
| 0 | 0.17 | 0.051 | 1164 |
| 1 | 0.22 | 0.109 | 1117 |
| 2 | 0.48 | 0.101 | 181 |
| 3 | 0.73 | 0.069 | 23 |

### Tooth Loss

Tooth loss was registered at the end of the study period together with the reason or reasons for the loss. In total 66 teeth or 2.25% of all teeth were lost during the observation period, all due to chronic periodontitis. Descriptive statistics for the material is presented in the Table 1.15 indicating a higher frequency of tooth loss in patients with a DRS_{dentition} above 0.5. Double the number of teeth (44) were lost in the DRSₜₒₒₜₕ interval above 0.3 compared to the DRSₜₒₒₜₕ interval below 0.3.

TABLE 1.15
Tooth loss in patients with a DRS_{dentition} above and below 0.5.

| | | No. of patients | % of total no. of |
|---|---|---|---|
| DRS_{dentition} interval | No. of patients | who lost teeth | patients |
| DRS_{dentition} < 0.5 | 76 | 5 | 2.7 |
| DRS_{dentition} ≧ 0.5 | 107 | 34 | 18.6 |
| Total | 183 | 39 | 21.3 |

### Discussion

### Investigational Materials (Validation Sample)

Risk and uncertainty are central to forecasting or prediction. Prognosis is a medical term denoting prediction of how a patient's disease will progress, and whether there is chance of recovery. Forecasting or prognostication in situations of uncertainty is the process of estimation of time series from cross-sectional or longitudinal data. Time series forecasting is the use of a model to forecast future events based on known past events or to forecast future data points before they are measured. A longitudinal study is a correlational research study that involves repeated observations of the same items over long periods of time. Cross-sectional data refers to data collected by observing many subjects at the same point of time, or without regard to differences in time.

In medicine and dentistry, time series data is preferable for validating predictive or prognostic models. However, before predictive qualities of such a model are assessed, the relevance of “past events” or risk predictors needs to be established. Secondly, as a supplement to assessment of the validity of a prognostic model, clinical relevance in terms of disease progression indicators should be calculated in particular for multifactorial diseases. These assessments and calculations are commonly referred to as validation of the model. For this purpose, a validation sample independent of any data or sample used for the construction of the model should be generated (Petrie & Sabin 2000). The investigational materials for validation of the DentoRisk™ algorithm were thus selected from a clinical study generating time series data on the progression of chronic periodontitis in a population with varying degrees of initial disease.

The investigational materials for validating the DentoRisk™ algorithm and assessing the clinical relevance of the skin provocation test (DentoTest™) comprised a sample with a spectrum of disease severity, documented with clinical and radiographic data from baseline to follow-up for 183 patients and 2928 teeth over a mean observation period of approximately 4 years in accordance with the recommendations on both observation period (less than 5 years) and outcome variables by Kwork & Caton (2007). These authors discarded tooth mortality as a reliable outcome variable for evaluating prognostic models at the tooth level. Consequently, chronic periodontitis progression in the present validation sample was assessed tooth by tooth with measurements of radiographic marginal bone loss and a variable based on combinations of radiographic bone loss, angular bony destruction and furcation involvement (periodontitis progression indicators). To minimize uncertainty with respect to disease progression over time, reliability and reproducibility of measurements for the outcome variables were determined.

Based on a cut-off limit for radiographic bone loss below 0.10 mm annually characteristic of an adult population, an annual bone loss above 0.10 mm may be defined as indicative of chronic periodontitis (Löe et al 1978, Laystedt et al 1986, Papapanou et al 1989). Distribution data for DentoRisk™ intervals presented in Table 1.9 at the patient level and in Table 1.12 at the tooth level show that approximately 27% of teeth in the validation sample demonstrated disease progression above 0.10 mm annually. This frequency is somewhat higher than that reported for an average adult population indicating some over-representation of periodontitis patients in the validation sample. This is most likely because the investigational materials consisted of 41.2% patients referred to periodontal specialist clinics. However, the over-representation of periodontitis patients ensured that a sufficient number of patients and teeth with chronic periodontitis were included in the investigational sample to validate the DentoSystem algorithm in DentoRisk™.

Further results in support of the validity of the investigational materials are presented in Section 1.8. In this section, congruence between our investigational materials and previous reports are demonstrated for the influence of smoking, angular bony destruction and furcation involvement, abutment teeth and endodontic pathology, all of which are predictors with known strong explanatory values for the development and progression of chronic periodontitis. Methods for measurements and assessment of clinical and radiographic risk predictors have been discussed in the sections describing each respective method.

### Statistical Analysis Plan and Validation Plan

In a series of statistical analyses defined in the statistical analysis plan, performance characteristics and quality measures for the DentoSystem algorithm in DentoRisk™ for chronic periodontitis risk assessment (Level I) and prognostication of disease outcome tooth by tooth (Level II) were established. The first step in the validation plan use regression analyses to evaluate the relevance of the risk factors included in the DentoSystem algorithm. In the second step of the validation plan, quality characteristics are calculated for the prognostic properties of the DentoSystem algorithm. The third step in the validation plan will establish the clinical significance of different DRSₜₒₒₜₕ intervals. These three steps are standard requirements in validating algorithms for statistical modeling of risk and prognosis (Petrie & Sabin 2000). Finally, the contribution from DentoTest™ results to the DentoRisk™ model was calculated and compared to the influence of five known strong modifying risk predictors. The details of the outcome of each step are discussed under the relevant sections below.

### Section 1.5 Relevance and Impact of Risk Predictors in the DentoRisk™ Algorithm

### Introduction

In Section 1.2, etiological and disease modifying risk predictors were reviewed and the relative impact of each predictor on chronic periodontitis risk was ranked. This review served as a basis for constructing the DentoRisk™ algorithm described in detail in Section 1.3 together with a plan for its validation. For this purpose an independent validation sample was generated as described in Section 1.4. In this section, the results of the first step in the validation plan are presented. The aim of this step is to verify that a sufficient number of relevant risk predictors resulting in sufficiently high explanatory values have been included in the DentoRisk™ algorithm.

Linear regression was used to correlate DRS_{dentition} (scores from DentoRisk™ Level I, the dentition as a whole) to the outcome variables in order to establish intervals of DRS_{dentition} relevant to risk of losing clinically significant periodontal attachment. Multivariate linear regression was used to investigate the relationship between the numerical outcome variables (DRSₜₒₒₜₕ or scores from DentoRisk™ Level II, tooth by tooth) and the explanatory variables (host, systemic, and local risk predictors) included in the DentoSystem algorithm for DentoRisk™ Level II. This was done to evaluate the relevance of the risk predictors included in the DentoSystem algorithm. In addition, stepwise regression analysis was applied in order to establish which variables are of greatest importance in terms of explaining the outcome variable in DentoRisk™ Level II.

Correlation of Variables and Scores from Dentorisk™ Level I (Dentition) to the Outcome Variables

Correlation of DRS_{dentition} to the outcome variable number of disease progression indicators presented a strong correlation (r=0.723, p<0.0001, N=183 patients). Linear regression between DRS_{dentition} and the outcome variable yielded an overall explanatory value R² of 53.1% (parameter value β=5.1, p>0.0001, N=183 patients). As shown in Section 1.4 an increasing DRS_{dentition} corresponds to increasing mean annual radiographic marginal bone loss (Table 1.9) and increasing mean number of disease progression indicators (Table 1.10) for the dentition, indicating a significantly increased risk of disease progression for patients with a DRS_{dentition}≧0.5 (annual mean bone loss >0.10 mm corresponding to a mean number of disease progression indicators >2).

This assumption is confirmed by a high correlation coefficient (r=0.7, p<0.0001, N=107 patients) for DRS_{dentition}≧0.5 to the outcome variable number of disease progression indicators for the dentition as a whole as well as significant parameter estimates for DRS_{dentition} intervals ≧0.5, compared to a DRS_{dentition}<0.5 (Table 1.16), and with an explanatory value (R²) of 57.4% (N=183 patients). Thus, a patient with a DRS_{dentition} between 0.5 and 0.6 has, on average, 0.474 more periodontitis progression indicators than a patient with a DRS_{dentition}<0.5. A patient with a DRS_{dentition} of 0.7 or higher has 1.895 more periodontitis progression indicators than a patient with a DRS_{dentition}<0.5. Hence, patients with a DRS_{dentition}≦0.5 appear to be at risk of losing clinically significant attachment. It appears reasonable to assume that a DRS_{dentition}≧0.5 justifies individual tooth by tooth prognostication in DentoRisk™ Level II.

TABLE 1.16
Parameter estimates for different intervals of DRS_{dentition} ≧ 0.5,
compared to a DRS_{dentition} < 0.5.

| DRS_{dentition} interval | Parameter estimate β | p-value |
|---|---|---|
| 0.5 ≦ DRS_{dentition} < 0.6 | 0.474 | 0.0005 |
| 0.6 ≦ DRS_{dentition} < 0.7 | 1.378 | <.0001 |
| DRS_{dentition} ≧ 0.7 | 1.895 | <.0001 |

Correlation of Variables and Scores from DentoRisk™ Level II (Individual Teeth) to the Outcome Variables

Multivariate linear regression analysis resulted in an explanatory value R² of 71.6% (N=459 teeth) regardless of outcome in DentoRisk™ Level 1 and 77.0% (N=265 teeth) for the subgroup of teeth from patients with a DRS_{dentition}≧0.5 when correlating all variables in DentoRisk™ Level II to the outcome variable number of disease progression indicators. Explanatory values (R²) of 84.6% (N=169 teeth) and 84.9% (N=137 teeth) was found for the subgroups of teeth with a DRSₜₒₒₜₕ≧0.2 from all patients and patients with a DRS_{dentition}≧0.5, respectively, when correlating all variables in DentoRisk™ Level II to the outcome variable number of disease progression indicators. This sub-grouping is based on teeth with a DRSₜₒₒₜₕ≧0.2 corresponding to a mean annual radiographic bone loss >0.10 mm (Table 1.12) and a mean annual number of disease progression indicators of ≧0.96 (Table 1.13), indicative of chronic periodontitis progression as identified in Section 1.4 and concluded in the discussion below.

Simple linear regression to estimate a regression model over the entire DRSₜₒₒₜₕ interval for the subgroup of teeth in patients with a DRS_{dentition}≧0.5 yielded an explanatory value (R²) of 46.8% with a statistically significant parameter estimate (N=1408 teeth, parameter estimate β of 3.43, p-value of <0.0001). Table 1.17 presents estimates and significance levels for the relevant DRSₜₒₒₜₕ intervals ≧0.2 based on the subgroup of teeth from patients with DRS_{dentition}≧0.5, compared to the DRSₜₒₒₜₕ interval <0.2, with an overall explanatory value (R²) of 46.7% (N=1408 teeth). A DRSₜₒₒₜₕ≧0.2 from appears to indicate an elevated risk of future loss of periodontal attachment tooth by tooth (>0.10 mm radiographic bone loss or >1 disease progression indicator).

TABLE 1.17
Estimates and significance levels for DRSₜₒₒₜₕ intervals ≧0.2
based on the subgroup of teeth from patients with a DRS_{dentition} ≧ 0.5,
compared to the DRSₜₒₒₜₕ interval <0.2.

| DRSₜₒₒₜₕ interval | Parameter estimate β | p-value |
|---|---|---|
| 0.2 ≦ DRSₜₒₒₜₕ < 0.3 | 0.08 | 0.0174 |
| 0.3 ≦ DRSₜₒₒₜₕ < 0.4 | 0.67 | <0.0001 |
| 0.4 ≦ DRSₜₒₒₜₕ < 0.5 | 1.16 | <0.0001 |
| DRSₜₒₒₜₕ ≧ 0.5 | 1.42 | <0.0001 |

### Stepwise Regression Analysis of Variables in DentoRisk™ Level II

To establish which variables are of greatest importance in terms of explaining the outcome variables and DentoRisk™ score outcome, stepwise selection of variables to include in a multivariate regression model can be used. Stepwise selection is a method that drops or adds variables into the model at various steps. The process is one of alternation between choosing the least significant variable to drop and then re-considering all dropped variables (excluding the most recently dropped) for re-introduction into the model. Algorithms supplied by SAS Institute Inc. (Cary, N.C., USA) were used for this analysis.

Table 1.18 shows the results of a stepwise regression analysis of variables for teeth, with radiographic marginal bone loss over time as an outcome variable regardless of outcome in DentoRisk™ Levels I and II. The variables in Table 1.18 together explain 39.8% of the variation in the outcome variable.

TABLE 1.18
Parameter estimate β, standard error (SE) significance level
(p) and explanatory value (R²) for the stepwise selection of
variables included in the multivariate regression model regardless
of outcome in DentoRisk ™ Levels I and II (N = 456 teeth).

| Variable | β | SE | p | R² (%) |
|---|---|---|---|---|
| Radiographic marginal bone loss at | 0.175 | 0.019 | <0.0001 | 34.35 |
| baseline | | | | |
| Patient disease awareness and | 0.155 | 0.045 | 0.0005 | 36.19 |
| interest | | | | |
| Pocket depth at baseline | 0.199 | 0.027 | <0.0001 | 37.89 |
| Age | −0.006 | 0.003 | 0.0367 | 38.54 |
| Increased mobility at baseline | −0.219 | 0.098 | 0.0267 | 39.06 |
| Stopped smoking less than | −0.253 | 0.145 | 0.0813 | 39.44 |
| 5 years ago | | | | |
| Smoking 10-20 cigarettes per day | −0.115 | 0.068 | 0.0918 | 39.83 |

Outcome variable: radiographic marginal bone loss over time.

Table 1.19 shows the results of a stepwise regression analysis of variables for teeth, with radiographic marginal bone loss over time as outcome variable and selected according to the indicated optimal use of the algorithm described above: that is, selection of patients with a DRS_{dentition}≧0.5 and teeth with a DRSₜₒₒₜₕ≧0.2, indicating an elevated risk of future loss of periodontal attachment tooth by tooth. The variables in Table 1.19 together explain 36.4% of the variation in the outcome variable.

TABLE 1.19
Parameter estimate β, standard error (SE) significance level
(p) and explanatory value (R²) for the stepwise selection of
variables included in the multivariate regression model for teeth
from patients with a DRS_{dentition} ≧ 0.5, and in those
patients only teeth with a DRSₜₒₒₜₕ ≧ 0.2 (N = 137 teeth).

| Variable | β | SE | p | R² (%) |
|---|---|---|---|---|
| Radiographic marginal bone loss at | 0.195 | 0.034 | <0.0001 | 30.49 |
| baseline | | | | |
| Pocket depth at baseline | 0.173 | 0.052 | 0.0011 | 34.80 |
| Increased mobility at baseline | −0.292 | 0.158 | 0.0665 | 36.44 |

Outcome variable: radiographic marginal bone loss over time.

Table 1.20 shows the results of a stepwise regression analysis of variables for teeth, with periodontitis progression indicators as an outcome variable (radiographic marginal bone loss over time, development of furcation involvement and angular bony destruction in combination) regardless of outcome in DentoRisk™ Levels I and II. The variables in Table 1.20 together explain 71.0% of the variation in the outcome variable.

TABLE 1.20
Parameter estimate β, standard error (SE) significance level
(p) and explanatory value (R²) for the stepwise selection of
variables included in the multivariate regression model regardless
of outcome in DentoRisk ™ Levels I and II (N = 459 teeth).

| Variable | β | SE | p | R² (%) |
|---|---|---|---|---|
| Radiographic marginal bone level | 0.571 | 0.039 | <0.0001 | 36.09 |
| at baseline | | | | |
| Angular bony destruction at | 0.889 | 0.068 | <0.0001 | 54.52 |
| baseline | | | | |
| Furcation involvement >2 mm at | 0.940 | 0.087 | <0.0001 | 62.64 |
| baseline | | | | |
| Furcation involvement ≦2 mm at | 0.880 | 0.098 | <0.0001 | 68.61 |
| baseline | | | | |
| Proximal restoration extending | 0.116 | 0.052 | 0.0014 | 69.19 |
| into root | | | | |
| Smoking >20 cigarettes per day | 0.348 | 0.115 | 0.0027 | 69.67 |
| Increased mobility at baseline | −0.197 | 0.091 | 0.0311 | 70.04 |
| Patient disease awareness and | 0.120 | 0.045 | 0.0081 | 70.31 |
| interest | | | | |
| Smoking 10-20 cigarettes per day | 0.128 | 0.067 | 0.0551 | 70.56 |
| Stopped smoking less than 5 years | −0.279 | 0.139 | 0.0462 | 70.76 |
| ago | | | | |
| Proximal plaque | 0.067 | 0.039 | 0.0880 | 70.95 |

Outcome variable: radiographic marginal bone loss over time, development of furcation involvement and angular bony destruction in combination.

Table 1.21 shows the results of a stepwise regression analysis of variables for teeth, with periodontitis progression indicators as an outcome variable (radiographic marginal bone loss over time, development of furcation involvement and angular bony destruction in combination) and selected according to the indicated optimal use of the algorithm described above: that is, selection of patients with a DRS_{dentition}≧0.5 and teeth with a DRSₜₒₒₜₕ≧0.2, indicating an elevated risk of future loss of periodontal attachment tooth by tooth. The variables in Table 1.21 together explain 83.5% of the variation in the outcome variable.

TABLE 1.21
Parameter estimate β, standard error (SE), significance level
(p), and explanatory value (R²) for the stepwise selection of
variables included in the multivariate regression model for
teeth from patients with a DRS_{dentition} ≧ 0.5, and in those
patients only teeth with a DRSₜₒₒₜₕ ≧ 0.2 (N = 137 teeth).

| Variable | β | SE | p | R² (%) |
|---|---|---|---|---|
| Furcation involvement >2 mm at | 0.949 | 0.082 | <0.0001 | 29.52 |
| baseline | | | | |
| Angular bony destruction at | 0.962 | 0.068 | <0.0001 | 51.47 |
| baseline | | | | |
| Furcation involvement ≦2 mm at | 0.893 | 0.935 | <0.0001 | 65.01 |
| baseline | | | | |
| Radiographic marginal bone loss | 0.318 | 0.047 | <0.0001 | 76.81 |
| at baseline | | | | |
| Smoking >20 cigarettes per day | 0.412 | 0.128 | <0.0001 | 78.10 |
| Increased mobility at baseline | −0.996 | 0.094 | <0.0001 | 79.46 |
| Age in relation to history of | 0.017 | 0.004 | 0.0001 | 81.63 |
| chronic periodontitis | | | | |
| Therapist's experience from | 0.177 | 0.077 | 0.0232 | 82.50 |
| periodontal care | | | | |
| Combination of negative stress | 0.267 | 0.126 | 0.0353 | 83.00 |
| and economic problems | | | | |
| Smoking 10-20 cigarettes per day | 0.138 | 0.073 | 0.0615 | 83.47 |

Outcome variable: radiographic marginal bone loss over time, development of furcation involvement and angular bony destruction in combination.

Table 1.22 shows the results of a stepwise regression analysis of variables for teeth, with DRSₜₒₒₜₕ as an outcome variable regardless of outcome in DentoRisk™ Levels I and II. The variables in Table 1.22 together explain 97.3% of the variation in the outcome variable.

TABLE 1.22
Parameter estimate β, standard error (SE) significance level
(p) and explanatory value (R²) for the stepwise selection of variables
included in the multivariate regression model regardless of outcome
in DentoRisk ™ Levels I and II (N = 73 teeth).

| Variable | β | SE | p | R² (%) |
|---|---|---|---|---|
| Angular bony destruction at | 0.241 | 0.004 | <0.0001 | 54.10 |
| baseline | | | | |
| Furcation involvement >2 mm at | 0.242 | 0.005 | <0.0001 | 79.19 |
| baseline | | | | |
| Furcation involvement ≦2 mm at | 0.138 | 0.006 | <0.0001 | 85.80 |
| baseline | | | | |
| Radiographic marginal bone level | 0.014 | 0.001 | <0.0001 | 90.17 |
| at baseline | | | | |
| Bleeding on probing at baseline | 0.017 | 0.002 | <0.0001 | 92.21 |
| Negative stress or economic | 0.045 | 0.003 | <0.0001 | 93.73 |
| problems | | | | |
| Combination of negative stress | 0.056 | 0.008 | <0.0001 | 94.92 |
| and economic problems | | | | |
| Proximal plaque at baseline | 0.027 | 0.002 | <0.0001 | 95.75 |
| Negative results from DentoTest ™ | 0.010 | 0.001 | <0.0001 | 96.61 |
| at baseline | | | | |
| Smoking 10-20 cigarettes per day | 0.023 | 0.004 | <0.0001 | 96.77 |
| Smoking >20 cigarettes per day | 0.041 | 0.008 | <0.0001 | 96.92 |
| Pocket depth at baseline | 0.006 | 0.002 | <0.0001 | 97.03 |
| Patient disease awareness and | −0.012 | 0.003 | <0.0001 | 97.15 |
| interest | | | | |
| Endodontic pathology at baseline | 0.021 | 0.007 | 0.0048 | 97.20 |
| Smoking <10 cigarettes per day | 0.006 | 0.003 | 0.0600 | 97.22 |
| Increased mobility at baseline | 0.010 | 0.005 | 0.0667 | 97.24 |
| Stopped smoking less than | 0.014 | 0.008 | 0.0901 | 97.26 |
| 5 years ago | | | | |

Outcome variable: DRSₜₒₒₜₕ.

Table 1.23 shows the results of a stepwise regression analysis of variables for teeth, with DRSₜₒₒₜₕ as outcome variable selected according to the indicated optimal use of the algorithm described above: that is, selection of patients with a DRS_{dentition}≧0.5 and teeth with a DRSₜₒₒₜₕ≧0.2, indicating an elevated risk of future loss of periodontal attachment tooth by tooth. The variables in Table 1.23 together explain 98.1% of the variation in the outcome variable.

TABLE 1.23
Parameter estimate β, standard error (SE), significance level
(p), and explanatory value (R²) for the stepwise selection of
variables included in the multivariate regression model for
teeth from patients with a DRS_{dentition} ≧ 0.5, and in those
patients only teeth with a DRSₜₒₒₜₕ ≧ 0.2 (N = 142 teeth).

| Variable | β | SE | p | R² (%) |
|---|---|---|---|---|
| Angular bony destruction at | 0.231 | 0.004 | <0.0001 | 50.12 |
| baseline | | | | |
| Furcation involvement >2 mm at | 0.234 | 0.005 | <0.0001 | 86.16 |
| baseline | | | | |
| Furcation involvement ≦2 mm at | 0.120 | 0.006 | <0.0001 | 91.80 |
| baseline | | | | |
| Radiographic marginal bone level | 0.012 | 0.001 | <0.0001 | 93.16 |
| at baseline | | | | |
| Proximal plaque at baseline | 0.024 | 0.004 | <0.0001 | 94.40 |
| Combination of negative stress | 0.057 | 0.008 | <0.0001 | 95.30 |
| and economic problems | | | | |
| Negative stress or economic | 0.038 | 0.004 | <0.0001 | 96.58 |
| problems | | | | |
| Negative results from | 0.008 | 0.002 | <0.0001 | 97.25 |
| DentoTest ™ at baseline | | | | |
| Bleeding on probing at baseline | 0.023 | 0.005 | <0.0001 | 97.69 |
| Smoking >20 cigarettes per day | 0.033 | 0.008 | <0.0001 | 97.89 |
| Endodontic pathology at baseline | 0.024 | 0.008 | 0.0048 | 97.98 |
| Smoking 10-20 cigarettes per day | 0.012 | 0.005 | 0.0149 | 98.07 |
| Age in relation to history of | 0.001 | 0.000 | 0.0625 | 98.12 |
| chronic periodontitis | | | | |

Outcome variable: DRSₜₒₒₜₕ.

### Discussion

Linear regression was used to investigate the relationship between a numerical outcome variable (number of disease progression indicators) and explanatory variables (risk predictors). Multivariate linear regression is the extension of simple linear regression used when more than one explanatory variable is suspected to affect the outcome variable. Multivariate linear regression tells us how much a one unit increase in each explanatory variable (risk predictor) affects progression of chronic periodontitis, assuming that all other variables are constant. The relationship between such variables can be modeled using regression or so-called ordinary least squares regression. As a supplement to the parameter value β, the regression coefficient or explanatory value (R²) is presented. The regression coefficient is a value that ranges from zero to one (1-100%) and tells us how much of the variation in the outcome variable that is explained by variation of the explanatory variables or “shared” by the variables.

Progression of chronic periodontitis expressed both as radiographic marginal bone loss and increase in periodontitis progression indicators increased with both increasing DRS_{dentition} and DRSₜₒₒₜₕ. The correlation was found to be strong and significant with both high explanatory values (R²) as well as significant and increasing parameter estimates β, indicating that DRS_{dentition} and DRSₜₒₒₜₕ may provide a reliable estimate of future disease progression.

The analyses furthermore enabled identification of two important DentoRisk™ threshold scores. DRS_{dentition}≧0.5 corresponding to an annual radiographic bone loss in excess of 0.10 mm correlated significantly to the outcome variable, number of disease progression indicators (r=0.7, p<0.0001, N=107 patients). Similarly, a high explanatory value (R²) followed (57.4%), with significant and increasing parameter estimates β with an increasing DRS_{dentition}. Hence, it may be concluded that patients with a DRS_{dentition}≧0.5 are at risk of losing significantly more periodontal attachment (>0.10 mm radiographic bone loss or >2 disease indicators) than in an average population. Analysis of teeth from this sub-group of patients showed that teeth with a DRSₜₒₒₜₕ≧0.2 showed a mean annual radiographic bone loss >0.10 mm corresponding to a mean annual number of disease progression indicators of ≧0.96 indicative of chronic periodontitis, and accompanied by a high explanatory value (R²=46.7%) as well as significant and increasing parameter estimates β with an increasing DRSₜₒₒₜₕ.

The average annual bone loss both for patients and teeth showing a DRS_{dentition}≧0.5 and DRSₜₒₒₜₕ≧0.2, respectively, should be compared with results of epidemiological studies on periodontal health irrespective of ethnic background (Löe et al 1978, Laystedt et al 1986, Papapanou et al 1989). An annual loss of attachment up to 0.10 mm has been reported to be representative of a non-periodontitis prone group of patients. Attachment loss above 0.10 mm may consequently be indicative of chronic periodontitis, with increasing severity as annual attachment loss increases.

Thus, detailed analysis tooth by tooth for patients with a DRS_{dentition}≧0.5 appear justified, while patients with a DRS_{dentition}<0.5 appear to benefit very little from any further detailed analysis. Selection of patients with a DRS_{dentition}≧0.5 for further analysis with DentoRisk™ Level II confirmed this assumption since the explanatory value for DentoRisk™ Level II increased compared to regression over the entire spectrum of DRSₜₒₒₜₕ, regardless of outcome in DentoRisk™ Level I. Using this approach, multivariate regression analysis showed explanatory values (R²) in excess of 80% for Level II indicating that a sufficient number of relevant variables from different categories to predict progression of chronic periodontitis have been included in the DentoRisk™ algorithm.

Stepwise regression analyses gave approximately 10% lower explanatory values for some 10 different significant risk predictors compared to multivariate regression analysis for DentoRisk™ Level II with radiographic marginal bone loss over time as outcome variable. This could imply that the remaining predictors play a negligible role in explaining the variation in the outcome variable. However, the fact that there may be insufficient data for some of the predictors is a more likely explanation for the lack of significance. Nevertheless, although lacking significance in the stepwise regression analysis, it may be argued that these predictors should not be excluded from the algorithm since they may be relevant to a smaller selection of patients and, perhaps more importantly, increase the robustness of the algorithm when data for a specific patient is missing. The latter is made possible since several of the predictors present overlapping registrations.

Another important consideration is dependency between teeth within the same individual. This may be argued to dramatically increase explanatory values in the stepwise regression analysis. However, this outcome by variable most likely reflects disease progression more accurately thereby identifying additional significant variables in the stepwise regression analysis. Although dependency between variables contribute to increased explanatory values, it seems likely that the balanced weights and selection of clinical variables (risk predictors) in the DentoRisk™ algorithm represents a refinement as seen from the further increase in significant clinical variables thereby increasing explanatory values (Tables 1.22 and 1.23). To somewhat compensate for the dependency between teeth within the same individual, variables on patient level (e.g. age, genetic aspects, socio-economic predictors, smoking habits, etc.) are included in the DentoRisk™ algorithm also at tooth level. However, no formal multi-level analysis techniques have been used.

In summary, the analyses in this section have established that the variables included in the DentoRisk™ algorithm are sufficient in number and reflect a balanced selection of risk predictors from the different risk categories: primary etiological risk predictors, local and systemic modifying risk predictors, and host predictors. Furthermore, sufficiently high explanatory values with significant and increasing parameter estimates β with increasing DentoRisk™ scores justify selection based on outcome in DentoRisk™ Level I for detailed analysis tooth by tooth in DentoRisk™ Level II. The analyses thus enabled identification of two important DentoRisk™ threshold scores above which significant progression of chronic periodontitis were found:
A DRS_{dentition}≧0.5 (whole dentition) corresponding to an annual radiographic bone loss in excess of 0.10 mm and approximately two disease progression indicators
A DRSₜₒₒₜₕ≧0.2 (tooth by tooth) corresponding to a mean annual radiographic bone loss in excess of 0.10 mm and approximately one disease progression indicator

### Section 1.6 Quality Characteristics of the DentoRisk™ Algorithm

### Introduction

Etiological and disease modifying risk predictors were reviewed in Section 1.2 and the relative impact of each predictor on chronic periodontitis risk was ranked. This formed the basis for constructing the DentoRisk™ algorithm described in detail in Section 1.3 together with a plan for its validation. An independent validation sample was generated for this purpose as described in Section 1.4.

Results from the first step in the validation plan established that the variables included in the DentoRisk™ algorithm are sufficient in number and reflect a balanced selection of risk predictors from the different risk categories: primary etiological risk predictors, local and systemic modifying risk predictors, and host predictors. Furthermore, sufficiently high explanatory values justify that assessment in DentoRisk™ Level I may serve to select patients at risk for detailed prognostication tooth by tooth in DentoRisk™ Level II. Two important DentoRisk™ threshold scores (DRS_{dentition}≧0.5 and DRSₜₒₒₜₕ≧0.2) were identified above which significant progression of chronic periodontitis was found (annual radiographic bone loss in excess of 0.10 mm for both levels of DentoRisk™ and two and one disease progression indicators for DentoRisk™ Level I and Level II, respectively).

With increasing DentoRisk™ scores follows a significant increase in disease progression indicators over time. In this section the results of the second step in the validation plan are presented. The aim of this step is to calculate relevant quality characteristics for the DentoSystem algorithm in DentoRisk™ Levels I and II. Hence, the definitions in Table 1.24 form the basis for calculations of accuracy, sensitivity, specificity, Positive Predictive Value (PPV) and Negative Predictive Value (NPV) as defined in Table 1.25.

TABLE 1.24
Definitions which formed the basis for further calculation
of accuracy, sensitivity, specificity, PPV and NPV
of the DentoSystem algorithm in DentoRisk ™.

| | No. of disease | No. of disease |
|---|---|---|
| | progression | progression |
| | indicators ≧ 2 | indicators < 2 |
| DRS_{dentition} ≧ 0.5 | True positive | False positive |
| DRS_{dentition} < 0.5 | False negative | True negative |
| | No. of disease | No. of disease |
| | progression | progression |
| | indicators ≧ 1 | indicators < 1 |
| DRSₜₒₒₜₕ ≧ 0.2 | True positive | False positive |
| DRSₜₒₒₜₕ < 0.2 | False negative | True negative |

TABLE 1.25
Formulas for calculation and relationships between accuracy, sensitivity,
specificity, PPV and NPV.

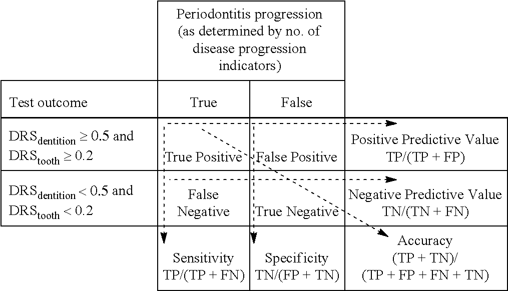

The current section describes the analyses and results from the second step in the validation plan, that is, calculation of clinically relevant quality characteristics for chronic periodontitis risk assessment relevant to the dentition in DentoRisk™ Level I, and prognosis of chronic periodontis progression tooth by tooth in DentoRisk™ Level II.

### Risk Assessment Characteristics for DentoRisk™ Level I

Risk assessment characteristics for DentoRisk™ Level I (accuracy, sensitivity, specificity, PPV and NPV) are presented in Table 1.26. In addition, a ROC-curve (Receiver Operating Characteristic curve) was established based on these calculations (FIG. 1.8).

TABLE 1.26
Accuracy, sensitivity, specificity, PPV and NPV based on calculations
including all patients in the validation sample (N = 183 patients).

| DRS_{dentition} interval | Accuracy | Sensitivity | Specificity | PPV | NPV |
|---|---|---|---|---|---|
| DRS_{dentition} < 0.5 | 79% | 86% | 71% | 76% | 83% |
| (disease | | | | | |
| indicators < 2) | | | | | |
| DRS_{dentition} ≧ 0.5 | | | | | |
| (disease | | | | | |
| indicators ≧ 2) | | | | | |

FIG. 1.8 is a ROC-curve (rate of true positive (TP) results vs. rate of false positive (FP) results) for DentoRisk™ Level I based on calculations including all patients in the investigational material (N=183 patients, •=cutoff values in DentoRisk Level I).

### Prognostic Characteristics for DentoRisk™ Level II

Prognostic properties for DentoRisk™ Level II include calculations of its accuracy, sensitivity, specificity, PPV and NPV. The calculations were performed for two sets of data:
1. All teeth in the clinical trial material (N=2485 teeth) regardless of outcome of assessment with DentoRisk™ Level I (Table 1.27)
2. Only the subgroup of teeth (N=1408 teeth) in patients which presented with a DRS_{dentition}≧0.5 (Table 1.28)
   The latter is in accordance with the intended use of risk assessment and prognostication with DentoRisk™ as defined in Section 1.5.

TABLE 1.27
Accuracy, sensitivity, specificity, PPV and NPV for DentoRisk ™ Level
II based on calculations including all teeth in the clinical
trial material (N = 2485 teeth) regardless of outcome
in the DentoRisk ™ Level I analysis.

| DRSₜₒₒₜₕ interval | Accuracy | Sensitivity | Specificity | PPV | NPV |
|---|---|---|---|---|---|
| DRSₜₒₒₜₕ < 0.2 | 63% | 50% | 77% | 71% | 58% |
| (disease | | | | | |
| indicators < 1) | | | | | |
| DRSₜₒₒₜₕ ≧ 0.2 | | | | | |
| (disease | | | | | |
| indicators ≧ 1) | | | | | |

TABLE 1.28
Accuracy, sensitivity, specificity, PPV and NPV for DentoRisk ™ Level
II based on calculations including only the subgroup of teeth in patients
which presented with a DRS_{dentition} ≧ 0.5 (N = 1408 teeth)
in accordance with the intended use of risk assessment and prognostication
with DentoRisk ™ as defined in Section 1.5.

| DRSₜₒₒₜₕ interval | Accuracy | Sensitivity | Specificity | PPV | NPV |
|---|---|---|---|---|---|
| DRSₜₒₒₜₕ < 0.2 | 65% | 66% | 64% | 73% | 55% |
| (disease | | | | | |
| indicators < 1) | | | | | |
| DRSₜₒₒₜₕ ≧ 0.2 | | | | | |
| (disease | | | | | |
| indicators ≧ 1) | | | | | |

It must be emphasized that the quality characteristics above (accuracy, sensitivity, specificity, PPV and NPV), and in particular PPV and NPV, must be viewed in relation to epidemiological data within the validation sample, such as prevalence. Distribution data from the clinical trial material show that the proportions of patients and teeth found to have a clinically significant risk of disease progression as indicated by their DentoRisk™ scores from Levels I & II (DRS_{dentition}≧0.5 and DRSₜₒₒₜₕ≧0.2, respectively) are approximately 58% and 37% (Table 1.29 and 1.30, respectively). As shown earlier, both annual bone loss and number of disease progression indicators increase significantly with increasing DentoRisk™ scores, indicating that teeth with a disease progression rate indicative of severe chronic periodontitis (mean annual bone loss >0.2 mm and mean number of disease progression indicators >1.7) are associated with a DRSₜₒₒₜₕ≧0.4. Approximately 10% of the teeth are found in this stratum (DRSₜₒₒₜₕ≧0.4).

TABLE 1.29
Distribution data of the clinical validation sample stratified
according to DRS_{dentition} intervals.

| | Mean annual | | | | Mean no. of | | | |
|---|---|---|---|---|---|---|---|---|
| | marginal bone | | | | disease | | N | |
| | loss (MBL) in | | | Preva- | progression | | (pa- | Preva- |
| DRS_{dentition} | mm | SD | N | lence | indicators | SD | tients) | lence |
| DRS_{dentition} < 0.5 | 0.05 | 0.07 | 75 | (41.7%) | 0.82 | 0.71 | 76 | (41.5%) |
| DRS_{dentition} ≧ 0.5 | 0.11 | 0.15 | 105 | 58.3% | 2.06 | 0.88 | 107 | 58.5% |

TABLE 1.30
Distribution data of the clinical validation sample stratified according to DRSₜₒₒₜₕ
intervals.

| | Mean annual | | | | Mean no. of | | | |
|---|---|---|---|---|---|---|---|---|
| | marginal bone | | | | disease | | | |
| | loss (MBL) in | | | | progression | | N | |
| DRSₜₒₒₜₕ | mm | SD | N | Prevalence | indicators | SD | (teeth) | Prevalence |
| DRSₜₒₒₜₕ < 0.2 | 0.06 | 0.10 | 1401 | (63.6%) | 0.42 | 0.49 | 1554 | (62.52%) |
| 0.2 ≦ DRSₜₒₒₜₕ < 0.3 | 0.12 | 0.19 | 499 | 22.6% | 0.53 | 0.51 | 539 | 21.7% |
| 0.3 ≦ DRSₜₒₒₜₕ < 0.5 | 0.17 | 0.25 | 221 | 10.0% | 1.41 | 0.60 | 275 | 11.1% |
| DRSₜₒₒₜₕ ≧ 0.5 | 0.27 | 1.34 | 83 | 3.8% | 1.86 | 0.72 | 117 | 4.7% |

### Discussion

Sensitivity, specificity and other quality characteristics of a test depend on more than just the “quality” of the test. They also depend on the definition of what constitutes an abnormal test result. Hence, based on the results of analyses in Section 1.5, threshold values for disease were established prior to calculation of quality characteristics of the DentoRisk™ algorithm. Subsequent calculations resulted in overall balanced quality characteristics for both DentoRisk™ Levels I and II.

When interpreting the calculated quality figures it must be emphasized that a result of 100% cannot be expected for all quality characteristics simultaneously. For example. any increase in sensitivity will inevitably be accompanied by a decrease in specificity. Hence the ROC curve resulting from the calculation of quality characteristics for DentoRisk™ Level I demonstrates that the selection of patients for further prognostic assessment of periodontitis progression tooth by tooth in DentoRisk™ Level II is close to ideal. The curve is a plot of the true positive rate against the false positive rate for the different possible cut-off points of a test. Accuracy, which is a measure of how well the test separates the group being tested into those with and without disease progression, is measured by the area under the ROC curve and should be as large as possible.

Furthermore, it was demonstrated that the quality characteristics for prognostication of chronic periodontitis in DentoRisk™ Level II depends on an accurate selection in Level I. It appears that selection of patients based on DRS_{dentition}≧0.5 for further analysis tooth by tooth in DentoRisk™ Level II, rather than no selection at all, is a necessary step for reducing the proportion of false negative results as demonstrated by an increase in sensitivity from 50% to 66% in Level II, thus minimizing superfluous analyses. For DentoRisk™ Level II, the quality characteristics came out somewhat lower than for DentoRisk™ Level I, although well within acceptable limits. However, as will be discussed in Section 1.7, DRSₜₒₒₜₕ≧0.2 reflects a spectrum of disease progression rates of which only DRSₜₒₒₜₕ above 0.3 appear to be correlated to any clinically significant progression rate. Hence, it may be argued that a DRSₜₒₒₜₕ threshold of 0.2 may be too low. However, raising the level to 0.3 will inevitably result in an increase in false negative results. Furthermore, when interpreting the calculated quality figures upon which treatment decisions will be based it must be emphasized that prevalence of chronic periodontitis in the validation sample may significantly reduce or enhance the clinical value of these figures. In the present validation sample, the clinical value of the Level II assessment, especially for DRSₜₒₒₜₕ above 0.3, is greatly enhanced by a relatively low prevalence (Table 1.30).

In this section, it was established that DentoRisk™ Level I analysis presents reliable quality characteristics for risk assessment, that is, for selection of patients for detailed prognostication tooth by tooth in DentoRisk™ Level II. Selection of patients in DentoRisk™ Level I was shown to be a necessary step for reducing the proportion of false negative results in DentoRisk™ Level II. Subsequently, prognostication of chronic periodontitis tooth by tooth in DentoRisk™ Level II was found to be accompanied by clinically relevant quality characteristics in relation to the prevalence of chronic periodontitis in the validation sample.

### Section 1.7 Clinical Relevance of the DentoRisk™ Level II Scores

### Introduction

The DentoRisk™ algorithm for periodontitis risk assessment and prognostication is based on a balanced ranking of etiological and disease modifying risk predictors (Section 1.2 and 1.3). Results from the first step of a clinical validation plan (Section 1.5) for the DentoRisk™ algorithm established that the variables included in the DentoRisk™ algorithm are sufficient in number and reflect a balanced selection of risk predictors from the different risk categories: primary etiological risk predictors, local and systemic modifying risk predictors, and host predictors. Sufficiently high explanatory values justify that assessment in DentoRisk™ Level I (entire dentition) may serve to select patients at risk for detailed prognostication tooth by tooth in DentoRisk™ Level II.

Two important DentoRisk™ threshold scores (DRS_{dentition}≧0.5 and DRSₜₒₒₜₕ≧0.2) were identified and confirmed in Sections 1.5 and 1.6, respectively, above which significant progression of chronic periodontitis were found (annual radiographic bone loss in excess of 0.10 mm for both levels of DentoRisk™ and two and one disease progression indicators for DentoRisk™ Level I and Level II, respectively).

The analyses in Section 1.6 showed that teeth with a DRSₜₒₒₜₕ≧0.2 was accompanied by clinically relevant quality characteristics. Selection of patients in DentoRisk™ Level I (risk assessment for the dentition) was shown to be a necessary step for reducing the proportion of false negative results in DentoRisk™ Level II (prognostication tooth by tooth).

The aim of the analyses in the current section, which make up the third step in the validation plan, is to determine clinical significance and relevance of prognosticated chronic periodontitis progression tooth by tooth calculated in DentoRisk™ Level II. For this purpose and in order to add prognostic value to DRSₜₒₒₜₕ intervals, logistic regression was used to calculate odds-ratio for the progression of chronic periodontitis and tooth mortality in different DRSₜₒₒₜₕ intervals.

### Odds-Ratio for Increase in Periodontitis Progression Indicators

Tables 1.31 and 1.32 present results from logistic regression of periodontitis progression (number of disease progression indicators) for DRSₜₒₒₜₕ intervals. Logistic regression confirmed an expected significant increase in odds-ratio for disease progression with increasing DRSₜₒₒₜₕ. The increased odds was about 40-fold for teeth with a DRSₜₒₒₜₕ≧0.3 in patients with a DRS_{dentition}≧0.5.

TABLE 1.31
Logistic regression of DRSₜₒₒₜₕ in different intervals as a predictor
of periodontitis progression (DRSₜₒₒₜₕ intervals for tooth by tooth
analysis ≧0.2 compared to <0.2, N = 2485 teeth, odds-ratio OR).

| | | | | Lower | Upper |
|---|---|---|---|---|---|
| DRSₜₒₒₜₕ interval | β | p-value | OR | CL | CL |
| 0.2 ≦ DRSₜₒₒₜₕ < 0.3 | 0.412 | <0.0001 | 1.509 | 1.240 | 1.837 |
| DRSₜₒₒₜₕ ≧ 0.3 | 3.856 | <0.0001 | 47.281 | 25.748 | 86.824 |

TABLE 1.32
Logistic regression of DRSₜₒₒₜₕ in different intervals as a predictor
of periodontitis progression (DRSₜₒₒₜₕ intervals for tooth level ≧0.2
compared to <0.2, N = 1408 teeth, odds-ratio OR) including
only teeth in patients with a DRS_{dentition} ≧ 0.5.

| | | | | Lower | Upper |
|---|---|---|---|---|---|
| DRSₜₒₒₜₕ interval | β | p-value | OR | CL | CL |
| 0.2 ≦ DRSₜₒₒₜₕ < 0.3 | 0.291 | 0.0222 | 1.337 | 1.042 | 1.716 |
| DRSₜₒₒₜₕ ≧ 0.3 | 3.659 | <0.0001 | 38.819 | 20.88 | 72.156 |

### Odds-Ratio for Tooth Mortality

The subset of teeth that were lost (tooth mortality) during the observation period were analyzed with logistic regression. Tooth loss was registered at the end of the study period together with the reasons for the loss, and it was found that chronic periodontitis caused the loss of all of the teeth. Descriptive statistics for the material is presented in the Table 1.15 in Section 1.4.

A higher frequency of tooth loss was found in patients with a DRS_{dentition} above 0.5. Double the number of teeth (44 teeth) with a DRSₜₒₒₜₕ above 0.3 were lost, compared to teeth with a DRSₜₒₒₜₕ below 0.3.

A significantly higher odds-ratio for tooth mortality above a DRSₜₒₒₜₕ of 0.3 was seen, with a 25-fold increase in odds above DRSₜₒₒₜₕ≧0.5 (Tables 33 and 34) showing two separate risk intervals (0.3≦DRSₜₒₒₜₕ<0.5 and DRSₜₒₒₜₕ≧0.5) for tooth mortality. Thus, a DRSₜₒₒₜₕ≧0.5 indicates a higher risk of periodontitis progression than can be expected in the DRSₜₒₒₜₕ interval between 0.3 and 0.5. A DRSₜₒₒₜₕ below 0.3 appears to be associated with a low risk of tooth mortality and consequently a low risk of periodontitis progression.

TABLE 1.33
Odds-ratio (OR) of tooth mortality for different DRSₜₒₒₜₕ
intervals ≧0.2 compared to <0.2 (N = 2928 teeth).

| | | | | Lower | Upper |
|---|---|---|---|---|---|
| DRSₜₒₒₜₕ interval | β | p-value | OR | CL | CL |
| 0.2 ≦ DRSₜₒₒₜₕ < 0.3 | 0.952 | 0.0291 | 2.592 | 1.102 | 6.095 |
| 0.3 ≦ DRSₜₒₒₜₕ < 0.5 | 2.427 | <0.0001 | 11.327 | 5.528 | 23.209 |
| DRSₜₒₒₜₕ ≧ 0.5 | 3.725 | <0.0001 | 41.471 | 20.552 | 83.682 |

TABLE 1.34
Odds-ratio (OR) of tooth mortality for different DRSₜₒₒₜₕ intervals
in different intervals compared to <0.2 for the subgroup of teeth from
patients with a DRS_{dentition} ≧ 0.5 (N = 1712 teeth).

| | | | | Lower | Upper |
|---|---|---|---|---|---|
| DRSₜₒₒₜₕ interval | β | p-value | OR | CL | CL |
| 0.2 ≦ DRSₜₒₒₜₕ < 0.3 | 0.648 | 0.1752 | 1.912 | 0.749 | 4.880 |
| 0.3 ≦ DRSₜₒₒₜₕ < 0.5 | 2.094 | <0.0001 | 8.160 | 3.722 | 17.697 |
| DRSₜₒₒₜₕ ≧ 0.5 | 3.215 | <0.0001 | 24.897 | 11.546 | 53.687 |

Logistic regression thus showed that a DRSₜₒₒₜₕ between 0.3 and 0.5 is significantly associated with an approximate 11-fold increase in tooth mortality, and that a DRSₜₒₒₜₕ≧0.5 showed a 40-fold increase in odds for tooth mortality. A DRSₜₒₒₜₕ below 0.3, although showing an elevated odds-ratio for tooth mortality, indicates a considerably lower risk than a DRSₜₒₒₜₕ in intervals above 0.3. Thus, DRSₜₒₒₜₕ may be subdivided into four strata with an increasing risk of disease progression as seen from the corresponding numbers for mean radiographic bone loss taken from Table 1.12 in Section 1.4 (Table 1.35). Radiographic bone loss below 0.10 mm annually is characteristic of an average adult population while an annual bone loss above 0.10 mm may be regarded as indicative of progressing chronic periodontitis (Löe et al 1978, Laystedt et al 1986, Papapanou et al 1989).

TABLE 1.35
DRSₜₒₒₜₕ distributed between intervals with an increasing risk
of periodontitis progression as seen from the corresponding numbers
for mean annual radiographic marginal bone loss (MBL/yr).

| | Level of risk for periodontitis | |
|---|---|---|
| DRSₜₒₒₜₕ interval | progression | MBL/yr |
| DRSₜₒₒₜₕ < 0.2 | No or negligible risk of periodontitis | 0.06 |
| | progression | |
| 0.2 ≦ DRSₜₒₒₜₕ < 0.3 | Low risk of periodontitis progression | 0.15 |
| 0.3 ≦ DRSₜₒₒₜₕ < 0.5 | Moderate risk of periodontitis | 0.21 |
| | progression | |
| DRSₜₒₒₜₕ ≧ 0.5 | High risk of periodontitis progression | 0.27 |

Distribution data for the DRSₜₒₒₜₕ intervals in Table 1.35 are presented in Table 1.36 with relevant parameter estimates and significance levels in Table 1.37. Approximately 15% of teeth are found in the two moderate to high-risk intervals defined in Table 1.35. The prevalence of high-risk teeth is in accordance with prevalence estimates for severe periodontitis previously reported (Löe et al 1986, Brown & Löe 1994).

TABLE 1.36
Distribution data from the clinical validation sample stratified according to DRSₜₒₒₜₕ
intervals.

| | | | | | Mean no. of | | | |
|---|---|---|---|---|---|---|---|---|
| | Mean annual | | | | disease | | | |
| | marginal bone | | N | | progression | | N | |
| DRSₜₒₒₜₕ | loss (MBL) in mm | SD | (teeth) | Prevalence | indicators | SD | (teeth) | Prevalence |
| DRS < 0.2 | 0.06 | 0.10 | 1401 | (63.6%) | 0.42 | 0.49 | 1554 | (62.52%) |
| 0.2 ≦ DRS < 0.3 | 0.12 | 0.19 | 499 | 22.6% | 0.53 | 0.51 | 539 | 21.7% |
| 0.3 ≦ DRS < 0.5 | 0.17 | 0.25 | 221 | 10.0% | 1.41 | 0.60 | 275 | 11.1% |
| DRS ≧ 0.5 | 0.27 | 1.34 | 83 | 3.8% | 1.86 | 0.72 | 117 | 4.7% |

TABLE 1.37
Estimates and significance levels for the relevant DRSₜₒₒₜₕ intervals ≧0.2
based on the subgroup of teeth from patients with a DRS_{dentition} ≧ 0.5,
compared to the DRSₜₒₒₜₕ interval < 0.2, with an overall
explanatory value (R²) of 46.7% (N = 1408 teeth).

| DRSₜₒₒₜₕ interval | Parameter estimate β | p-value |
|---|---|---|
| 0.2 ≦ DRSₜₒₒₜₕ < 0.3 | 0.08 | 0.0174 |
| 0.3 ≦ DRSₜₒₒₜₕ < 0.4 | 0.67 | <0.0001 |
| 0.4 ≦ DRSₜₒₒₜₕ < 0.5 | 1.16 | <0.0001 |
| DRSₜₒₒₜₕ ≧ 0.5 | 1.42 | <0.0001 |

### Discussion

The two first steps of the validation plan (Sections 1.5 and 1.6) have validated the construction of the DentoRisk™ algorithm and its clinical performance in risk assessment and disease prognostication. The aim of the analyses in the current section which make up the third step in the validation plan is to determine clinical significance and relevance of prognosticated chronic periodontitis progression tooth by tooth calculated in DentoRisk™ Level II. For this purpose and in order to add prognostic value to DRSₜₒₒₜₕ intervals, logistic regression was used to calculate odds-ratio for the progression of chronic periodontitis and tooth mortality in different DRSₜₒₒₜₕ intervals.

It was shown that statistically and clinically significant differences between different DRSₜₒₒₜₕ intervals in DentoRisk™ Level II existed, based on increases in periodontitis progression indicators and increasing odds-ratio for tooth mortality. Logistic regression based on periodontitis progression indicators identified a statistically and clinically significant threshold at DRSₜₒₒₜₕ of 0.3, above which the likelihood of disease progression rose dramatically. As tooth mortality was shown to be more prevalent in the DRSₜₒₒₜₕ intervals above 0.3, this outcome variable was used to investigate if any further differentiation into statistically and clinically significant intervals could be distinguished above a DRSₜₒₒₜₕ of 0.3. Two separate significant risk intervals (0.3≦DRSₜₒₒₜₕ<0.5 and DRSₜₒₒₜₕ≧0.5) were found. A DRSₜₒₒₜₕ≧0.5 indicates a clinically significant risk of periodontitis progression higher than that which can be expected in the DRSₜₒₒₜₕ interval between 0.3 and 0.5, while a DRSₜₒₒₜₕ below 0.3 appears to be associated with a low risk of periodontitis progression.

In summary, three DRSₜₒₒₜₕ intervals representing distinctly different and increasing levels of risk for progression of chronic periodontitis were identified: 0.2≦DRSₜₒₒₜₕ<0.3, 0.3≦DRSₜₒₒₜₕ<0.5 and DRSₜₒₒₜₕ≧0.5. These intervals correspond to increasing levels of annual marginal bone loss, all of which are significantly correlated to the DRSₜₒₒₜₕ. Thus, clinically relevant information can be correlated to the three different DRSₜₒₒₜₕ intervals, adding a temporal dimension to risk assessment with DentoRisk™ and enabling prognostication of disease development tooth by tooth.

### Section 1.8 Analysis of Selected Risk Predictors (DentoTest™ Results, Smoking, Abutment Teeth, Endodontic Pathology, Furcation Involvement, Angular Bony Destruction) in DentoRisk™

### Introduction

In Sections 1.5 and 1.6 it was established that DentoRisk™ Level I (DRS_{dentition}) selects risk patients with satisfactory quality characteristics for detailed prognostication tooth by tooth in DentoRisk™ Level II (DRSₜₒₒₜₕ). Analyses in Section 1.7 demonstrated that prognostication tooth by tooth in DentoRisk™ Level II is accompanied by clinically relevant measures of expected disease progression.

The aim of this section is, firstly, to analyze results from a skin provocation test (DentoTest™) used to assess the patient's inflammatory responsiveness as a risk predictor for chronic periodontitis. Previous studies have shown a decreased reactivity to Lipid A administered through a simple Skin Prick Test in patients with severe chronic periodontitis. Hence, this initial analysis was done to validate previous results (Lindskog et al 1999). Secondly, the contribution of DentoTest™ to the DentoRisk™ model was analyzed and compared to the contribution of smoking, angular bony destruction and furcation involvement, abutment teeth and endodontic pathology, all of which are risk predictors with known strong explanatory values for the development and progression of chronic periodontitis. The rational for including these known predictors in the analyses was to verify congruence between our investigational materials (validation sample) and previous reports.

### DentoTest™

DentoTest™ is a skin provocation test administered as a Skin Prick Test that assesses the individual patient's ability to develop an appropriate chronic inflammatory reaction relevant to the patient's propensity to chronic marginal periodontitis. Patients with severe forms of chronic periodontitis present with varying degrees of impaired inflammatory reactivity (Lindskog et al 1999). A plausible explanation for this finding may relate to proposed differences between the innate immune systems of individuals (Kinnane et al 2007). This variation has most likely a poly-genetic background (Hassell & Harris 1995, Mucci et al 2005); polymorphism of the IL-1 gene being one such genetic aberration that has been shown to be associated with chronic periodontitis. Nevertheless, it has been argued that genetic variation is not a sufficiently strong factor to be singled out as etiological risk factor in chronic periodontitis development (Mucci et al 2005, Huynh-Ba et al 2007, Loos et al. 2005).

The DentoTest™ results as a risk predictor for chronic periodontitis were analyzed in three steps: firstly, to establish the relationship between the skin provocation test result and severity of chronic periodontitis (history of radiographic marginal bone loss) at baseline; secondly, the relationship between DentoTest™ results and progression of chronic periodontitis (radiographic marginal bone loss) over time was investigated; and finally, the contribution from the DentoTest™ results to the DentoRisk™ model was calculated. Results from the three steps above were compared to the influence of smoking, morphological characteristics of past attachment loss (angular bony destruction and furcation involvement), abutment teeth and endodontic pathology, all of which are known strong risk predictors. Descriptive statistics tooth by tooth for the different variables or risk predictors (DentoTest™ results, smoking, angular bony destruction, furcation involvement, abutment teeth and endodontic pathology) are summarized in Table 1.38.

TABLE 1.38
Mean and median past radiographic marginal bone loss (bone
level) at baseline examination (history of chronic periodontitis)
for the dentition (when applicable) and all evaluable teeth
distributed between variable outcomes for DentoTest ™ results,
smoking, angular bony destruction, furcation involvement,
abutment teeth and endodontic pathology.

| | | Median past | Mean past | |
|---|---|---|---|---|
| Variable | N | marginal bone | marginal bone | |
| (risk predictor) | (teeth) | loss (mm) | loss (mm) | SD |
| DentoTest ™ Results | | | | |
| No negative reaction | 447 | 2.55 | 2.97 | 1.46 |
| 1-3 negative reactions | 1873 | 2.60 | 3.24 | 1.83 |
| 1 negative reactions | 467 | 2.55 | 3.11 | 1.57 |
| 2 negative reactions | 434 | 2.55 | 3.06 | 1.78 |
| 3 negative reactions | 972 | 2.75 | 3.38 | 1.95 |
| Smoking | | | | |
| No (patient level) | 126 | 2.80 | 3.15 | 1.38 |
| Yes (patient level) | 56 | 4.31 | 4.35 | 0.8 |
| No (tooth level) | 1699 | 2.40 | 2.83 | 1.54 |
| Yes (tooth level) | 621 | 3.85 | 4.16 | 1.98 |
| <10 cigarettes/day | 342 | 3.93 | 4.03 | 1.83 |
| 10-20 cigarettes/day | 236 | 3.55 | 4.18 | 2.13 |
| >20 cigarettes/day | 43 | 4.60 | 5.09 | 2.04 |
| Abutment Teeth | | | | |
| No | 2226 | 2.60 | 3.12 | 1.72 |
| Yes | 94 | 4.30 | 4.74 | 2.21 |
| Endodontic Pathology | | | | |
| No | 1058 | 2.35 | 2.83 | 1.50 |
| Yes | 23 | 4.35 | 5.03 | 2.30 |
| Angular Bony | | | | |
| Destruction | | | | |
| No | 2068 | 2.50 | 2.97 | 1.55 |
| Yes | 231 | 4.90 | 5.06 | 2.32 |
| Furcation Involvement | | | | |
| No | 692 | 2.55 | 3.13 | 1.74 |
| Yes | 124 | 5.20 | 5.64 | 1.86 |

### Analyses of DentoTest™ Results

The relationship between DentoTest™ results and history of chronic periodontitis (past radiographic marginal bone loss or bone level) at baseline was investigated. Linear regression of DentoTest™ results as a predictor of mean marginal bone level at baseline for the dentition yielded an explanatory value (R²) of 2.6% and a significant (p=0.03) parameter estimate β of 0.22 (N=182 patients). This means that if the number of negative reactions in the skin provocation increases by 1, mean past radiographic marginal bone loss increases by 0.22 mm. Furthermore, 2.6% of the variation in the severity of chronic periodontitis for the dentition as a whole at baseline is explained by the variation in DentoTest™ results. Correspondingly, significant results were also found tooth by tooth.

Table 1.38 shows radiographic marginal bone loss (severity or history of chronic periodontitis at baseline) in patients with positive reactions to all three Lipid A concentrations in the skin provocation test and patients with one or more negative reactions to all the Lipid A concentrations. Correlation between DentoTest™ results and history of radiographic marginal bone loss at baseline was found to be significant both for the dentition as a whole (r=0.144, p=0.05, N=182 patients) and tooth by tooth (r=0.05, p=0.01, N=2320 teeth).

Non-parametric analysis using the Kruskal-Wallis Test demonstrated a significant difference (p=0.0131) in the degree of past radiographic bone loss (severity of chronic periodontitis at baseline) between patients with positive reactions to all three Lipid A concentrations and patients with an increasing number of negative reactions to the Lipid A concentrations (Table 1.38). Thus, an increasing number of negative reactions in DentoTest™ relates to a significantly increased severity of chronic periodontitis, both for the dentition as a whole and tooth by tooth.

The contribution to the DentoRisk™ model of the DentoTest™ results was investigated with radiographic bone loss over time as outcome variable. Linear regression of DentoTest™ results as a predictor of radiographic marginal bone loss over time for the dentition as a whole yielded an explanatory value R²=5.1% and a significant (p=0.04) parameter estimate β of 0.10 (N=84 patients) when analyzing patients with a mean radiographic bone loss over time of ≧0.15 mm/yr, representative of a clinically significant periodontitis prone population. This means that if the number of negative reactions from DentoTest™ increases by 1, the average bone loss over time increases by 0.10 mm. Furthermore, 5.1% of the variation in progression of chronic periodontitis for the dentition as a whole is explained by the variation in the DentoTest™ results.

Correlation between DentoTest™ results and radiographic bone loss over time (periodontitis progression) was found to be significant both for the dentition as a whole (r=0.244, p=0.03, N=84 patients) and tooth by tooth (r=0.137, p=0.02, N=308 teeth). Correlation analysis was performed in two different intervals of radiographic bone loss, <0.15 mm and ≧0.15 for the dentition as a whole and <0.8 mm and ≧0.8 mm for the tooth-by-tooth analysis in accordance with previously established clinically significant progression rate intervals for severe chronic periodontitis (Sections 1.5 through 1.7).

Increase in disease progression indicators was used to calculate the Positive Predictive Value (PPV) of DentoTest™ results as a predictor of disease progression for the dentition as a whole (Table 1.39) as well as tooth by tooth (Table 1.40). The PPV, or precision rate, or post-test probability of disease, is the proportion of patients or teeth with positive test results that show progression of periodontitis.

TABLE 1.39
Definitions which formed the basis for calculation of the
Positive Predictive Value for DentoTest ™ with
respect to periodontitis progression for the entire dentition.

| | No. of disease | No. of disease |
|---|---|---|
| | progression | progression |
| DentoTest ™ results | indicators ≧ 2 | indicators < 2 |
| No Negative Reaction | True positive | False positive |
| 1-3 Negative Reactions | False negative | True negative |

TABLE 1.40
Definitions which formed the basis for calculation of
the Positive Predictive Value for DentoTest ™ with
respect to periodontitis progression tooth by tooth.

| | No. of disease | No. of disease |
|---|---|---|
| | progression | progression |
| DentoTest ™ results | indicators ≧ 1 | indicators < 1 |
| No Negative Reaction | True positive | False positive |
| 1-3 Negative Reactions | False negative | True negative |

Calculation of the PPV for DentoTest™ results for disease progression of the dentition as a whole gave a value of 82%. Calculation of the PPV for the skin provocation test for disease progression tooth by tooth gave a value of 53% for the entire study population. However, the intended use of the analysis in DentoRisk™ Level I is to select patients with an elevated risk of chronic periodontitis for in-depth analysis tooth by tooth in DentoRisk™ Level II as concluded in Sections 1.5 through 1.7 (DRS_{dentition}≧0.5). Applying this restriction to the calculation of the PPV for DentoTest™ results as a predictor of disease progression tooth-by-tooth resulted in an increase in PPV to 62%.

Logistic regression to calculate odds-ratio (OR) for disease progression with tooth mortality as the outcome variable gave a significant result (p=0.03) for the DentoTest™ results as a predictor of tooth mortality. Although significant, the increased odds-ratio was quite modest (OR=1.3).

Thus, DentoTest™ results appear to provide a clinically significant contribution of the predictive qualities of DentoRisk™, in particular in the selection of patients for in-depth risk analysis tooth by tooth in DentoRisk™ Level II. However, DentoTest™ results as a risk predictor appear too weak by themselves and should be assessed together with other risk predictors in DentoRisk™.

### Smoking

Non-parametric testing (Wilcoxson's Rank Sum Test) demonstrated a significant difference (p<0.0001) for history of chronic periodontitis (past radiographic marginal bone loss or bone level at baseline) between patients who were smokers and patients who did not smoke (Table 1.38). Further non-parametric analysis using the Kruskal-Wallis Test demonstrated an equally significant difference (p<0.0001) between smoking and non-smoking patients as well as between patients in different intervals of smoking frequency (Table 1.38).

Correlation between smoking habits and DentoTest™ results was found to be significant both for the dentition as a whole (r=0.203, p=0.006, N=183 patients) and tooth by tooth (r=0.203, p<0.0001, N=2928 teeth). Smoking was related to a significant increase in negative reactions in the skin provocation test.

Thus, increasing cigarette consumption was accompanied by a significantly increased severity of chronic periodontitis both for the dentition as a whole and tooth by tooth. In addition, there was a significant correlation between smoking and DentoTest™ results, indicating that smoking may suppress inflammatory reactivity.

### Abutment Teeth

Non-parametric testing (Wilcoxson's Rank Sum Test) demonstrated a significant difference (p<0.0001) for history of chronic periodontitis (past radiographic marginal bone loss or bone level) between teeth in fixed-bridge constructions and those without any such proximal cervical restorations (Table 1.38).

### Endodontic Pathology

Non-parametric testing (Wilcoxson's Rank Sum Test) demonstrated a significant difference (p<0.0001) for history of chronic periodontitis (past radiographic marginal bone loss or bone level) between teeth with and without endodontic pathology (Table 1.38).

### Angular Bony Destruction

Non-parametric testing (Wilcoxson's Rank Sum Test) demonstrated a significant difference (p<0.0001) for history of chronic periodontitis (past radiographic marginal bone loss or bone level) between teeth with and without angular bony destruction (Table 1.38).

### Furcation Involvement

Non-parametric testing (Wilcoxon's Rank Sum Test) demonstrated a significant difference (p<0.0001) for history of chronic periodontitis (past radiographic marginal bone loss or bone level) between teeth with and without furcation involvement (Table 1.38).

Relationship between Smoking, Abutment Teeth, Endodontic Pathology and Progression of Chronic Periodontitis

Tables 1.41 to 1.44 present results from correlation analysis between smoking, abutment teeth angular bony destruction, furcation involvement, endodontic pathology and progression of chronic periodontitis, with radiographic marginal bone loss and periodontitis progression indicators used as outcome variables. Angular bony destruction and furcation involvement were analyzed only with radiographic marginal bone loss as an outcome variable since these two variables are part of the combined outcome variable (radiographic marginal bone loss, furcation involvement or angular bony destruction or periodontitis progression indicators).

TABLE 1.41
Explanatory values (R²), β parameter estimates and
significance levels for smoking, abutment teeth angular
bony destruction, furcation involvement and endodontic pathology
correlated to periodontitis progression with radiographic
marginal bone loss as outcome variable and analyzed at the
patient level (means for the entire dentition).

| | | | | | Spearman's |
|---|---|---|---|---|---|
| | N | | | | correlation |
| Risk predictor | (patients) | R² (%) | β | p | coefficient |
| Smoking | 180 | 13.0 | | <0.0001 | 0.320 |
| <10 cigarettes/day | | | 0.283 | 0.0016 | |
| 10-20 cigarettes/day | | | 0.389 | 0.0002 | |
| >20 cigarettes/day | | | 0.588 | 0.0085 | |
| Abutment teeth | 180 | 7.0 | 0.305 | <0.0001 | 0.235 |
| Angular bony | 180 | 10.1 | 0.941 | <0.0001 | 0.303 |
| destruction | | | | | |
| Furcation | 135 | 5.2 | 0.380 | 0.0002 | 0.314 |
| involvement | | | | | |
| Endodontic | 91 | 8.1 | 0.707 | 0.0008 | 0.344 |
| pathology | | | | | |

TABLE 1.42
Explanatory values (R²), β parameter estimates and significance
levels for smoking, abutment teeth and endodontic pathology correlated
to periodontitis progression with number of periodontitis progression
indicators as an outcome variable and analyzed at the patient
level (means for the entire dentition).

| | | | | | Spearman's |
|---|---|---|---|---|---|
| | N | | | | correlation |
| Risk predictor | (patients) | R² (%) | β | p | coefficient |
| Smoking | 183 | 11.2 | | <0.0001 | 0.319 |
| <10 cigarettes/day | | | 0.573 | 0.0035 | |
| 10-20 cigarettes/day | | | 0.717 | 0.0019 | |
| >20 cigarettes/day | | | 1.419 | 0.0042 | |
| Abutment teeth | 183 | 8.7 | 0.745 | <0.0001 | 0.293 |
| Endodontic | 93 | 10.9 | 1.928 | <0.0001 | 0.427 |
| pathology | | | | | |

TABLE 1.43
Explanatory values (R²), β parameter estimates and significance
levels for smoking, abutment teeth angular bony destruction,
furcation involvement and endodontic pathology correlated
to periodontitis progression with radiographic bone loss
as outcome variable and analyzed at the tooth level (means
for all teeth in the validation sample).

| | | | | | Spearman's |
|---|---|---|---|---|---|
| | N | | | | correlation |
| Risk predictor | (teeth) | R² (%) | β | p | coefficient |
| Smoking | 2204 | 4.5 | | <0.0001 | 0.170 |
| <10 cigarettes/day | | | 0.245 | | |
| 10-20 cigarettes/day | | | 0.260 | | |
| >20 cigarettes/day | | | 0.614 | | |
| Abutment teeth | 2204 | 1.6 | 0.425 | <0.0001 | 0.147 |
| Angular bony | 2196 | 3.8 | 0.400 | <0.0001 | 0.120 |
| destruction | | | | | |
| Furcation | 771 | 5.6 | 0.446 | <0.0001 | 0.172 |
| involvement | | | | | |
| Endodontic | 1032 | 3.2 | 0.744 | <0.0001 | 0.157 |
| pathology | | | | | |

TABLE 1.44
Explanatory values (R²), β parameter estimates and significance
levels for smoking, abutment teeth and endodontic pathology correlated
to periodontitis progression with number of periodontitis progression
indicators as outcome variable and analyzed at the tooth level
(means for all teeth in the validation sample).

| | | | | | Spearman's |
|---|---|---|---|---|---|
| | N | | | | correlation |
| Risk predictor | (teeth) | R² (%) | β | p | coefficient |
| Smoking | 2485 | 3.4 | | <0.0001 | 0.156 |
| <10 cigarettes/day | | | 0.200 | <0.0001 | |
| 10-20 cigarettes/day | | | 0.217 | <0.0001 | |
| >20 cigarettes/day | | | 0.651 | <0.0001 | |
| Abutment teeth | 2485 | 0.9 | 0.289 | <0.0001 | 0.083 |
| Endodontic | 1140 | 1.6 | 0.464 | <0.0001 | 0.116 |
| pathology | | | | | |

### Odds-Ratio for Smoking, Abutment Teeth and Endodontic Pathology as Predictors of Chronic Periodontitis Progression

Table 1.45 presents results from logistic regression of smoking, abutment teeth and endodontic pathology as predictors of periodontitis progression with number of disease progression indicators (≧1) as an outcome variable, and Table 1.46 presents results from logistic regression of smoking, abutment teeth angular bony destruction, furcation involvement and endodontic pathology as predictors of periodontitis progression with radiographic marginal bone loss as an outcome variable. As could be expected, smoking as well as endodontic pathology and abutment teeth (as infection retaining factors) presented with a significantly increased likelihood for periodontitis progression both with tooth loss and radiographic marginal bone loss as outcome variables.

TABLE 1.45
Logistic regression of smoking, abutment teeth and endodontic pathology as
predictors of periodontitis progression (tooth by tooth analysis with ≧1 compared to <1
disease progression indicator, odds-ratio OR).

| | N | | | | Lower | Upper |
|---|---|---|---|---|---|---|
| Risk predictor | (teeth) | β | p-value | OR | CL | CL |
| Smoking | 2485 | | | | | |
| <10 cigarettes/day | | 0.550 | <0.0001 | 1.732 | 1.376 | 2.181 |
| 10-20 cigarettes/day | | 0.436 | 0.001 | 1.546 | 1.191 | 2.006 |
| >20 cigarettes/day | | 1.975 | <0.0001 | 7.204 | 3.049 | 17.24 |
| Abutment teeth | 2485 | 0.558 | 0.0037 | 1.748 | 1.199 | 2.548 |
| Endodontic pathology | 1140 | 1.195 | 0.0021 | 3.303 | 1.544 | 7.064 |

TABLE 1.46
Logistic regression of smoking, abutment teeth, angular bony destruction,
furcation involvement and endodontic pathology as predictors of periodontitis progression
(tooth by tooth analysis with radiographic marginal bone loss ≧0.1 mm compared to <0.1 mm,
odds-ratio OR).

| | N | | | | Lower | Upper |
|---|---|---|---|---|---|---|
| Risk predictor | (teeth) | β | p-value | OR | CL | CL |
| Smoking | 2204 | | | | | |
| <10 cigarettes/day | | 0.615 | <0.0001 | 1.849 | 1.446 | 2.365 |
| 10-20 cigarettes/day | | 0.450 | 0.0018 | 1.569 | 1.182 | 2.083 |
| >20 cigarettes/day | | 1.771 | <0.0001 | 5.875 | 2.708 | 12.743 |
| Abutment teeth | 2204 | 1.909 | <0.0001 | 6.748 | 3.629 | 12.546 |
| Angular bony destruction | 2196 | 0.605 | <0.0001 | 1.831 | 1.379 | 2.432 |
| Furcation involvement | 771 | 0.769 | 0.0003 | 2.158 | 1.421 | 3.276 |
| Endodontic pathology | 1032 | 2.057 | 0.0011 | 7.825 | 2.279 | 28.866 |

### Discussion

Assessment of the selected risk predictors, based on both the different analyses in this section and the results from the stepwise regression analysis for teeth in patients with a DentoRisk score Level ≧0.5 in Section 1.5 (Tables 1.18-1.23), allows us to rank them in the following order with respect to increasing impact on periodontitis progression: abutment teeth, negative reactions with DentoTest™, endodontic pathology, smoking >20 cigarettes/day, furcation involvement and angular bony destruction with some variations depending on level of analysis (dentition or tooth) and outcome variable. Furthermore, it is evident that the selected predictors also contribute significantly to the history of periodontitis as evidenced by radiographic bone level measurements at baseline (Table 1.38) and accordingly represent strong and clinically significant predictors as previously reported in the literature (discussed for each individual risk predictor below). However, there is evidence to suggest that interactions between these risk predictors may affect the impact of some of them on periodontitis progression. This has previously been demonstrated for endodontic infection and angular bony destruction. In the analysis of DentoTest™ results, an interaction was also evident between smoking and increasing number of negative reactions with DentoTest™. However, since the purpose of risk assessment and prognostication in DentoRisk™ is not to establish causal relationships, any interaction between risk predictors may only serve to strengthen the model in case of missing data.

### DentoTest™

For the most severely affected patients, it was shown that the DentoTest™ results may contribute significant explanatory values in excess of 5% with an increasing number of negative reactions in DentoTest™ accompanied by a significantly increased severity of chronic periodontitis both for the dentition as a whole and tooth by tooth. This confirms earlier findings (Lindskog et al 1999). In addition, there seemed to be a significant correlation between smoking and the DentoTest™ results, probably reflecting the fact that smoking cause immunosuppression (Razani-Boroujerdi et al 2004, Chen et al 2007) and suppresses the inflammatory response (Hedin et al 1981, Apatzidou et al 2005). Furthermore, increasing cigarette consumption was accompanied by a significantly increased severity of chronic periodontitis both for the dentition as a whole and tooth by tooth.

Thus, significant correlations were found between DentoTest™ results and progression of chronic periodontitis both for the dentition as a whole and tooth by tooth. Most importantly, a relatively high explanatory value for an individual risk predictor was established for the DentoTest™ results for the dentition as a whole for patients with clinically significant chronic periodontitis (mean radiographic bone loss ≧0.15 mm/yr). This is of clinical significance since the primary objective of the skin provocation test is to contribute to the selection of patients in DentoRisk™ Level I (dentition as a whole) for detailed tooth-by-tooth analysis in DentoRisk™ Level II.

### Smoking

As reported in many previous studies, smoking is one of the strongest risk predictors (Laystedt & Eklund 1975, Feldman et al 1983, Bolin et al 1986a&b, Bergström 1989, 2006, Haber & Kent 1992, Stoltenberg et al 1991, 1993, Klinge & Nordlund 2005). Results of the current study confirmed that the severity of chronic periodontitis as well as periodontitis progression increases with increasing cigarette consumption (Bergström 1989, Haber & Kent 1992, Stoltenberg et al 1991, 1993, Haber et al 1993, Klinge & Nordlund 2005). The observation that smoking (>20 cigarettes/day) is the strongest of the systemic modifying risk predictors with an explanatory value of up to 13% is supported by these previous studies. Further results in support of this conclusion were derived from analysis of individual strong risk factors corroborating previously reported results in the literature.

### Endodontic Pathology

Endodontic pathology has previously been reported to contribute significantly to the progression of chronic periodontitis in accordance with findings in the present study (Jansson et al 1993a&b, 1995b, Jansson 1995). However, it should be noted that endodontic pathology is a risk factor for periodontitis progression only in patients with a previous history of periodontal disease, that is, root surfaces void of protective cementum (Jansson 1995, Jansson et al 1995b). In these patients, the influence of endodontic pathology for the individual tooth may increase progression rate by a factor of 3. Although not widely investigated and reported, it is somewhat surprising that endodontic pathology as a risk predictor has an explanatory value of up to 11%.

### Abutment Teeth

Abutment teeth and restored tooth surfaces have previously been reported to contribute significantly to progression of chronic periodontitis in accordance with findings in the present study (Jansson et al 1994). However, restored tooth surfaces such as surfaces in abutment teeth have been suggested to become prevalent only at an advanced stage of periodontitis. Nevertheless, the present study has demonstrated a significantly higher odds-ratio for periodontitis progression in abutment teeth.

### Morphological Characteristics of Past Attachment Loss

History of chronic periodontitis as evidenced by angular destruction (Papapanou & Wennström 1991, Papapanou & Tonetti 2000) and furcation involvement are considered to be strong risk predictors for periodontitis progression (Hirschfeld & Wasserman 1978, McFall 1982, Goldman et al 1986, Nordland et al 1987, Wood et al 1989, Wang et al 1994, McGuire & Nunn 1996a&b, McLeod et al 1997, Papapanou & Tonetti 2000). Results from the present study corroborate these reports, assigning angular bony destruction and furcation involvement explanatory values from 3.8 to 5.6%.

### Conclusions

With explanatory values for periodontitis progression between 4% and 13% and highly significant parameter estimates, smoking, endodontic pathology, abutment teeth, angular bony destruction and furcation involvement, appear to be the strongest predictors. Furthermore, the results with respect to these single risk predictors are all congruous with previous reports thus demonstrating that the present investigational materials (validation sample) is relevant for validating the DentoSystem algorithm in DentoRisk™ and assessing the clinical utility of DentoTest™.

DentoTest™ appears to provide a clinically significant contribution to the quality of analysis with DentoRisk™, in particular in the selection of patients for in-depth risk analysis tooth by tooth in DentoRisk™ Level II. This is reflected in a high PPV for DentoTest™ results for disease progression, both for the dentition as a whole and on an individual tooth basis.

### Section 1.9 General Discussion, Conclusions and Clinical Utility

The focus of the present report has been to validate the DentoRisk™ algorithm which is incorporated in the DentoRisk™ assessment software (Cε mark). The DentoRisk™ assessment software was developed to provide clinicians with a clinically validated unbiased tool that assesses chronic periodontitis risk and, when indicated, prognosticates disease outcome at the tooth level.

DentoRisk™ (DentoSystem Scandinavia AB, Stockholm, Sweden, www.dentosystem.se) is a web-based analysis tool that calculates chronic periodontitis risk (DentoRisk™ Level I) and, if an elevated risk is found, prognosticates disease progression tooth by tooth (DentoRisk™ Level II). The clinician enters clinical and radiographic registrations into the algorithm by way of a simple web-page menu, and the resulting risk score is presented for the dentition as a whole (DentoRisk™ Level I). Subsequently, if an elevated risk is found in Level I, Level II calculates a risk score for each individual tooth which is linked to a prognosis of disease progression.

This report initially describes the construction of the algorithm (Sections 1.1 through 1.3), followed by a description of the validation sample intended for validation of the algorithm (Section 1.4). It was concluded that the validation sample was generated in a way suitable for validation of a prognostic test (longitudinal sample), and presented with reliable recordings of clinical and radiographic variables (risk predictors) and appropriate outcome variables as confirmed by the analyses in Section 1.8.

Sections 1.5 through 1.7 describe in a stepwise fashion the outcomes of the structured analyses in the validation plan. These steps follow those required in a validation plan to demonstrate “fitness for purpose” of a clinical test and recommendations regarding choice of outcome variables and observation periods (Kwok & Caton 2007). In addition, a select number of strong risk predictors (smoking, angular bony destruction and furcation involvement, abutment teeth and endodontic pathology) were analyzed in-depth to verify congruence with previous studies and to evaluate the contribution of DentoTest™ to risk analysis and prognostication with DentoRisk™ (Section 1.8).

DentoTest™ is a skin provocation test administered as a Skin Prick Test to assess the individual patient's ability to develop an appropriate chronic inflammatory reaction relevant to the patient's propensity to chronic marginal periodontitis. Patients with severe forms of chronic periodontitis present with varying degrees of impaired inflammatory reactivity (Lindskog et al 1999).

### Conclusions

The following conclusions were drawn with respect to the different steps of the validation process:

In Section 1.5 it was established that the variables included in the DentoRisk™ algorithm are sufficient in number and reflect a balanced selection of risk predictors from the different risk categories: primary etiological risk predictors, local and systemic modifying risk predictors, and host predictors. Furthermore, it was concluded that sufficiently high explanatory values justify the use of DentoRisk™ Level I to select at-risk patients for detailed prognostication tooth by tooth in DentoRisk™ Level II. Two important DentoRisk™ threshold scores (DRS_{dentition} from Level I and DRSₜₒₒₜₕ from Level II) were identified, above which significant progression of chronic periodontitis was shown:
DRS_{dentition}≧0.5 (whole dentition) corresponding to an annual radiographic bone loss in excess of 0.10 mm and approximately two disease progression indicators.
DRSₜₒₒₜₕ≧0.2 (tooth by tooth) corresponding to a mean annual radiographic bone loss in excess of 0.10 mm and approximately one disease progression indicator.

In Section 1.6, it was established that DentoRisk™ Level I presents with reliable quality characteristics for risk assessment, i.e. selection of patients for detailed prognostication tooth by tooth in DentoRisk™ Level II. DentoRisk™ Level I was shown to be a necessary step for reducing the proportion of false negative results in DentoRisk™ Level II. Subsequently, prognostication of chronic periodontitis tooth by tooth in DentoRisk™ Level II was found to be accompanied by clinically relevant quality characteristics in relation to the prevalence of chronic periodontitis in the validation sample.

Analyses in Section 1.7 demonstrated that prognostication tooth by tooth in DentoRisk™ Level II is accompanied by clinically relevant measures of expected disease progression. Three DentoRisk™ score intervals representing distinctly different and increasing levels of risk for progression of chronic periodontitis were identified in Level II: 0.2≦DRSₜₒₒₜₕ<0.3, 0.3≦DRSₜₒₒₜₕ<0.5 and DRSₜₒₒₜₕ≧0.5. These intervals correspond to increasing levels of annual marginal bone loss, all of which are significantly correlated to DRSₜₒₒₜₕ. Thus, clinically relevant information can be correlated to the three different DRSₜₒₒₜₕ intervals adding a temporal dimension to risk assessment with DentoRisk™, and enabling prognostication of disease development tooth by tooth.

In Section 1.8, it was shown that DentoTest™ provides a clinically significant contribution to the quality of analysis with DentoRisk™, in particular in the selection of patients for in-depth risk analysis tooth by tooth in DentoRisk™ Level II. This is reflected by a high positive predictive value for DentoTest™ results for disease progression both for the dentition as a whole and on an individual tooth basis. It should be noted, however, that the skin provocation test is not intended as a stand-alone test, and its clinical value lies in its merit as an adjunct to risk assessment and the prognostication of chronic periodontitis in DentoRisk™.

### Clinical Utility

The periodontal risk assessment of patients using DentoRisk™ Level I appears to provide a clinically useful tool for selecting patients in need of detailed prognostication tooth by tooth in DentoRisk™ Level II. Both selection of patients and prognostication are accompanied by clinically relevant quality characteristics in relation to the prevalence of chronic periodontitis. The Level II analyses tooth by tooth enabled categorization of prognosis levels into four strata with an increasing risk of disease progression:

| | Mean annual | |
|---|---|---|
| | marginal | |
| DRSₜₒₒₜₕ interval | bone loss | Prognosis category |
| DRSₜₒₒₜₕ < 0.2 | 0.06 mm | No or negligible risk of |
| | | periodontitis progression |
| 0.2 ≦ DRSₜₒₒₜₕ < 0.3 | 0.15 mm | Low risk of periodontitis |
| | | progression |
| 0.3 ≦ DRSₜₒₒₜₕ < 0.5 | 0.21 mm | Moderate risk of periodontitis |
| | | progression |
| DRSₜₒₒₜₕ ≧ 0.5 | 0.27 mm | High risk of periodontitis |
| | | progression |

It is likely that these disease progression rates could have been higher, since the majority of patients, especially those at periodontal clinics, underwent some form of periodontal treatment during the observation period. Prognosticated periodontitis progression in DentoRisk™ Level II has a positive predictive value of 73% and a negative predictive of 55% for a disease prevalence in the relevant strata of approximately 15%. These values are clinically relevant since positive and negative predictive values should not be confused with simple probability in a sample with equal distribution of health and disease.

Furthermore, DentoTest™, which is designed to detect if the patient's inflammatory response is suppressed, appears to provide a clinically significant contribution to the quality of analysis with DentoRisk™, in particular in the selection of patients for in-depth risk analysis tooth by tooth in DentoRisk™ Level II. This is reflected in a high positive predictive value for DentoTest™ results for disease progression, both for the dentition as a whole and on an individual tooth basis.

Thus, based on the outcome of the validation plan it may be argued that the principal clinical utility of risk analysis and periodontitis prognostication with DentoRisk™ (incorporating results from DentoTest™) is to provide the clinician with a reliable, consistent and objective tool supporting periodontal treatment planning and decision making. Future refinement of the algorithm may offer the possibility to rank risk predictors for the individual tooth which significantly contribute to an increased DentoRisk™ Level II score, especially in the two highest intervals (0.3≦DRSₜₒₒₜₕ<0.5 and DRSₜₒₒₜₕ≧0.5), enabling targeted treatment measures.

### SECTION 1.10 REFERENCES

Ainamo J & Bay I. Problems and proposals for recording gingivitis and plaque. Int Dent J 1975: 25; 229-235.
Albandar J M, Brunelle J A, Kingman A. Destructive periodontal disease in adults 30 years of age and older in the United States, 1988-1994. J Periodontol 1999; 1: 13-29.
Albandar J M. A 6-years study on the pattern of periodontal disease progression. J Clin Periodontol 1990: 17: 467-471.
Albandar J M. Global risk factors and risk indicators for periodontal diseases. Periodontology 2000 2002; 9: 177-206.
Al-Zahrani M S, Bissada N F, Borawskit E A. Diet and periodontitis. J Int Acad Periodontol 2005; 7: 21-26.
Al-Zahrani M S, Bissada N F, Borawskit E A. Obesity and periodontal disease in young, middle-aged, and older adults. J Periodontol 2003; 74: 610-615.
American Academy of Periodontology. American Academy of Periodontology statement on risk assessment. J Periodontol 2008; 79: 202.
American Academy of Periodontology. Guidelines for the management of patients with periodontal diseases. J Periodontol 2006; 77: 1607-1611.
Andreasen J O, Andreasen F M, Andersson L. Textbook and Color Atlas of Traumatic Injuries of the Teeth. Blackwell Munksgaard, 2007.
Andreasen J O, Hjörting-Hansen E. Replantation of teeth. II. Histological study of 22 replanted anterior teeth in humans. Acta Odont Scand 1966; 24: 287-306.
Apatzidou D A, Riggio M P, Kinnane D F. Impact of smoking on the clinical, microbiological and immunological parameters of adult patients with periodontitis. J Clin Periodontol 2005; 32: 973-983.
Armö A, Waerhaug J, Lövdal A, Schei O. Incidence of gingivitis as related to sex, occupation, tobacco consumption, tooth-brushing, and age. Oral Surg Oral Med Oral Path 1958; 11: 587-595.
Axelsson P, Lindhe J. Effect of controlled oral hygiene procedures on caries and periodontal disease in adults. Results after 6 year. J Clin Periodontol 1981; 8: 239-248.
Axelsson P. Diagnosis and Risk Prediction of Periodontal Diseases, vol 3. Quintessence Publishing Co, Inc, London 2002.
Axtelius B, Söderfeldt B, Nilsson A, Edwardsson S, Attström R. Therapy-resistant periodontitis. Psychosocial characteristics. J Clin Periodontol 1998; 6: 482-491.
Baelum V, Luan W M, Chen X, Fejerskov O. A 10-year study of the progression of destructive periodontal disease in adult and elderly Chinese. J Periodontol 1997; 11: 1033-1042.
Bain C A, Moy P K. The association between the failure of dental implants and cigarette smoking. Int J Oral Maxillofac Impl 1993; 8: 609-615.
Bayrktar G, Kurtulus I, Duraduryan A, Cintan S, Kazancioglu R, Yildiz A, Bural C, Bozfakioglu S, Besler M, Trablus S, Issever H. Dental and periodontal findings in hemodialysis patients. Oral Diseases 2007; 13: 393-397.
Beck J D, Koch G G, Rozier R G, Tudor G E. Prevalence and risk indicators for periodontal attachment loss in a population of older community-dwelling blacks and whites. J Periodontol 1990; 61: 521-528.
Beck J D, Koch G G. Characteristics of older adults experiencing periodontal attachment loss as gingival recession or probing depth. J Periodontal Res 1994; 29: 290-298.
Becker W, Becker B E, Berg L E. Periodontal treatment without maintenance.
A retrospective study in 44 patients. J Periodontol 1984; 9: 505-509.
Bergström J, Eliasson S. Noxious effect of cigarette smoking on periodontal health. J Period Res 1987; 22: 513-517.
Bergström J. Cigarette smoking as risk factor in chronic periodontal disease. Com Dent Oral Epidem 1989; 17: 245-247.
Bergström J. Periodontitis and smoking: An evidence-based appraisal. J Evid Based Pract 2006;6: 33-41.
Bernick S M, Hiniker J J, Dummett C O. Dental disease in children with diabetes mellitus. J Periodontol 1975; 46: 241-245.
Björn A L. Dental health in relation to age and dental care. Odont Revy 1964; suppl 29.
Blomlöf L, Jansson L, Appelgren R, Ehnevid H, Lindskog S. Prognosis and mortality of root-resected teeth. Int J Periodont Rest Dent 1997; 17: 191-201.
Blomlöf L, Lengheden A, Lindskog S. Endodontic infection and calcium hydroxide-treatment. Effects on periodontal healing in mature and immature replanted monkey teeth. J Clin Periodontol 1992; 19: 652-658.
Blomlöf L, Lindskog S, Hammarström L. Influence of pulpal treatments on cell and tissue reactions in the marginal periodontium. J Periodontol 1988; 59: 577-583.
Bolin A Laystedt S, Frithiof L, Henrikson C O. Proximal alveolar bone loss in a longitudinal radiographical investigation.IV. Smoking and other factors influencing the progress in a material of individuals with at least 20 remaining teeth. Acta Odont Scand 1986b; 44: 263-268.
Bolin A, Eklund G, Frithiof L, Laystedt S. The effect of changed smoking habits on marginal bone loss. Swed Dent J 1993; 17: 211-216.
Bolin A, Laystedt S, Henrikson C O. Proximal alveolar bone loss in a longitudinal radiographical investigation. III. Some predictors with possible influence on the progress in an unselected material. Acta Odont Scand 1986a; 44: 257-262.
Borawski J, Wilczynska-Borawska M, Stokowska W, Mysiwiec M. The periodontal status of pre-dialysis chronic kidney disease and maintenance dialysis patients. Nephrol Dial Transplant 2007; 22: 457-464.
Borell L N, Burt B A, Warren R C, Neighbors H W. The role of individual and neighborhood social factors on periodontitis: The third national health and nutrition examination survey. J Periodontol 2006; 77(3); 444-453.
Brown L F, Beck J D, Rozier R G. Incidence of attachment loss in community-dwelling older adults. J Periodontol 1994; 65: 316-323.
Brown LJ, Löe H. Prevalence, extent, severity and progression of periodontal disease. Periodontol 2000 1994; 2: 57-71.
Brunsvold M A, Lane J J. The prevalence of overhanging dental restorations and their relationship to periodontal disease. J Clin Periodontol 1990; 17: 67-72.
Buckley L A. The relationship between malocclusions, gingival inflammation, plaque and calculus. J Periodontol 1981; 52: 35-40.
Buhlin K, Gustaysson A, Pockley A G, Frosteg\dot{a}rd J, Klinge B. Risk factors for cardiovascular disease in patients with periodontitis. Eur Heart J 2003; 24: 2099-2107.
Chapple I L C, Hamburger J. The significance of oral health in HIV disease. Sexual transmitted infections 2000; 76: 236-243.
Chen H, Cowan M J, Jeffrey D, Hasday J D, Vogel S N, Medvedev A E. Tobacco smoking inhibits expression of proinflammatory cytokines and activation of IL-1 R-associated kinase, p38, and NF-BK in alveolar macrophages stimulated with TLR2 and TLR4 agonists. J Immunol 2007; 179: 6097-6106.
Cianciola L J, Park B H, Bruck E, Moskovitch L, Genco R J. Prevalence of periodontal disease in insulin-dependant diabetes mellitus (juvenile diabetes). J Amer Dent Assoc 1982; 104: 653-660.
Craig RG. Interactions between chronic renal disease and periodontal disease. Oral Dis 2008; 14: 1-7.
Cronin A J, Claffey N, Stassen L F. Who is at risk? Periodontal disease risk analysis made accessible for general dental practitioner. British Dental J 2008; 205: 131-137.
Cvek M., Granath L E, Hollender L. Treatment of non-vital permanent incisors with calcium hydroide. III. Variation of occurrence of ankylosis of reimplanted teeth with duration of extra-alveolar period and storage environment. Odont Revy 1974; 25: 43-56.
Debruyn H, Collaert B. The effect of smoking on early implant failure. Clin Oral Impl Res 1994; 5: 260-264.
Dennison D K & Van Dyke T. The acute inflammatory response and the role of phagocytic cells in periodontal health and disease. Periodontology 2000 1997; 14: 54-78.
Duinkerke A S H, Van de Poel A C M, Purdell-Lewis D J, Doesburg W H. Estimation of alveolar crest height using routine periapical dental radiographs. Oral Surg Oral Med Oral Pathol 1986; 62: 603-606.
Egelberg J. Periodontics. The scientific way. Synopsis of clinical studies. 1999, 3 ed. OdontoScience, Malmö.
Ehnevid H. Local factors modifying marginal periodontal healing. Experimental studies in monkeys and clinical studies in periodontitis-prone patients. Thesis, Karolinska Institutet, Stockholm, Sweden, 1995.
Eick S, Pfister W. Comparison of microbial cultivation and a commercial PCR based method for detection of periodontopathogenic species in subgingival plaque samples. J Clin Periodontol 2002; 29: 638-644.
Emrich L J, Schlossman M, Genco R J. Periodontal disease in non-insulin dependant diabetes mellitus. J Periodontol 1991; 62: 123-130.
Feldman R S, Bravacos J S, Rose C L. Association between smoking different tobacco products and periodontal disease indexes J Periodontol 1983; 54: 481-487.
Fikrig S M, Reddy C M, Orti E, Herod L, Suntharalingam K. Diabetes and neutrophil chemotaxis. Diabetes 1977; 26: 466-468.
Fisher M A, Taylor G W, Papapanou P N, Rahman M, Debanne S M. Clinical and serologic markers of periodontal infection and chronic kidney disease. J Periodontol 2008; 79: 1670-1678.
Fleiss J L, Cohen, J. The equivalence of weighted kappa and the intraclass correlation coefficient as measures of reliability. Educational and Psychological Measurement, 1973, 33, 613-619.
Fleiss, J L. Statistical Methods for Rates and Proportions. 2nd ed., 1981, New York: John Wiley & Sons.
Genco R J, Löe H. The role of systemic conditions and disorders in periodontal disease. Periodontology 2000 1993; 2: 98-116.
Gettig E, Hart T C. Genetics in dental practice: Social and Ethical issues surrounding genetic testing. J Dent Ed 2003; 67: 549-562.
Goldman M C, Ross I F, Goteiner D. Effect of periodontal therapy on patients maintained for 15 years or longer. A retrospective study. J Periodontol 1986; 57: 347-353.
Gould M S, Picton D C. The relation between irregularities of teeth and periodontal disease. Br Dent J 1966; 121: 20-23.
Grassi M, Williams C A, Winkler J R, Murray P A. Management of HIV-associated periodontal diseases. In Oral manifestations of AIDS (ed. PB Robertson and JS Greenspan).1988; pp 119-30. PSG Publishing Company, Littleton Mass., USA.
Gröndahl, H-G. Radiographic examination. In: Clinical Periodontology and Implant Dentistry, Blackwell Publishing Ltd. 2003; 36: 838-851.
Grossi S G, Genco R J, Machtei E E, Ho, A W, Koch G, Dunford R, Zambon J J, Hausmann E. Assessment of risk for periodontal disease. II. Risk indicators for alveolar bone loss. J Periodontol 1995; 66: 23-29.
Grossi S G, Zambon J J, Ho A W, Koch G, Dunford R G, Machtei E E, Norderyd OM, Genco R J. E. Assessment of risk for periodontal disease. I. Risk indicators for attachment loss. J Periodontol 1994; 65: 260-267.
Guzman S G, Karima M, Wang H Y, Van Dyke T E. Association between interleukin-1 genotyp and periodontal disease in a diabetic population. J Periodontol 2003; 8: 1183-1190.
Haber J Wattles J, Crowby M, Mandell R, Kaunudi J, Kent R. Evidence for smoking as a risk factor for periodontitis. J Periodontol 1993; 64: 16-23.
Haber J, Kent R L. Cigarette smoking in periodontal practice. J Periodontol 1992; 63: 100-106.
Haffajee A D, Socransky S S, Lindhe J, Kent R L, Okamoto H, Yoneyama T. Clinical risk indicators for periodontal attachment loss. J Clin Periodontol 1991a; 18: 117-125.
Haffajee A D, Socransky S S, Smith C, Dibart S. Microbial risk indicators for periodontal attachment loss. J Period Res 1991b; 26: 293-296.
Haffajee A D, Socransky S S, Smith C, Dibart S. Relation of baseline microbial parameters to future periodontal attachment loss. J Clin Periodontol 1991c; 18: 744-750.
Hammarström L, Blomlöf L, Feiglin B, Lindskog S. Effect of calcium hydroxide treatment on periodontal repair and root resorption. Endod Dent Traumatol 1986; 2: 184-189.
Harrison R, Bowen W H. Periodontal health, dental caries, and metabolic control in insulin-dependant diabetic children and adolescents. Pediatr Dent 1987; 9: 283-286.
Hart T C, Shapira L, Van Dyke T E. People at risk for periodontitis—Neutophil defects as risk factors. J Periodontol 1994;65: 521-529.
Hassell T M, Harris E L. Genetic influence in caries and periodontal disease. Crit Rev Oral Biol Med 1995; 6: 319-342.
Hedin C A, Ronquist G, Forsberg O. Cyclic nucleotide content in gingival tissue from smokers and non-smokers. J. Periodont Res 1981; 16: 337-343.
Heijl L, Heden G, Svärdstrom G & Östgren A. Enamel matrix derivative (EMDOGAIN) in the treatment of intrabony periodontal defects. J Clin Period 1997; 24: 705-714
Heitz-Mayfield L J A. Disease progression: identification of high-risk groups and individuals for periodontitis. J Clin Periodontol 2005; 32 (suppl. 6): 196-209.
Hirschfeld L, Wasserman B. A long-term survey of tooth loss in 600 treated periodontal patients. J Periodontol 1978; 49: 225-237.
Hugoson A. Gingival inflammation and female sex hormones: A clinical investigation of pregnant women and experimental studies in dogs.
Thesis, Gothenburg, 1970.
Huynh-Ba G, Lang N P, Tonetti M S, Salvi, G E. The association of the composite IL-1 genotype with periodontitis progression and/or treatment outcomes: a systematic review. J Clin Periodontol 2007; 34: 305-317.
Ide R Hoshuyama T, Takahashi K. The effect of periodontal disease on medical and dental costs in a middle-aged Japanese population: A longitudinal worksite study. J Periodontol 2007; 78: 2120-2126.
Ingervall B. A clinical study of the relationship between crowding of teeth, plaque, and gingival conditions. J Clin Periodontol 1977; 4: 214-222.
Ismail A L, Morrison E C, Burt B A, Caffesse R G, Kavanagh M T. Natural history of disease in adults: findings from Tecumseh periodontal disease study, 1959-87. J Dent Res 1990; 2: 430-435.
Jansson H, Norderyd O. Evaluation of a periodontal risk assessment model in subjects with severe periodontitis. Swed Dent J 2008; 32: 1-7.
Jansson L, Ehnevid H, Blomlöf L, Weintraub A, Lindskog S. Endodontic pathogens in periodontal disease augmentation J Clin Periodontol 1995a; 22: 598-602.
Jansson L, Ehnevid H, Lindskog S, Blomlöf L. Proximal restorations and periodontal status. J Clin Periodontol 1994; 21: 577-582.
Jansson L, Ehnevid H, Lindskog S, Blomlöf L. Radiographic attachment in periodontitis-prone teeth with endodontic infection. J Periodontol 1993a; 64: 947-953.
Jansson L, Ehnevid H, Lindskog S, Blomlöf L. Relationship between periapical and periodontal status. A clinical retrospective study. J Clin Periodontol 1993b; 20: 117-123.
Jansson L, Ehnevid H, Lindskog S, Blomlöf L. The influence of endodontic infection on progression of marginal bone loss in periodontitis. J Clin Periodontol 1995b; 22; 729-734.
Jansson L, Lagervall M. Periodontitis progression in patients subjected to supportive maintenance care. Swed Dent J 2008; 32: 105-114.
Jansson L. Influence of endodontic infection on marginal periodontal status. Experimental studies in monkeys and clinical studies in periodontitis-prone patients. Thesis, Karolinska Institutet, Stockholm, Sweden, 1995.
Javed F, Näsström K, Benchimol D, Altamash M, Klinge B, Engstöm PE. Comparison of periodontal and socioeconomic status between subjects with type 2 diabetes mellitus and non-diabetic controls. J Periodontol 2007; 78: 2112-2119.
Jeffcoat M K, Chung Wang I, Reddy M. Radiographic diagnosis in periodontics. Periodontology 2000 1995; 7: 54-68.
Jeffcoat M K, Howell T H. Alveolar bone destruction due to overhanging amalgam in periodontal disease. J Periodontol 1980; 51: 599-602.
Johannsen A. Anxiety, exhaustion and depression in relation to periodontal diseases. Thesis, Karolinska Institutet, Stockholm, Sweden, 2006.
Kaldahl W B, Kalkwarf K L, Patil K D, Molvar M P. Responses of four tooth and sites groupings to periodontal therapy. J Periodontol 1990; 61: 173-179.
Kalkwarf K L, Reinhardt R A. The furcation problem and current controversies and future directions. Dent Clin North Amer 1988; 22: 243-266.
Kalkwarf K L. The effect of contraceptive therapy on gingival inflammation in humans. J Periodontol 1978; 49: 560-563.
Kinnane D F, Demuth D R, Gorr S-U, Hajishengallis G N, Martin M H. Human variability in innate immunity. Periodontotolgy 2000 2007; 45: 14-34
Kinnane D F, Hart T C. Genes and polymorphism associated with periodontal disease. Grit Rev Oral Biol Med 2003; 14: 430-49.
Klinge B, Norlund A A. A socio-economic perspective on periodontal disease: a systematic review. J Clin Periodontol 2005; 32 (suppl. 6): 314-325.
Knight G M, Wade A B. The effect of hormonal contraceptives on the human periodontium. J Period Res 1974; 9: 18-22.
Kornman K S, Crane A, Wang H-Y, di Giovine F S, Newman M G, Pirk F W, Wilson T G, Higginbottom F L, Duff GW. The interleukin-1 genotype as a severity factor in adult periodontal disease. J Clin Periodontol 1997a; 24: 72-77.
Kornman K S, Löe H. The role of local factors in the etiology of periodontal diseases. Periodontol 2000 1993; 2: 83-97.
Kornman K S, Page R, Tonetti M. The host response to the microbial challange in periodontitis: assembling the players. Periodontol 2000 1997b; 14: 33-53.
Kwok V, Caton J G. Commentary. Prognosis revisited: A system for assessing periodontal prognosis. J Periodontol 2007; 78: 2063-2071.
Lagerwall M, Jansson L. Relationship between tooth loss/probing depth and systemic disorders in periodontitis patients. Swed Dent J 2007; 31: 1-9.
Lang N P, Bragger U, Tonetti M S, Hämmerle CF. Supportive periodontal therapy (STP). In: Textbook of Clinical Periodontology. Lindhe J ed. 1998: 822-847.
Lang N P, Kiel R A, Anderhalden K. Clinical and microbiological effect of subgingival restorations with overhanging or clinically perfect margins. J Clin Periodontol 1983; 10: 563-578.
Lang N P, Tonetti M S. Periodontal diagnosis. I. treated periodontitis. Why, when and how to use clinical parameters. J Clin Periodontol 1996; 3: 240-250.
Lang N P, Tonetti M S. Periodontal risk assessment (PRA) for patients in supportive periodontal therapy (STP). Oral Health & Preventive Dentistry 2003; 1; 7-16.
Laystedt S, Bolin A, Henrikson C O. Proximal alveolar bone loss in a longitudinal radiographic investigation. II. A ten-year follow up in an epidemiological material. Acta Odont Scand 1986; 44: 199-205.
Laystedt S, Eklund G. Some factors of significance for proximal marginal bone loss studied on an epidemiological material. Acta Odont Scand 1975; 67: 50-89.
Laystedt S. A methodological-roentgenological investigation on marginal alveolar bone loss. Thesis, Karolinska institutet, Stockholm, Sweden, 1975.
Lengheden A. Periodontal implications of calcium hydroxide treatment. Thesis, Karolinska Institutet, Stockholm, Sweden, 1994.
Lindhe & Nyman S. The effect of plaque control and surgical pocket elimination on the establishment and maintenance of periodontal health. A longitudinal study of periodontal therapy in cases of advanced disease. J Clin Periodontol 1975; 2: 67-79.
Lindhe J, Nyman S, Eriksson I. Trauma from occlusion. In: Clinical Periodontology and Implantology. Lindhe J ed. 1998: 279-295.
Lindhe J, Okamoto H, Yoneyama T Haffajee A, Socransky SS. Longitudinal changes in periodontal disease in untreated subjects. J Clin Periodontol 1989a; 16: 662-670.
Lindhe J, Okamoto H, Yoneyama T Haffajee A, Socransky SS. Periodontal loser sites in untreated adult subjects. J Clin Periodontol 1989b; 16: 671-678.
Lindskog S, Zetterström O, Kamkar A, Bergman E, Forsg\dot{a}rd \dot{A} & Blomlöf L. Skin-prick test for severe marginal periodontitis. Int J Periodontol Rest Dent 1999; 4: 373-377.
Listgarten M A. Periodontal probing: What does it mean? J Clin Periodontol 1980; 7: 165-176.
Locker D, Leake J L. Risk indicators and risk markers for periodontal disease experience in older adults living independently in Ontario, Canada. J Dental Res 1993; 72: 9-17.
Löe H, \dot{A}nerud A, Boysen H, Morrison E. Natural history of periodontal disease in man. Rapid, moderate and no loss of attachment in Sri Lankan laborers 14 to 46 years of age. J Clin Periodontol 1986; 13: 431-440.
Löe H, \dot{A}nerud A, Boysen H, Smith M. The natural history of periodontal disease in man. The rate of periodontal disease destruction before 40 years of age. J Periodontol 1978; 49: 607-620.
Löe H, Silness J. Periodontal disease in pregnancy. I. Prevalence and severity. Acta Odont Scand 1963; 21: 533-551.
Löe H, Theilade E, Jensen S B. Experimental gingivitis in man. J Periodontol 1965; 36: 177-187.
Loesche W J, Lopatin D E, Giordano J, Alcoforado G, Hujoel P. Comparison of the Benzoyl-DL-Arginine-Naphthylamide (BANA) Test, DNA Probes, and Immunological reagents for ability to detect anaerobic periodontal infections due to Porphyromonas gingivalis, Treponema denticola, and Bacteroides forsythus. J Clin Microbiology 1992; 30: 427-433.
Loos B G, John R P, Laine M L. Identification of genetic risk factors for periodontitis and possible mechanisms of action. J Clin Periodontol 2005; 32 (Suppl. 6): 159-179.
Lovdal A, Arnö A, Waerhaug J. Incidence of clinical manifestations of periodontal disease in light of oral hygiene and calculus formation. J Amer Dent Assoc 1958; 56: 21-33.
MacFarlane G D, Herzberg M C, Wolf L F, Hardie N A, Refractory periodontitis associated with abnormal polymorphonuclear leucocyte phagocytosis and cigarette smoking. J Periodontol 1992; 63: 908-913.
Maier A W, Obran B. Gingivitis in pregnancy. Oral Surg Oral Med Oral Path 1949; 2: 334-373.
Manouchehr-Pour M, Spagnuolo P J, Rodman H M, Bissada N F. Comparison of neutrophil chemotactic response in diabetic patients with mild and severe periodontal disease. J Periodontol 1981; 52: 410-415.
Marshall-Day C D, Stevens R G, Quigley L F. Periodontal disease prevalence and incidence. J Periodontol 1955; 26: 185-203.
Masters D H, Hoskins S W. Projections of cervical enamel on molar furcations. J Periodontol 1964; 35: 49-53.
Matuliene G, Pjetursson B E, Salvi G E, Schmidlin K, Brägger U, Zwahlen M, Lang N P. Influence of residual pockets on progression of periodontitis and tooth loss: results after 11 years of maintenance. J Clin Periodontol 2008: 35: 685-695.
McDewitt M J, Wang H Y, Knobelman C, Newman M G, di Giovine F S, Timms J, Duff G W, Kornman K S. Interleukin-1 genetic association with periodontitis in clinical practice. J Periodontol 2000; 71: 156-163.
McFall W T. Tooth loss in 100 treated patients with periodontal disease. J Periodontol 1982; 53: 539-549.
McGuire M K, Nunn M E. Prognosis versus actual outcome. II. The effectiveness of clinical parameters in developing an accurate prognosis. J Periodontol 1996a; 67: 658-665.
McGuire M K, Nunn M E. Prognosis versus actual outcome. III. The effectiveness of clinical parameters in accurately predicting tooth survival. J Periodontol 1996b; 67: 666-674.
McGuire M K, Nunn M E. Prognostic versus actual outcome. IV. The effectiveness of clinical parameters and IL-1 genotype in accurately predicting prognoses and tooth survival. J Periodontol 1999; 70: 49-56.
McGuire M K. Prognosis versus actual outcome: A long-term survey of 100 treated periodontal patients under maintenance care. J Periodontol 1991; 62: 51-58.
McLeod D E, Lainson P A, Spivey J D. Tooth loss due to periodontal abscess: a retrospective study. J Periodontol 1997; 10: 963-966.
Merchant A T, Pitiphat W, Ahmed B, Kawachi I, Joshipura K. A prospective study of social support, anger expression and risk of periodontitis in men. J Am Dent Assoc 2003; 134(12): 1591-1596.
Moretti A J, Fiocchi M F, Flaitz C M. Sarcoidosis affecting the periodontium: a long-term follow-up case. J Periodontol 2007; 78: 2209-2215.
Mucci L A, Björkman L, Douglass C W, Pedersen N L. Environmental and heritable factors in the etiology of oral diseases—a population-based study of Swedish twins. J Dent Res 2005; 84: 800-805.
Nishida N, Tanaka M, Hayashi N, Nagata H, Takeshita T, Nakayama K, Morimoto K, Shizukuishi S. Association of ALDH(2) genotypes and alcohol consumption with periodontitis. J Dent Res 2004; 83(2): 161-165.
Nishida N, Tanaka M, Hayashi N, Nagata H, Takeshita T, Nakayama K, Morimoto K, Shizukuishi S. Determination of smoking and obesity as periodontitis risks using the classification and regression tree method. J Periodontol 2005; 76: 923-928.
Norderyd O, Hugoson A, Grusovin G. Risk of severe periodontal disease in a Swedish adult population. A longitudinal study. J Clin Periodontol 1999; 9: 608-615.
Nordland P, Garrett S, Kiger R, Vanooteghem R, Hutchens L H, Egelberg J. The effect of plaque control and root debridement in molar teeth. J Clin Periodontol 1987; 14: 231-236.
Nunn M E. Understanding of the etiology of periodontitis: an overview of periodontal risk factors. Periodontology 2000 2003; 32: 11-23.
Nyman S, Lindhe J, Rosling B. Periodontal surgery in plaque-infected dentitions. J Clin Periodontol 1977; 4: 240-249.
Nyman S, Lindhe J. Examination of patients with periodontal disease. In: Clinical Periodontology and Implantology. Ed. J Lindhe, Munksgaard, Copenhagen 1998, 383-395.
Nyman S, Rosling B, Lindhe J. Effect of professional tooth cleaning on healing after periodontal surgery. J Clin Periodontol 1975; 2: 80-86.
Okamoto H, Lindhe J, Haffajee A, Socransky S. Methods of evaluating periodontal disease data in epidemiological research. J Clin Periodontol 1988; 15: 430-439.
Page R C, Beck J D. Risk assessment for periodontal disease. Int Dent J 1997; 47: 61-72.
Page R C, Krall E A, Martin J, Mancl L, Garcia R I. Validity and accuracy of a risk calculator in predicting periodontal disease. JADA 2002; 133: 569-576.
Page R C, Martin J, Mancl L, Garcia R. Longitudinal validation of a risk calculator for periodontal disease. J Clin Periodontol 2003; 30: 819-827.
Page R C. Oral health status in United States: Prevalence of inflammatory periodontal diseases. J Dent Edu 1985; 49:354-364.
Papapanou P N, Tonetti M S. Diagnosis and epidemiology of periodontal osseous lesions. Periodontology 2000 2000; 22: 8-21.
Papapanou P N, Wennström J L, Gröndahl K. A 10-year retrospective study of periodontal disease progression. J Clin Periodontol 1989; 16: 403-411.
Papapanou P N, Wennström J L, Gröndahl K. Periodontal status in relation to age and tooth type. A cross-sectional radiogrphical study. J Clin Periodontol 1988; 15: 469-478.
Papapanou P N, Wennström J L. The angular bony defect as indicator of further alveolar bone loss. J Clin Periodontol 1991; 18: 317-322.
Persson G R, Manci L A, Martin J, Page R C. Assessing periodontal disease risk: a comparison of clinicians' assessment versus computerized tool. Am J Dent Assoc 2003a: 134; 575-582
Persson G R, Matuliene' G, Ramseier C A, Persson R E, Tonetti M S, Lang N P. Influence of interleukin-1 gene polymorphism on the outcome of supportive periodontal therapy explored by a multi-factorial periodontal risk assessment model (PRA). Oral Health Preventive Dentistry 2003b; 1:17-27.
Persson G R. Effects of line-angle versus mid-proximal periodontal probing measurements on prevalence estimates of periodontal disease. J Periodont Res 1991; 26: 527-529.
Petrie A, Sabin C. Medical Statistics. Blackwell 2000, pp. 80-81.
Pitiphat W, Merchant A T, Rimm E B, Joshipura K J. Alcohol consumption increases periodontitis risk. J Dent Res 2003; 82(7): 509-513.
Preber H, Bergström J. Cigarette smoking in patients referred for periodontal treatment. Scand J Dent Res 1986; 94: 102-108.
Razani-Boroujerdi S, Singh S P, Knall C, Hahn F F, Peña-Philippides J C, Kalra R, Langley R J, Sopori M L. Chronic nicotine inhibits inflammation and promotes influenza infection. Cell Immunol 2004; 230: 1-9.
Renvert S, Ohlsson O, Persson S, Lang N P, Persson GR. Analysis of periodontal risk profiles in adults with or without a history of myocardial infarction. J Clin Periodontol 2004; 31: 19-24.
Renvert S, Persson G R. A systematic review on the use of residual probing depth, bleeding on probing and furcation status following initial periodontal therapy to predict further attachment and tooth loss. J Clin Periodontol 2002; 3: 82-89.
Ringsdorf W M, Powell B J, Knight L A, Cheraskin E. Periodontal status and pregnancy. Amer J Gynecol 1962; 83: 258-263.
Robertson P B, Ernster V, Walsh M, Greene J, Grady D, Hanck W. Periodontal effects associated with the use of smokeless tobacco. J Periodontol 1990; 61: 438-443.
Ronderos M, Ryder M I. Risk assessment in clinical practice. Periodontology 2000 2004; 34: 120-135.
Rosling B, Nyman S, Lindhe J, Jern B. The healing potential of periodontal tissues following different techniques of periodontal surgery in plaque-free dentitions. A 2-year clinical study. J Clin Periodontol 1976b; 3: 233-250.
Rosling B, Nyman S, Lindhe J. The effect of systemic plaque control on bone regeneration in infrabony pockets. J Clin Periodontol 1976a; 3: 38-53.
Rutjes A W S, Reitsma J B, Coomarasamy A, Khan K S, Bossuyt P M M. Evaluation of diagnostic tests when there is no gold standard. A review of methods. Health Technology Assessment 2007; vol. 11: no. 50.
Rylander H, Ramberg P, Blohme G, Lindhe J. Prevalence of periodontal disease in young diabetics. J Clin Periodontol 1986; 14: 38-43.
Saito T, Shimazaki Y, Koga T, Tsuzuki M, Ohshima A. Relationship between upper body obesity and periodontitis. J Dent Res 2001; 80: 1631-1636.
Sandberg G E, Sundberg H E, Fjellstrom C A, Wikblad K F. Type 2 diabetes and oral health: a comparison between diabetic and non-diabetic subjects. Diabetes Res and Clin Practice. 2000; 1: 27-34.
Sanz M, Quirynen M. Advances in the etiology of periodontis. J Clin Periodontol 2005; 32 (Suppl. 6): 54-56.
Schätzle M, Loe H, Lang N P, Burgin W, Anerud A, Boysen H. The clinical course of chronic periodontitis. J Clin Periodontol 2004: 31: 1122-1127.
Schei O, Waerhaug J, Lövdal A, Arnö A. Alveolar bone loss as related to oral hygiene and age. J Periodontol 1959; 30: 7-16.
Scheil R, Blum M, Muller U A, Kohler S, Kademann A, Strobel J, Hoffken K. Screening for people with diabetes mellitus for poor blood glucose control in an opthtalmological laser clinic. Diabetes Res Clin Practice 2001; 3: 173-179
Schlossman M, Knowler W C, Pettitt D J, Genco R J. Type 2 diabetes mellitus and periodontal disease. JADA 1990; 121: 532-536.
Seymore R A, Heasman P A. Drugs, Diseases and the Periodontium. Oxford Medical Publications 1992.
Seyomour G J, Ford P J, Cullinan M P, Leishman S, Yamazaki K. Relationship between periodontal infections and systemic disease. Clin Microbiol Infect 2007; 13 (suppl): 3-10.
Shimazaki Y, Saito T, Kiyohara Y, Kato I, Kubo M, Iida M, Yarnashita Y. Relationship between drinking and periodontitis: The Hisayama study. J Periodontol 2005; 76: 1534-1541.
Silness J, Löe H. Periodontal disease in pregnancy III. Response to local treatment. Acta Odont Scand 1966; 22: 747-759.
Silness J, Röystrand T. Relationship between alignment conditions of teeth in anterior segments and dental health. J Clin Periodontol 1985; 12: 312-320.
Socransky S. Relationship of bacteria to the etiology of periodontal disease. J Dent Res 1970; 49 (suppl): 203-232.
Socransky S S, Haffajee A D, Goodson J, Lindhe J. New concepts of destructive periodontal disease. J Clin Periodontol 1984; 11: 21-32.
Soskolne W A, Klinger A. The relationship between periodontal diseases and diabetes. An overview. Ann Periodontol 2001; 1: 91-98.
Stahl S S. Inflammatory periodontal disease an nutritional deficiencies. Ann Dent 1976; 35: 47-51.
Stanford T W, Rees T D. Acquired immunesuppression and other risk factors/indicators for periodontal disease progression. Periodontology 2000 2003; 32: 118-135.
Stoltenberg I L, Osborn J B, Hardie N A; Herzberg M C, Pihlström B L. The association between periodontal status and cigarette smoking. J Dent Res 1991; 70 (spec iss): 556 (Abstr 2321).
Stoltenberg J L, Osborn J B, Pihlstrom B L, Herzberg M C, Aeppli D M, Wolf L F, Fischer G. Association between cigarette smoking, bacterial pathogens and periodontal status. J Periodontol 1993; 64: 1225-1230.
Taylor G W, Burt B, Becker M P, Genco R J, Schlossman M, Knowler W C, Pettitt D J. Non-insulin dependent diabetes mellitus and alveolar bone loss progression over 2 years. J Periodontol 1998; 1; 76-83.
Teng H C, Lee C H, Hung H C, Tsai C C, Chang Y Y, Yang Y H, Lu C T, Yen Y Y, Wu YM. Lifestyle and psychosocial factors associated with chronic periodontitis in Taiwanese adults. J Periodontol 2003; 74(8): 1169-1175.
Tervonen T, Karjalainen K. Periodontal disease related to diabetic status. A pilot study of the response to periodontal therapy in type 1 diabetes. J Clin Periodontol 1997; 7: 505-510.
Theilade E, Wright W H, Jensen S B, Löe H. Experimental gingivitis in man. III. A longitudinal clinical and bacteriological investigation. J Period Res 1966; 1: 1-13.
Thorstensson H, Kuylenstierna J, Hugosson A. Medical status and complications in relation to periodontal disease experience in insulin-dependent diabetics. J Clin Periodontol 1996; 23: 194-202.
Tsai C, Hayes C, Taylor G W. Glycemic control of type 2 diabetes and severity of periodontal disease in the US adult population. Com Dent Oral Epidemiol 2002; 30: 82-92.
Vandersall D C. Concise Encyclopedia of Periodontology. Blackwell Munksgaard, 2007.
Wang H L, Burgett F G, Shyr Y, Ramfjord S. The influence of molar furcation involvement and mobility on future clinical attachment loss. J Periodontol 1994; 1:25-29.
Wilson T G, Glover M E, Malik A K, Schoen J A, Dorsett D. Tooth loss in maintenance patients in a private periodontal practice. J Periodontol 1987; 4: 231-235.
Wilson T G. Using assessment to customize periodontal treatment J California Dental Association 1999; 27: 627-640.
Wilton J M. Unchanging, subject-based risk factors for destructive periodontitis: Race, sex, genetic, congenital and childhood systemic diseases. In: Johnson NW (ed) Risk markers for oral diseases, vol 3: Periodontal diseases. Cambridge, 1991, p. 109.
Winkler J R, Grassi M, Murray P A. Clinical description and etiology of HIV-associated periodontal diseases. In Robertson P B, Greenspan J S (eds.) Oral manifestations of AIDS. PSG Publishing Company, Littleton Mass., 1988; pp. 49-70.
Wood W R, Greco G W, Mac Fall W T. Tooth loss in patients with moderate periodontitis after treatment and long-term maintenance care. J Periodontol 1989; 60: 516-520.
Ziskin D E, Blackberg S N, Stout A P. The gingivae during pregnancy. An experimental study and a histopathological interpretation. Surg Gynecol Obstet 1933; 57: 719-726.

### Example 2

### Quality Characteristics of the DentoRisk™ Level II Analysis with and without Differentiated Weight Factors Depending on Outcome in DentoRisk™ Level I Analysis

### DentoRisk™

DentoRisk™ is a web-based analysis tool that calculates chronic periodontitis risk (DentoRisk™ Level I) and, if an elevated risk is found, prognosticates disease progression tooth by tooth (DentoRisk™ Level II). In Level I, the clinician enters numerical or dichotomous values for each clinical variable (Table 2.1) into an algorithm by way of a menu with predefined variable outcomes, and the resulting risk score (DRS_{dentition}) is presented for the dentition as a whole (DentoRisk™ Level I). Subsequently, if an elevated risk is indicated in Level I, detailed registration of clinical variables enables calculation of a risk score (DRSₜₒₒₜₕ) for each individual tooth (DentoRisk™ Level II).

TABLE 2.1
Risk predictors relevant to risk of periodontitis
progression classified according to host predictors,
and systemic and local modifying predictors.

| | Modifying systemic | Modifying local |
|---|---|---|
| Host predictors | predictors | predictors |
| Age in relation to | Patient cooperation | Bacterial plaque |
| history of chronic | and disease | (oral hygiene) |
| periodontitis | awareness | Endodontic pathology |
| Family history of | Socio-economic status | Furcation involvement |
| chronic | Smoking habits | Angular bone |
| periodontitis | The therapist's | destruction |
| Systemic diseases | experience with | Radiographic marginal |
| and related | periodontal care | bone loss |
| diagnoses | | Periodontal pocket depth |
| Result of skin | | Periodontal bleeding on |
| provocation test to | | probing |
| assess the | | Marginal dental |
| patient's | | restorations |
| inflammatory | | Increased tooth mobility |
| reactivity | | |
| (DentoTest ™) | | |

Local modifying predictors usually exert their influence on all, some or single tooth sites in contrast to systemic modifying predictors, which invariably affect all teeth. In addition to the host predictors, some of the systemic modifying predictors also have a genetic background.

The DentoRisk™ software assigns a numerical value to each variable x in Table 2.1 based on the patient's current periodontal and general medical status when entered into the data entry module. In addition, a relative weight factor a (an integral part of the DentoRisk™ algorithm) is assigned for each variable and is introduced into the calculations performed by the algorithm as presented below. The numerical values for the variable outcomes and weight factors have been determined from pervious clinical studies. The equation in the algorithm for calculation of DentoRisk™ scores (DRS) in Levels I & II is as follows:

$$\frac{{a}_{1} {x}_{1} + {a}_{2} {x}_{2} + … + {a}_{n} {x}_{n}}{{a}_{1} {x}_{1 max} + {a}_{2} {x}_{2 max} + … + {a}_{n} {x}_{n max}} = {DentoRisk}^{} Score ( DRS , range 0.00 - 1.00 )$$

Assessment in DentoRisk™ Level I serves to select patients at risk of chronic periodontitis progression for detailed prognostication tooth by tooth in DentoRisk™ Level II. A detailed description of the clinical validation of the DentoRisk algorithm is presented in Example 1 (Lindskog et al. Clinical Validation of the DentoRisk™ Algorithm for Chronic Periodontitis Risk Assessment and Prognostication).

In summary, a DentoRisk™ threshold score in Level I (DRS_{dentition})≧0.5 is correlated to significant progression of chronic periodontitis and determine if DentoRisk™ Level II analysis should be carried out. In DentoRisk™ Level II a score (DRSₜₒₒₜₕ)>0.2) is similarly correlated to significant progression of chronic periodontitis. Scores correspond to an annual radiographic bone loss in excess of 0.10 mm for both levels of DentoRisk™ and two and one disease progression indicators for DentoRisk™ Level I and Level II, respectively.

### Definitions for Calculation of Quality Characteristics for DentoRisk™

Hence, the definitions in Table 2.2 form the basis for calculations of accuracy, sensitivity, specificity, Positive Predictive Value (PPV) and Negative Predictive Value (NPV) as defined in Table 2.3.

TABLE 2.2
Definitions which formed the basis for further calculation
of accuracy, sensitivity, specificity, PPV and NPV
of the DentoSystem algorithm in DentoRisk ™.

| | No. of disease | No. of disease |
|---|---|---|
| | progression | progression |
| | indicators ≧ 2 | indicators < 2 |
| DRS_{dentition} ≧ 0.5 | True positive | False positive |
| DRS_{dentition} < 0.5 | False negative | True negative |
| | No. of disease | No. of disease |
| | progression | progression |
| | indicators ≧ 1 | indicators < 1 |
| DRSₜₒₒₜₕ ≧ 0.2 | True positive | False positive |
| DRSₜₒₒₜₕ < 0.2 | False negative | True negative |

TABLE 2.3
Formulas for calculation and relationships between accuracy, sensitivity,
specificity, PPV and NPV.

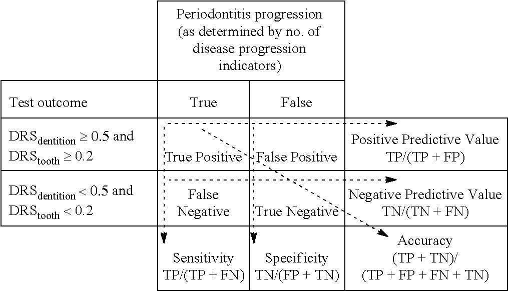

### Quality Characteristics for DentoRisk™ Level I

Quality characteristics for risk assessment with DentoRisk™ Level I (accuracy, sensitivity, specificity, PPV and NPV) are presented in Table 2.4. Analysis in Level I serves to select patients for detailed analysis tooth by tooth in DentoRisk™ Level II. The clinical validation sample which was analyzed is described in Example 1 (Lindskog et al. Clinical Validation of the DentoRisk™ Algorithm for Chronic Periodontitis Risk Assessment and Prognostication).

TABLE 2.4
Accuracy, sensitivity, specificity, PPV and NPV based on calculations
including all patients in the validation sample (N = 183 patients).

| DRS_{dentition} interval | Accuracy | Sensitivity | Specificity | PPV | NPV |
|---|---|---|---|---|---|
| DRS_{dentition} < 0.5 | 79% | 86% | 71% | 76% | 83% |
| (disease | | | | | |
| indicators < 2) | | | | | |
| DRS_{dentition} ≧ 0.5 | | | | | |
| (disease | | | | | |
| indicators ≧ 2) | | | | | |

### Quality Characteristics for DentoRisk™ Level II

Quality characteristics for prognostication of chronic periodontitis progression with DentoRisk™ Level II include calculations of its accuracy, sensitivity, specificity, PPV and NPV. The calculations were performed for three sets of data:
3. All teeth in the clinical trial material (N=2485 teeth) regardless of outcome of assessment with DentoRisk™ Level I and without a differentiated algorithm in DentoRisk™ Level II (Table 2.5).
4. Only the subgroup of teeth (N=1408 teeth) in patients which presented with a DRS_{dentition}≧0.5 and without a differentiated algorithm in DentoRisk™ Level II (Table 2.6).

TABLE 2.5
Accuracy, sensitivity, specificity, PPV and NPV for DentoRisk ™ Level
II based on calculations including all teeth in the clinical
trial material (N = 2485 teeth) regardless of outcome in the
DentoRisk ™ Level I analysis (DRS_{dentition}).

| DRSₜₒₒₜₕ interval | Accuracy | Sensitivity | Specificity | PPV | NPV |
|---|---|---|---|---|---|
| DRSₜₒₒₜₕ < 0.2 | 63% | 50% | 77% | 71% | 58% |
| (disease | | | | | |
| indicators < 1) | | | | | |
| DRSₜₒₒₜₕ ≧ 0.2 | | | | | |
| (disease | | | | | |
| indicators ≧ 1) | | | | | |

TABLE 2.6
Accuracy, sensitivity, specificity, PPV and NPV for DentoRisk ™ Level
II based on calculations including only the subgroup of teeth in patients
which presented with a DRS_{dentition} ≧ 0.5 (N = 1408
teeth) in accordance with the intended use of risk assessment
and prognostication with DentoRisk ™.

| DRSₜₒₒₜₕ interval | Accuracy | Sensitivity | Specificity | PPV | NPV |
|---|---|---|---|---|---|
| DRSₜₒₒₜₕ < 0.2 | 65% | 66% | 64% | 73% | 55% |
| (disease | | | | | |
| indicators < 1) | | | | | |
| DRSₜₒₒₜₕ ≧ 0.2 | | | | | |
| (disease | | | | | |
| indicators ≧ 1) | | | | | |

Quality Characteristics for DentoRisk™ Level II Analysis with Differentiated Weight Factors Depending on Outcome in DentoRisk™ Level I

DentoRisk™ Level I selects patients with a significant risk of chronic periodontitis for detailed analysis in DentoRisk™ Level II with clinically relevant quality characteristics (accuracy, sensitivity, specificity, PPV and NPV) as presented in Table 2.4. With an increasing risk for chronic periodontitis as indicated by a DentoRisk™ Level I score DRS_{dentition}≧0.5 it is reasonable to assume that risk predictors relevant to risk of periodontitis progression as defined in Table 2.1 become increasingly important for disease progression with an increasing DRS_{dentition}. A differentiated algorithm with weight factors a adjusted based on outcome in DentoRisk™ Level I analysis would be able to increase the quality of analysis in DentoRisk™ Level II. Thus, the relevant quality characteristics for a differentiated algorithm are only those which related to correctly identified progression of disease (accuracy, sensitivity and positive predictive value or PPV):
Accuracy The proportion of true results (both true positives and true negatives).
Sensitivity The proportion of true positives of all cases that showed progression of periodontitis (true positives and false negatives).
PPV PPV is the proportion of patients or teeth with positive test results who showed progression of periodontitis.

Hence, prognostic quality properties include calculations of accuracy, sensitivity, and PPV for a differentiated algorithm in DentoRisk™ Level II for tooth by tooth analysis in patients from two different outcome strata in DentoRisk™ Level I:
1. The subgroup of teeth (N=405 teeth) in patients which presented with a 0.6≦DRS_{dentition}<0.7 and analyzed with an algorithm with weight factors a in DentoRisk™ Level II adjusted to the elevated DRS_{dentition} risk interval (Table 2.7).
2. The subgroup of teeth (N=474 teeth) in patients which presented with a DRS_{dentition}≧0.7 and analyzed with an algorithm with weight factors a in DentoRisk™ Level II adjusted to the highest DRS_{dentition} risk interval (Table 2.8).

TABLE 2.7
Accuracy, sensitivity, specificity, PPV and NPV for DentoRisk ™ Level
II based on calculations including the subgroup of teeth (N = 405 teeth)
in patients which presented with a 0.6 ≦ DRS_{dentition} < 0.7 analyzed
with an algorithm with adjusted weight factors a in DentoRisk ™ Level II.

| DRSₜₒₒₜₕ interval | Accuracy | Sensitivity | PPV |
|---|---|---|---|
| DRSₜₒₒₜₕ < 0.2 | 64% | 61% | 80% |
| DRSₜₒₒₜₕ ≧ 0.2 | | | |

TABLE 2.8
Accuracy, sensitivity, specificity, PPV and NPV for DentoRisk ™ Level
II based on calculations including the subgroup of teeth (N = 474 teeth)
in patients which presented with a DRS_{dentition} ≧ 0.7 analyzed
with an algorithm with adjusted weight factors a in DentoRisk ™ Level II.

| DRSₜₒₒₜₕ interval | Accuracy | Sensitivity | PPV |
|---|---|---|---|
| DRSₜₒₒₜₕ < 0.2 | 70% | 92% | 73% |
| DRSₜₒₒₜₕ ≧ 0.2 | | | |

Table 2.9 presents change in prognostic quality properties for DentoRisk™ Level II (accuracy, sensitivity, and PPV) for the differentiated algorithm in DentoRisk™ Level II for tooth by tooth analysis in patients from three different outcome strata in DentoRisk™ Level I (DRS_{dentition}). In conclusion, analysis with a differentiated algorithm in DentoRisk™ Level II based on outcome in DentoRisk™ Level I analysis increases significantly quality characteristics for disease prognostication with an increasing risk of chronic periodontitis as indicated by an increasing DentoRisk™ Level I score (DRS_{dentition}).

TABLE 2.9
Change (percentage points) in accuracy, sensitivity and PPV for
an algorithm with adjusted weight factors a in DentoRisk ™ Level
II based on outcome in DentoRisk ™ Level I (DRS_{dentition}
intervals ≧ 0.5) compared to results from analysis of the entire
investigational materials with an undifferentiated algorithm
(DRS_{dentition} ≧ 0.0) and calculated from the results presented
in Tables 2.5 through 2.8.

| DRS_{dentition} interval | ΔAccuracy | ΔSensitivity | ΔPPV |
|---|---|---|---|
| DRS_{dentition} ≧ 0.0 | — | — | — |
| 0.5 ≦ DRS_{dentition} < 0.6 | +2 | +15 | −2 |
| 0.6 ≦ DRS_{dentition} < 0.7 | +1 | +11 | +9 |
| DRS_{dentition} ≧ 0.7 | +7 | +42 | +2 |

1.-56. (canceled)

57. A method for assessing the risk for periodontitis progression or for developing periodontitis, the method including the steps of:
retrieving a first set of measures from at least one user device, each measure of the first set of measures corresponding to one of a plurality of predictors promoting periodontitis comprising host predictors, local predictors, and systemic predictors for periodontitis progression or for developing periodontitis for a patient;
for each of the retrieved first set of measures, assigning a weight factor on the basis of the relative impact on the progress of periodontitis of the predictor corresponding to the respective measure; and
calculating a first risk score for periodontitis progression or for developing periodontitis for the patient on the basis of the assigned weight factors;
wherein said method further includes the steps of, for each tooth of the patient, on a condition that the calculated first risk score exceeds a predetermined threshold value:
retrieving a second set of measures from the at least one user device, each measure of the second set of measures corresponding to one of a plurality of predictors promoting periodontitis comprising local predictors for periodontitis progression or for developing periodontitis for the respective tooth;
for each of the retrieved second set of measures, assigning a weight factor on the basis of the relative impact on the progress of periodontitis of the predictor corresponding to the respective measure;
calculating a second risk score for periodontitis progression or for developing periodontitis for the respective tooth on the basis of the assigned weight factors; and
transmitting the first risk score and/or the second risk score to the at least one user device.

58. The method according to claim 57, further comprising one or more of the steps of:
on the basis of the thus calculated first risk score, determining a risk level for the risk for progression of periodontitis or for developing periodontitis for the patient; and
on the basis of the thus calculated second risk score, determining a risk level for the risk for progression of periodontitis or for developing periodontitis for the respective tooth.

59. The method according to claim 57, further including the step of producing a first set of numerical values, each numerical value of the first set of numerical values being associated with a weight factor, wherein the first risk score is calculated on the basis of the thus produced numerical values of the first set of numerical values and the associated weight factors.

60. The method according to claim 57, wherein the step of receiving a first set of measures further includes the steps of:
assessing predictors promoting periodontitis comprising host predictors, systemic predictors and local predictors for periodontitis progression or for developing periodontitis for the patient;
determining a first set of measures, each of the measures of the first set of measures corresponding to one of the thus assessed predictors;
storing said first set of measures in a database;
accessing the database; and
retrieving said first set of measures from the database.

61. The method according to claim 57, wherein at least one of the weight factors associated with the first set of measures is improved by performing said method and comparing said thus determined risk level for the risk for progression of periodontitis or for developing periodontitis with clinical measures on the progress of periodontitis or indications for developing periodontitis for the patient, and on the basis of said comparison, adjusting the at least one of the weight factors associated with the first set of measures.

62. A method for prognosticating the outcome of a treatment procedure for treating a patient suffering from periodontitis, the method including the steps of, for each tooth of the patient:
retrieving a set of measures from at least one user device, each measure of the set of measures corresponding to one of plurality of predictors promoting periodontitis progression comprising host predictors, local predictors, and systemic predictors for periodontitis progression for the respective tooth of the patient;
retrieving a set of predetermined impact factors with respect to the impact of the treatment procedure on at least one of the set of measures from the at least one user device, each impact factor corresponding to the at least one of the set of measures;
applying each impact factor to the corresponding measure, thereby biasing said measure;
for each of the determined set of measures, assigning a weight factor on the basis of the relative impact on the progress of periodontitis of the predictor corresponding to the respective measure;
calculating a biased risk score for progression of periodontitis for the respective tooth of the patient on the basis of the thus assigned weight factors; and
on the basis of the difference between the biased risk score and a predetermined unbiased risk score for progression of periodontitis for the respective tooth of the patient, prognosticating the outcome of a treatment procedure for treating the patient suffering from periodontitis.

63. The method according to claim 62, further including the step of producing a first set of numerical values, each numerical value of the first set of numerical values being associated with a weight factor, wherein the biased risk score is calculated on the basis of the thus produced numerical values of the first set of numerical values and the associated weight factors.

64. The method according to claim 62, wherein the step of receiving a set of measures further includes the steps of:
assessing predictors promoting periodontitis comprising host predictors, systemic predictors and local predictors for periodontitis progression for the patient;
determining a set of measures, each of the measures of the set of measures corresponding to one of the thus assessed predictors;
storing said set of measures in a database;
accessing the database; and
retrieving said set of measures from the database.

65. The method according to claim 62, wherein the host predictors include at least one of the age of the patient in relation to history of periodontitis, the patient's family history of periodontitis, the patient's history of systemic disease and related diagnoses, and the result of a skin provocation test for assessing the inflammatory reactivity of the patient.

66. The method according to claim 65, wherein the host predictors include the age of the patient in relation to history of periodontitis, the patient's family history of periodontitis, the patient's history of systemic disease and related diagnoses, and the result of a skin provocation test for assessing the inflammatory reactivity of the patient.

67. A device for assessing the risk for periodontitis progression or for developing periodontitis, the device including a control and processing unit adapted to communicate with at least one user device, the control and processing unit being further adapted to:
retrieve a first set of measures from the at least one user device, each measure of the first set of measures corresponding to a plurality of predictors promoting periodontitis comprising host predictors, local predictors, and systemic predictors for periodontitis progression or for developing periodontitis for a patient;
for each of the retrieved first set of measures, assign a weight factor on the basis of the relative impact on the progress of periodontitis of the predictor corresponding to the respective measure; and
calculate a first risk score for periodontitis progression or for developing periodontitis for the patient on the basis of the assigned weight factors;
wherein for each tooth of the patient the processing unit is further adapted to, on a condition that the calculated first risk score exceeds a predetermined threshold value:
retrieve a second set of measures from the at least one user device, each measure of the second set of measures corresponding to one of a plurality of predictors promoting periodontitis comprising local predictors for periodontitis progression or for developing periodontitis for the respective tooth;
for each of the retrieved second set of measures, assign a weight factor on the basis of the relative impact on the progress of periodontitis of the predictor corresponding to the respective measure;
calculate a second risk score for periodontitis progression or for developing periodontitis for the respective tooth on the basis of the assigned weight factors; and
transmit the first risk score and/or the second risk score to the at least one user device.

68. The device according to claim 67, wherein the processing unit is further adapted to perform one or more of:
on the basis of the thus calculated first risk score, determine the risk level for the risk for progression of periodontitis or for developing periodontitis for the patient; and
on the basis of the thus calculated second risk score, determine a risk level for risk for progression of periodontitis or for developing periodontitis for the respective tooth.

69. The device according to claim 67, wherein the processing unit is further adapted to produce a first set of numerical values, each numerical value of the first set of numerical values being associated with a weight factor, and wherein the first risk score is calculated on the basis of the thus produced numerical values of the first set of numerical values and the associated weight factors.

70. A device for prognosticating the outcome of a treatment procedure for treating a patient suffering from periodontitis, the device including a control and processing unit adapted to communicate with at least one user device, the control and processing unit being further adapted to, for each tooth of the patient:
retrieve a set of measures from the at least one user device, each measure of the set of measures corresponding to one of a plurality of predictors promoting periodontitis progression comprising host predictors, local predictors, and systemic predictors for periodontitis progression for the respective tooth of the patient;
retrieve a set of predetermined impact factors with respect to the estimated impact of the treatment procedure on at least one of the set of measures from the at least one user device, each impact factor corresponding to the at least one of the set of measures;
apply each impact factor to the corresponding measure, thereby biasing said measure;
for each of the determined set of measures, assign a weight factor on the basis of the relative impact on the progress of periodontitis of the predictor corresponding to the respective measure;
calculate a biased risk score for progression of periodontitis for the respective tooth of the patient on the basis of the assigned weight factors; and
on the basis of the difference between the biased risk score and a predetermined unbiased risk score for progression of periodontitis for the respective tooth of the patient, prognosticate the outcome of a treatment procedure for treating the patient suffering from periodontitis.

71. A system for assessing the risk of periodontitis or for developing periodontitis for a patient, including:
a control and processing unit;
wherein the control and processing unit is adapted to perform a method for assessing the risk for the progression of periodontitis for a patient according to claim 57.
